(19) United States
(12) Patent Application Publication
(10) Pub. No.: US 2025/0372070 A1
(43) Pub. Date: Dec. 4, 2025

(54) CARRIER FOR A MODULAR SIGNAL PROCESSING SYSTEM AND METHODS FOR USING SAME

(71) Applicant: Team Projects LLC, Oakland, CA (US)

(72) Inventors: Zachary Heineman, Oakland, CA (US); Dan Senatore, San Francisco, CA (US); Shannon Staats, Ostrander, OH (US); Ed Wood, Marina del Ray, CA (US); Jason Metzner, Issaquah, WA (US)

(21) Appl. No.: 19/231,779

(22) Filed: Jun. 9, 2025

Related U.S. Application Data
(63) Continuation of application No. PCT/US2023/083431, filed on Dec. 11, 2023.
(60) Provisional application No. 63/386,694, filed on Dec. 9, 2022.

(51) Int. Cl. G10H 1/32; G10H 5/00

(52) U.S. Cl. CPC G10H 1/32; G10H 5/00

(57) ABSTRACT

A case assembly for a modular synthesizer includes a case and a carrier to improve the ease of mechanically and electrically installing or uninstalling a module to the case. Specifically, the carrier is mechanically coupled directly to the module via a module attachment mechanism that accommodates modules made for various standardized formats, such as the Eurorack format. The carrier further includes carrier electronics that are electrically coupled directly to the module via an electrical cable. Once the module is mounted to the carrier, the carrier can be mechanically coupled directly to the case via a locking mechanism with one or more quick-release features. The case also includes case electronics, such as a power bus, that can be electrically coupled to the case electronics via multiple pogo pins on the carrier electronics and corresponding electrical traces on the case electronics.

### CROSS-REFERENCE TO RELATED APPLICATION(S)

This application is a bypass continuation of International Application No. PCT/US2023/083431, filed Dec. 11, 2023 and entitled “CARRIER FOR A MODULAR SIGNAL PROCESSING SYSTEM AND METHODS FOR USING SAME,” which claims the priority benefit, under 35 U.S.C. 119(c), of U.S. Application No. 63/386,694, filed Dec. 9, 2022 and entitled, “CARRIER FOR MODULAR SYNTHESIZERS AND METHODS FOR USING SAME.” Each of these applications is incorporated herein by reference in their entirety.

### BACKGROUND

A modular synthesizer is an electronic musical instrument that generates and manipulates audio signals. Modular synthesizers include one or more modules that each provide various functions, such as the generation and/or modulation of an audio signal, the generation of a control signal for another module, and/or the generation of a logic, timing, or trigger signal. Example modules include oscillators (e.g., a voltage-controlled oscillator, a low-frequency oscillator), amplifiers, filters, envelope generators, noise generators, and/or the like. Each module typically includes at least one input port and/or at least one output port to facilitate connection and transmission of various signals with other modules via one or more patch cables. Additionally, the modules often include user control inputs (e.g., a knob, a button, a key) to adjust, for example, the amplitude or frequency of an audio signal, the shape of a waveform, or the timing of a sequencer.

Conventional modular synthesizers typically include at least one case to mechanically and electrically support the modules. The case provides a mechanical interface to securely couple different modules of varying size to the case via one or more fasteners. A power supply and a power bus are also often disposed within the case to provide an electrical interface to supply electrical power to multiple modules. In some instances, modular synthesizers can include multiple cases with modules that are mechanically and electrically coupled together to form a larger system.

FIGS. 1A-ID show one example of a conventional modular synthesizer 10. Specifically, FIG. 1A shows an example configuration of the modular synthesizer 10 that includes modules 20a-20h installed into a case 30. As noted above, the signals from one module can be transmitted to another module via one or more patch cables. As an example, FIG. 1A includes patch cables 12 to electrically connect the module 20a to the module 20b. FIG. 1B shows another example configuration of the modular synthesizer 10 in a partially assembled state with only modules 20i and 20j installed. Generally, the number and type of modules installed into the modular synthesizer 10 can vary depending on the size of the case 30 and the types of modules desired by the user. Although FIGS. 1A and 1B show the modular synthesizer 10 with different modules, it should be appreciated the modular synthesizer 10 can generally include different combinations of the modules 20a-20j (also referred to herein more generally as the “module 20”) or other modules not shown.

FIG. 1B shows that each module 20 generally includes a faceplate 21 supporting the module's electronics 23, control inputs 25, and input/output ports 26. The case 30 is often formed as an enclosure that defines a cavity 31 and includes a pair of rails 33-1 and 33-2 (also referred to herein more generally as a “rail 33”) that each have an array of fastener openings 34. The module 20 is mechanically coupled to the case 30 by placing the faceplate 21 against the rails 33-1 and 33-2 such that fastener openings (not shown) on the faceplate 21 are aligned with corresponding fastener openings 34 on the rails 33-1 and 33-2. The module 20 is then securely coupled to the case 30 by inserting fasteners 22 through the respective fastener openings. In this manner, the faceplate 21, the control inputs 25, and the input/output ports 26 are exposed while more sensitive components of the module 20, such as the module's electronics 23, are contained in the cavity 31 of the case 30.

The case 30 further includes a power supply (not shown) and a power bus 40 disposed on a back portion 32 of the case 30. The power bus 40 is typically a printed circuit board (PCB) with multiple connectors 41 that can each be coupled to a module 20 to provide electrical power. Each module 20 is connected to the power bus 40 via a ribbon cable 42 that couples to the connector 41 of the power bus 40 and a corresponding connector (not shown) of the module's electronics 23. FIG. 1C shows a front view of the case 30, which can include a power supply 43 disposed within the cavity 31 to supply electrical power to the power bus 40. The power supply 43 is often an AC-to-DC converter. FIG. 1D shows a right-side view of a module 20. As shown, the module's electronics 23 include a connector 24 that couples to the ribbon cable 42.

FIG. 2 shows a diagram of a typical process to install a module 20 in the conventional modular synthesizer 10. First, the ribbon cable 42 is coupled to the connector 24 of the module's electronics 23 and the connector 41 of the power bus 40 to electrically couple the module 20 to the power bus 40. Second, the module 20 is mechanically coupled to the case 30 by aligning the faceplate 21 of the module 20 with the rails 33 of the case 30 and inserting the fasteners 22 through respective fasteners openings of the faceplate 21 and the case 30. The module 20 can be removed from the case 30 by first removing the fasteners 22 followed by disconnecting the ribbon cable 42 from the connector 41 of the power bus 40. In this manner, the modular synthesizer 10, in principle, can be reconfigured and updated over time by allowing users to replace one or more of the modules.

Conventional modular synthesizers are typically designed in accordance with a standardized format to ensure compatibility between different cases, modules, and power supplies from different manufacturers. Various formats have been established over the years including, but not limited to, Eurorack, Buchla, Frac, Modcan A, MOTM, MU, Serge, and 500 Series. Each format generally includes a mechanical specification and an electrical specification. The mechanical specification imposes constraints on the size and dimensions of the case and the modules to ensure different-sized modules can be installed into the same case. The electrical specification imposes constraints on the operating voltages of the power supply and the module as well as the types of ports and connectors for the patch cables used to connect different modules together.

### SUMMARY

The Inventors have recognized and appreciated a modular synthesizer provides users a highly customizable musical instrument that can be readily tailored to generate audio signals according to the user's preferences. This is achieved by giving users the freedom to choose and combine different modules into one system and the flexibility to connect the modules in different ways via patch cables to generate a variety of different audio signals. However, the Inventors recognized the Inventors recognized the reconfigurable nature of modular synthesizers is seldom exploited by users due, in part, to the cumbersome and difficult manner in which the modules are installed. Instead, modular synthesizers are typically left unchanged after initial assembly. If a user desires a different combination or arrangement of modules, a new modular synthesizer is typically built at great expense to the user.

Referring again to the modular synthesizer 10, the modules 20 are generally coupled mechanically to the case 30 via multiple fasteners 22. The modules 20 typically use two to four fasteners 22 for assembly. However, larger modules often include more fasteners. Each time the module 20 is installed or removed, the user needs to tighten or loosen each fastener 22, which is a time-consuming and laborious process that makes it difficult for the user to replace the modules 20 in an expeditious manner. This is further exacerbated by the fasteners 22 often including small nylon washers to protect the faceplate 21 from wear (also sometimes referred to as “rack rash”). The fasteners 22 and the washers can be easily lost during assembly and disassembly. Additionally, modular synthesizers often include multiple cases that each support a set of modules. Each case can originate from different manufacturers with fastener openings that have different thread sizes in both metric units (e.g., M2.5, M3) and imperial units (e.g., 3/32″). As a result, modular synthesizers with multiple cases often include different sizes and types of screws (e.g., Phillips, hex, Torx), which can be challenging to manage.

During assembly and disassembly, the user should also carefully connect or disconnect the module 20 to the power bus 40, which can be challenging due to the cumbersome way the modules 20 are mechanically coupled to the case 30. During assembly, the user typically holds the module 20 with one hand while connecting the ribbon cable 42 to the power bus 40 or a flying bus cable with the other hand. As more modules 20 are installed, the module's electronics 23 and the ribbon cables 42 progressively occupy more space in the cavity 31. This can make it harder for the user to electrically connect the last remaining modules 20 to the power bus 40 since the user often has to reach around or between modules that are already installed to access the space within the cavity 31. In some instances, the installation and removal of one module 20 can require the removal and reinstallation of other modules 20 to provide sufficient space in the cavity 31.

The connectors 41 of the power bus 40 also typically include male headers either with unkeyed sockets or without a socket all together. This can easily result in the ribbon cable 42 being connected backwards where the pins of the ribbon cable 42 and the pins of the connector 41 are reversed, which can severely damage the module 20 when the modular synthesizer 10 is turned on since most modules 20 do not typically include built-in current protection. Additionally, once the modules 20 are removed, the sensitive components of the module 20, such as the module's electronics 23, are exposed and, hence, vulnerable to static shock, which can also damage the module 20. Thus, the modules 20 should also be placed into an antistatic bag, box, or case after removal.

The Inventors have also recognized that conventional modular synthesizers do not include any stored memory or record of a particular arrangement of modules. Said in another way, the modules 20 of the modular synthesizer 10 are not networked together and thus, the identity and location of the modules 20 installed in the modular synthesizer 10 cannot be tracked. If a user wishes to test different configurations of modules 20 to determine a configuration that best suits their preferences, they need to manually record the arrangement of the modules 20 for each configuration, which can be a laborious process.

In view of the foregoing limitations of previous modular synthesizers, the present disclosure is directed to various inventive implementations of a case assembly to facilitate the assembly of, for example, a modular synthesizer. The case assembly includes a case couplable to one or more carriers designed to appreciably improve the case of installing and uninstalling a module to the case and associated methods thereof.

First, the case assembly provides a mechanical interface that securely supports the module while allowing the module to be inserted or removed from the case more easily and quickly compared to previous modular synthesizers. In particular, the carrier generally includes a frame with a module attachment mechanism to mechanically couple the module to the carrier via, for example, one or more fasteners. The carrier is, in turn, mechanically coupled to the case via a locking mechanism with quick-release features that can be readily actuated by a user to engage or disengage the carrier with the case (e.g., without tightening any fasteners to securely couple the carrier to the case). Thus, the user can couple the module to the carrier using the fasteners in one step/movement. Thereafter, the locking mechanism can be used to facilitate the insertion or removal of the modules in the case. In this manner, the case assemblies described herein reduces the amount of labor and time to install and uninstall a module compared to previous modular synthesizers.

Second, the case assembly also provides an electrical interface that simplifies the process of electrically connecting a module to the electronics of the case (also referred to herein as “case electronics”), such as a power bus and a power supply. Specifically, the carrier can include carrier electronics in the form of one or more circuit boards that are electrically coupled to the module via, for example, an electrical cable. The carrier electronics, in turn, are electrically coupled to the power bus via an array of pogo pins (i.e., spring-loaded electrical connectors) that are pressed into contact with corresponding electrical traces when, for example, the carrier is mechanically coupled to the case. In other words, the carrier can mechanically and electrically couple and/or decouple the module to the case simultaneously. In this manner, the case assemblies described herein also simplifies the electrical installation of a module by eliminating the need to manually attach or detach an electrical cable to the module electronics each time a module is installed or removed as in previous modular synthesizers. Additionally, the likelihood of the module being electrically connected to the case incorrectly, for example by attaching a connector backwards, is also reduced or, in some instances, eliminated.

In some implementations, the carrier is mechanically and electrically coupled to the module in a semi-permanent manner. For example, the carrier can be coupled to the module during initial assembly of the modular synthesizer and remain coupled to the module even if the module is later removed. This permits the user to couple multiple carriers to corresponding modules and subsequently swap out or rearrange the modules as desired. Generally, one or more carriers can be mounted to a module depending, in part, on the size and weight of the module. For example, a relatively smaller and/or lighter module can be supported by a single carrier mounted on one side of the module. In another example, a relatively larger and/or heavier module can be supported by a pair of carriers disposed on opposing sides of the module. For this example, one set of carrier electronics can be mounted to one of the carriers.

The module attachment mechanism of the carrier can also readily accommodate modules with different attachment mechanisms, which can vary based on the manufacturer or a particular standardized format if the module is designed to meet the mechanical and electrical specifications of the format. For example, a module that conforms to the Eurorack format is typically mounted to a case via one or more screw fasteners (see, for example, the module 20 in FIGS. 1A-1D). The module attachment mechanism can thus include fastener openings that align with the fastener openings on the faceplate of the module. Although the user should attach the module to the carrier with multiple fasteners, the difference between the modular synthesizers described herein and previous modular synthesizers is that the user only couples the module to the carrier once.

The locking mechanism, as described above, can generally include one or more quick-release features disposed on the carrier and/or the case so that the user can readily engage or disengage the locking mechanism. In some implementations, the locking mechanism can be engaged and disengaged without the use of any tools (e.g., a screwdriver, a wrench). The locking mechanism can also be engaged or disengaged by the user actuating a single actuator (e.g., a switch, a lever, a button) mounted to the carrier or the case. The case assembly can include a variety of quick-release features including, but not limited to, a snap-fit connector, a clamp, a twist lock, a linkage mechanism, a cam lock, and a push button.

The case assembly can also include an alignment mechanism to facilitate alignment of the carrier to the case before the locking mechanism is engaged. Generally, the alignment mechanism reduces or limits the translational and rotational degrees of the freedom between the carrier and the case without rigidly affixing the carrier to the case. For example, the alignment mechanism can couple the carrier to the case such that the carrier cannot be easily removed from the case, but still provide some play between the case and the carrier. That way, the user can coarsely position the carrier with the module to the case and, once the alignment mechanism is engaged, finely position the carrier before the locking mechanism locks the carrier in place. In another example, the alignment mechanism can include a pair of rails disposed on the case and multiple quick-release features disposed on the carrier that couple to the rails such that the carrier can slide along the rails while the remaining translational and rotational degrees of freedom between the carrier and the case are constrained.

The case generally provides a structure to mechanically and electrically couple one or more carriers and modules together. As noted above, the locking mechanism and the alignment mechanism can include features formed, at least in part, on the case to facilitate the mechanical coupling of the carrier to the case. Additionally, the case can include case electronics to electrically couple the module to various electrical systems including, but not limited to, an electrical power supply, a computer, and a network router. The case electronics generally include one or more circuit boards that can be electrically coupled to the carrier electronics via a combination of pogo pins and electrical traces as described above.

Generally, various modules can be installed into the case assemblies including, but not limited to, an oscillator (e.g., a voltage-controlled oscillator, a low-frequency oscillator), an amplifier, a filter, an envelope generator, and a noise generator. The number of modules that can be installed is limited only by the relative dimensions of the case and the modules. In some implementations, one or more modules can be installed that only occupy a portion of the case assembly. The remaining, unoccupied space in the case assembly can be covered, for example, by one or more blank faceplates mounted to one or more carriers.

In some implementations, the case assembly can mechanically and electrically support modules that conform to a particular standardized format, such as Eurorack, Buchla, Frac, Modcan A, MOTM, MU, Serge, or 500 Series. That way, commercially off-the-shelf modules designed for a particular format can be readily integrated into the case assemblies described herein. This can be accomplished, in part, by the carrier having a module attachment mechanism that is compatible with one or more of these formats. In other words, the module attachment mechanism provides structural features that allow the modules to be mechanically coupled to the carrier in the same manner as the cases used in previous modular synthesizers. For example, the module attachment mechanism can include fastener openings sized and positioned based on the Eurorack format to facilitate attachment to the faceplates of Eurorack modules as noted above.

Although the carrier and the case define the mechanical interface instead of the module and the case as in previous modular synthesizers, the cases described herein can still satisfy the mechanical specification defined by the standardized format. That way, the case assemblies can be installed into the same enclosures as previous modular synthesizers. For example, the case assembly can be installed into a 19-inch rack by dimensioning the case based on the Eurorack format where the height of the case is equal to a 3U rack height (e.g., a height of about 5.25 inches or 133.4 mm) and the width of the case is equal to 84 Horizontal Pitch (HP) units where 1 HP is equal to 0.2 inches. However, it should be appreciated that, in some implementations, the case can be designed without imposing any constraints from a standardized format.

Additionally, the various electronics of the case assembly can also satisfy the electrical specification of a particular standardized format. For example, the case electronics and the carrier electronics can comply with the Eurorack format by providing at least one +12V electrical connections, at least one −12V electrical connections, at least one ground connection and, optionally, at least one +5V electrical connection, at least one Gate connection, and at least one Control Voltage (CV) connection.

It should also be appreciated that, in some implementations, the case, the carrier, and the module can be designed without imposing any mechanical or electrical limitations to meet a standardized format. Said in another way, new modules can be developed together with the case assembly to create a new format. For example, the various mechanical and electrical features of the carrier can be integrated into the module. In this manner, a user can acquire a module and directly install the module into a case using the same mechanical and electrical coupling features described above, thus further improving the case of installing and uninstalling modules.

Generally, the case electronics and the carrier electronics supply the module with electrical power. In some implementations, the case assembly and, in particular, the case electronics and the carrier electronics can also provide an electronic interface to network them modules together and facilitate data transmission and/or control signals to or from each of the modules. For example, the identification of the modules (e.g., the model number, the module type) and the location of the modules in the case assembly can be monitored and stored by a remote computer. This, in turn, allows the user to more easily record multiple configurations of modules particularly when the user is testing different configurations. In another example, the case electronics and the carrier electronics can transmit a command from a remote computer to turn specific modules on or off. In yet another example, the case electronics and the carrier electronics can transmit timing or clock signals to the modules to control the tempo of the audio signals generated by the various modules. In yet another example, the case assemblies described herein can be readily electrically coupled to other case assemblies to form a larger modular synthesizer where electrical power and/or network communications are shared between more modules. This can be accomplished, in part, by connecting the case assemblies together using a wired connection with one or more electrical cables.

It should be appreciated the various features and concepts of the case assemblies described herein is not limited only to modular synthesizers, but can be applied more generally to any modular signal processing system. For example, the case assemblies described herein can be used for various signal conditions systems including, but not limited to, various metrology systems with various sensors (e.g., piezoelectric sensors, capacitive sensors, temperature sensors, photo) and motion control systems (e.g., robotics).

In one example, a case assembly for a modular signal processing system comprises: a case having at least one ledge; case electronics, directly coupled to the case, to supply at least one of electrical power or data communication, the case electronics having a first circuit board with a plurality of electrical traces; and a carrier configured to mechanically and electrically support a module, the carrier including: a frame mechanically coupled to the case and configured to support the module; a locking mechanism, coupled to the frame, having at least one movable connector end to engage the al least one ledge of the case to securely couple the frame to the case, the locking mechanism being configured to release the at least one connector end from the case when actuated; and carrier electronics configured to supply the at least one of the electrical power or the data communication from the case electronics to the module, the carrier electronics having a plurality of pogo pin connectors in electrical contact with the plurality of electrical traces of the case electronics.

In another example, a case assembly for a modular signal processing system comprises: a case; case electronics, directly coupled to the case, to supply at least one of electrical power or data communication; and a carrier configured to mechanically and electrically support a module, the carrier including: a frame mechanically coupled to the case and configured to support the module; and carrier electronics electrically coupled to the case electronics and configured to supply the at least one of the electrical power or the data communication from the case electronics to the module, wherein: the carrier is mechanically coupled to the case in a tool-less manner; and the carrier electronics are electrically coupled to the case electronics without using an electrical cable.

In another example, a case assembly for a modular synthesizer comprises: a case; case electronics, directly coupled to the case, to supply electrical power; and a carrier, including: a frame configured to be mechanically coupled directly to the case; and carrier electronics, configured to be operatively coupled directly to the case electronics to receive the electrical power from the case electronics, wherein the carrier is configured to be mechanically and operatively coupled directly to a module when the module is present so as to mechanically couple the module to the case and operatively couple the module to the case electronics by transmitting the electrical power to the module.

In another example, a method for installing a module into a case of a modular signal processing system includes the following steps: A) mechanically coupling a faceplate of the module to a carrier of the modular signal processing system via an attachment mechanism; B) electrically connecting the module to carrier electronics of the carrier; C) inserting the carrier into a cavity of the case, at least a portion of the module being disposed within the cavity of the case; and D) actuating a locking mechanism of the carrier to mechanically couple the carrier to the case and electrically couple the carrier electronics to case electronics of the case, wherein the case electronics supplies at least one of electrical power or data communication to the module via the carrier electronics.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1A shows a perspective view of a conventional modular synthesizer in one example configuration.

FIG. 1B shows a perspective view of the modular synthesizer of FIG. 1A in another example configuration and in a partially assembled state.

FIG. 1C shows a front view of a case in the modular synthesizer of FIG. 1A.

FIG. 1D shows a right-side view of a representative module used in the modular synthesizer of FIG. 1A.

FIG. 2 shows a cross-sectional right-side view of the modular synthesizer of FIG. 1A illustrating an example procedure to install a module into the case.

FIG. 3A shows a front, right, top perspective view of an example modular signal processing system with a case assembly that includes a carrier to mechanically and electrically couple a module to a side portion of a case.

FIG. 3B shows a front, left, bottom perspective view of the modular signal processing system of FIG. 3A.

FIG. 3C shows a front view of the modular signal processing system of FIG. 3A.

FIG. 3D shows a top view of the modular signal processing system of FIG. 3A.

FIG. 3E shows a left-side view of the modular signal processing system of FIG. 3A.

FIG. 3F shows a cross-sectional view of the modular signal processing system of FIG. 3A corresponding to the plane A-A of FIG. 3D.

FIG. 3G shows a cross-sectional view of the modular signal processing system of FIG. 3A corresponding to the plane B-B of FIG. 3D.

FIG. 3H shows an exploded front, top, left perspective view of the modular signal processing system of FIG. 3A.

FIG. 3I shows an exploded front, top, right perspective view of the modular signal processing system of FIG. 3A.

FIG. 4A shows a front, left, bottom perspective view of multiple carriers supporting a module in the modular signal processing system of FIG. 3A.

FIG. 4B shows a front, right, top perspective view of the carriers of FIG. 4A.

FIG. 4C shows a rear, right, bottom perspective view of the carriers of FIG. 4A.

FIG. 4D shows a bottom view of the carriers of FIG. 4A.

FIG. 5A shows a front, left, bottom perspective view of the case in the modular signal processing system of FIG. 3A.

FIG. 5B shows a front, right, top perspective view of the case of FIG. 5A.

FIG. 5C shows an exploded front, left, top perspective view of the case of FIG. 5A.

FIG. 5D shows a magnified exploded front, left, bottom perspective view of the case electronics and the case of FIG. 5A.

FIG. 5E shows an exploded front, right, bottom perspective view of the case electronics of FIG. 5D.

FIG. 6 shows a side view of an example stand to support a modular signal processing system 100a.

FIG. 7 shows a diagram and table specifying the dimensions for a module in accordance with the Eurorack format.

FIG. 8A shows an example of electrically expandable case electronics.

FIG. 8B shows an example circuit with logic gates to determine an order of modules in the modular signal processing system.

FIG. 9 shows a cross-sectional right-side view of another example modular signal processing system with a case assembly that includes a carrier to mechanically and electrically couple a module to a back portion of a case.

FIG. 10A shows a perspective view of another example modular signal processing system with a case assembly that includes multiple carriers to mechanically and electrically couple corresponding modules to a back portion of a case.

FIG. 10B shows a cross-sectional left-side view of the modular signal processing system of FIG. 10A corresponding to the plane A-A of FIG. 10A.

FIG. 11A shows a perspective view of the carrier in the modular signal processing system of FIG. 10A with a representative module.

FIG. 11B shows a left-side view of the carrier and the module of FIG. 11A.

FIG. 11C shows a magnified left-side view of a module attachment mechanism in the carrier of FIG. 11B.

FIG. 11D shows a magnified front view of the module attachment mechanism of FIG. 11C.

FIG. 12A shows a perspective view of another example carrier with a representative module where the carrier has another example module attachment mechanism.

FIG. 12B shows another perspective view of the carrier and the module of FIG. 12A.

FIG. 12C shows a magnified perspective view of the module attachment mechanism in the carrier of FIG. 12A.

FIG. 13A shows a perspective view of another example carrier with ribs for mechanical reinforcement and alignment with a module and/or a case.

FIG. 13B shows a perspective view of a variant of the carrier of FIG. 13A without an aperture.

FIG. 13C shows a magnified perspective view of a module attachment mechanism in the carriers of FIGS. 12A and 12B.

FIG. 13D shows a magnified perspective view of a variant of the module attachment mechanism of FIG. 13C where the fastener opening is formed as a slot.

FIG. 14A shows a perspective view of another example carrier with a module attachment mechanism that includes attachment slots.

FIG. 14B shows a perspective view of a variant of the carrier of FIG. 14A without an aperture.

FIG. 14C shows a magnified perspective view of a module attachment mechanism in the carriers of FIGS. 13A and 13B.

FIG. 15A shows a perspective view of another example carrier with a module attachment mechanism that includes rail posts.

FIG. 15B shows a perspective view of a variant of the carrier of FIG. 15A without an aperture and longer rail posts.

FIG. 15C shows a magnified perspective view of the module attachment mechanism in the carriers of FIGS. 14A and 14B.

FIG. 16 shows a cross-sectional side view of a module faceplate and an example cap assembly with an indicator coupled to the faceplate.

FIG. 17A shows a perspective view of another example cap that can be used in the cap assembly of FIG. 16.

FIG. 17B shows a cross-sectional side view of the cap of FIG. 17A.

FIG. 18A shows a perspective view of an example fastener with threads to couple the cap assembly to a module faceplate and/or a carrier.

FIG. 18B shows a cross-sectional side view of the fastener of FIG. 18A where the fastener is a threaded rod.

FIG. 18C shows a cross-sectional side view of the fastener of FIG. 18A where the fastener includes a bolt head.

FIG. 18D shows a cross-sectional side view of the fastener of FIG. 18A where the fastener includes a screw head.

FIG. 19A shows a side view of another example fastener with threads and a snap-fit connector to couple a cap assembly to a module faceplate and/or a carrier.

FIG. 19B shows a front view of the fastener of FIG. 19A.

FIG. 20 shows a side view of another example fastener with threads and multiple snap-fit connector to couple a cap assembly to a module faceplate and/or a carrier.

FIG. 21A shows a cross-sectional side view of another example fastener with a cam lock to couple a cap assembly to a module faceplate and/or a carrier.

FIG. 21B shows a perspective view of the fastener of FIG. 21A with a cam in the cam lock removed.

FIG. 21C shows a side view of the fastener of FIG. 21B.

FIG. 22 shows a side view of another example cam for the cam lock of FIG. 21A.

FIG. 23 shows a cross-sectional side view of another example fastener with a nut and a bolt tethered to the carrier.

FIG. 24A shows a cross-sectional side view of another example alignment mechanism that includes a snap-fit connector disposed on the carrier with lead-in and lead-out portions and ribs.

FIG. 24B shows a magnified perspective view of an end of the snap-fit connector of FIG. 24A.

FIG. 25A shows a cross-sectional side view of another example alignment mechanism that includes a snap-fit connector with lead-in portions and ribs.

FIG. 25B shows a cross-sectional side view of another example alignment mechanism that includes a snap-fit connector with only lead-in portions.

FIG. 25C shows a cross-sectional side view of another example alignment mechanism that includes a compression spring and a translatable connector end.

FIG. 25D shows a cross-sectional side view of another example alignment mechanism that includes a compression spring and a rotatable connector end.

FIG. 25E shows a cross-sectional side view of another example alignment mechanism that includes a torsion spring and a movable connector end.

FIG. 25F shows a cross-sectional side view of another example alignment mechanism that includes a leaf spring and a movable connector end.

FIG. 26A shows a cross-sectional side view of another example alignment mechanism that includes a leaf spring with a round connector end and a wheel.

FIG. 26B shows a magnified perspective view of the round connector end of the leaf spring of FIG. 26A.

FIG. 27A shows a cross-sectional side view of another example alignment mechanism with a rotatable connector end and a push button.

FIG. 27B shows a cross-sectional side view of the alignment mechanism of FIG. 27A with a spring.

FIG. 27C shows a cross-sectional side view of another variant of the alignment mechanism of FIG. 27A with a different push button.

FIG. 28A shows a front view of a pair of another example alignment mechanisms where each alignment mechanism includes a compression spring and a dome-shaped connector end.

FIG. 28B shows a cross-sectional side view of one of the alignment mechanisms of FIG. 28A.

FIG. 29A shows a cross-sectional front view of another example alignment mechanism that includes a compression spring, a dome-shaped connector end, and a wall defining a channel.

FIG. 29B shows a cross-sectional side view of the alignment mechanisms of FIG. 29A.

FIG. 30A shows a cross-sectional side view of another example alignment mechanism with a ball end, a plunger to guide the ball end, and a compression spring disposed in a wall defining a channel.

FIG. 30B shows a cross-sectional side view of another example alignment mechanism with a ball end and a compression spring disposed in a wall defining a channel that guides the ball end.

FIG. 30C shows a cross-sectional side view of another example alignment mechanism with a ball end and a compression spring disposed in a wall defining a channel where the wall limits the displacement of the ball end.

FIG. 31A shows a cross-sectional side view of another example locking mechanism with a twist lock that includes a round connector end. The locking mechanism is shown disengaged.

FIG. 31B shows a cross-sectional side view of the locking mechanism of FIG. 31A where the locking mechanism is shown engaged.

FIG. 31C shows a cross-sectional front view of the round connector end of FIG. 31A when engaged and disengaged.

FIG. 31D shows a cross-sectional side view of another knob to actuate the locking mechanism of FIG. 31A.

FIG. 32A shows a cross-sectional side view of another example locking mechanism with a twist lock that includes a round connector end and a spring washer that together forms a push-spring mechanism. The locking mechanism is shown disengaged.

FIG. 32B shows a cross-sectional side view of the locking mechanism of FIG. 32A where the locking mechanism is shown engaged.

FIG. 33A shows a cross-sectional side view of another example locking mechanism with a rotatable connector end, a compression spring, and a ball guide. The locking mechanism is shown disengaged.

FIG. 33B shows a cross-sectional side view of the locking mechanism of FIG. 33A where the locking mechanism is shown engaged.

FIG. 34A shows a cross-sectional side view of another example locking mechanism with a linkage mechanism on the carrier and a recessed portion on the case. The locking mechanism is shown disengaged.

FIG. 34B shows a cross-sectional side view of the locking mechanism of FIG. 34A where the locking mechanism is shown engaged.

FIG. 35A shows a cross-sectional side view of another example locking mechanism with another linkage mechanism disposed on one side of the carrier and a dome-shaped connector end disposed on another side of the carrier. The locking mechanism is shown disengaged.

FIG. 35B shows a cross-sectional side view of the locking mechanism of FIG. 35A where the locking mechanism is shown engaged.

FIG. 36A shows a cross-sectional side view of another example locking mechanism where the carrier includes a rotatable peg with a tooth and the case includes an opening to receive the peg. The locking mechanism is shown engaged.

FIG. 36B shows a perspective view of the rotatable peg of FIG. 36A.

FIG. 36C shows a perspective view of the rotatable peg of FIG. 36A being inserted into the opening of the case.

FIG. 37A shows a cross-sectional side view of another example case assembly with a case and a carrier with a locking mechanism that couples to the sides of the carrier.

FIG. 37B shows an inset view of another example locking mechanism for the case assembly of FIG. 37A where the locking mechanism includes a rotatable locking end.

FIG. 38A shows an inset view of another example locking mechanism that includes another rotatable locking end actuated by a rotatable actuator.

FIG. 38B shows an inset view of another example locking mechanism that includes a translatable locking end and a slidable actuator that moves perpendicularly with respect to the locking end.

FIG. 39A shows a cross-sectional view of another example locking mechanism that includes a plunger latch with a pusher mechanism. The locking mechanism is shown engaged.

FIG. 39B shows a cross-sectional view of the locking mechanism of FIG. 39A disengaged.

FIG. 40 shows a cross-sectional view of another example locking mechanism that includes a plunger latch with a pusher mechanism that operates as a push lock. The locking mechanism is shown engaged.

FIG. 41A shows a cross-sectional view of another example locking mechanism that includes a plunger latch with a pusher mechanism. The locking mechanism is shown engaged.

FIG. 41B shows a cross-sectional view of the locking mechanism of FIG. 41A disengaged.

FIG. 42A shows a perspective view of a snap fit support and a clamp in the locking mechanisms of FIGS. 39A, 40, and 41A.

FIG. 42B shows a magnified view of the snap fit support and the clamp as incorporated in the locking mechanism of FIG. 39A.

FIG. 43A shows a perspective view of another example locking mechanism that includes a plunger latch with a slide mechanism. The locking mechanism is shown disengaged.

FIG. 43B shows a perspective view of the locking mechanism of FIG. 43A engaged.

FIG. 44A shows another example locking mechanism that includes a cantilever spring.

FIG. 44B shows a perspective view of the cantilever spring of FIG. 44A.

FIG. 45A shows a perspective view of another example locking mechanism with a vertical pinch mechanism.

FIG. 45B shows a side view of the locking mechanism of FIG. 45A engaged with a case.

FIG. 45C shows a side view of the locking mechanism of FIG. 45A disengaged from the case.

FIG. 46A shows a cross-sectional view of another example locking mechanism with a vertical pinch mechanism that includes a single mechanically compliant component.

FIG. 46B shows a cross-sectional view of the locking mechanism of FIG. 46A engaged with a case.

FIG. 47A shows a perspective view of an example round undercut along a side portion of the case for the vertical pin mechanisms of FIGS. 45A and 46A to engage when connected to the case.

FIG. 47B shows a perspective view of an example flat undercut along a side portion of the case for the vertical pin mechanisms of FIGS. 45A and 46A to engage when connected to the case.

FIG. 47C shows a perspective view of an example indented flat undercut along a side portion of the case for the vertical pin mechanisms of FIGS. 45A and 46A to engage when connected to the case.

FIG. 48A shows a front perspective view of another example locking mechanism with a vertical pinch mechanism that includes at least one spring to provide a retaining force for engagement.

FIG. 48B shows a rear perspective view of the locking mechanism of FIG. 48A.

FIG. 49A shows a cross-sectional view of another example locking mechanism with a wireform spring.

FIG. 49B shows a cross-sectional view of another example locking mechanism with a wireform spring having a different geometry than the spring of FIG. 49A.

FIG. 50A shows a cross-sectional view of another example locking mechanism with a wireform spring having an overmold.

FIG. 50B shows a perspective view of another example locking mechanism with a wireform spring having an overmold where the end of the wireform spring is exposed.

FIG. 51A shows a perspective view of other examples of wireform springs.

FIG. 51B shows a perspective view of an example wireform spring with dual tabs.

FIG. 51C shows a perspective view of an example wireform spring formed as a flat spring.

FIG. 52A shows cross-sectional views of another example wireform spring engaged (locked) and disengaged (unlocked).

FIG. 52B shows cross-sectional views of yet another example wireform spring engaged (locked) and disengaged (unlocked).

FIG. 52C shows cross-sectional views of yet another example wireform spring.

FIG. 52D shows a perspective view of another example wireform spring.

FIG. 53A shows a perspective view of another example locking mechanism with a slidable plastic snap.

FIG. 53B shows a perspective view of another example locking mechanism with a plastic snap having a hinge.

FIG. 53C shows a cross-sectional view of another example locking mechanism with an O-ring and a sprung latch mechanism.

FIG. 54A shows a cross-sectional view of another example locking mechanism with a rotatable deformable elastomer element.

FIG. 54B shows a perspective view of another example locking mechanism with a compressible elastomer element.

FIG. 54C shows a cross-sectional view of another example locking mechanism with a deformable elastomer element.

FIG. 55A shows a cross-sectional view of another example locking mechanism with a wireform and an overmold formed from a deformable elastomer element.

FIG. 55B shows a perspective view of the locking mechanism of FIG. 55A.

FIG. 56A shows multiple views of another example locking mechanism with a deformable elastomer element according to a fingernail concept.

FIG. 56B shows multiple cross-sectional views of yet another example locking mechanism with a deformable elastomer element according to the fingernail concept of FIG. 56A.

FIG. 57A shows multiple views of another example locking mechanism with a deformable elastomer element according to a duckbill concept.

FIG. 57B shows a perspective view of yet another example locking mechanism with a deformable elastomer element according to the duckbill concept of FIG. 57A.

FIG. 57C shows a perspective view of example deformable elastomer elements according to the duckbill concept of FIG. 57A.

FIG. 58A shows a perspective view of another example locking mechanism with a deformable elastomer element according to a beam concept.

FIG. 58B shows a top view of another example locking mechanism with a deformable elastomer element according to the beam concept of FIG. 58A.

FIG. 59A shows a perspective view of another example locking mechanism with a rotary geared latch.

FIG. 59B shows a perspective view of the locking mechanism of FIG. 59A with removed for clarity.

FIG. 60A shows a cross-sectional perspective view of the locking mechanism of FIG. 59A.

FIG. 60B shows a cross-sectional side view of the locking mechanism of FIG. 59A.

FIG. 61A shows a side view of another example locking mechanism with a rotary latch and a cable.

FIG. 61B shows a perspective view of the locking mechanism of FIG. 61A.

FIG. 62A shows a side view of another example locking mechanism with a linear latch and a cable.

FIG. 62B shows a cross-sectional view of the locking mechanism of FIG. 62A.

FIG. 63A shows a perspective view of another example locking mechanism with a spring latch and a cable.

FIG. 63B shows another perspective view of the locking mechanism of FIG. 63A.

FIG. 64A shows a perspective view of another example handle for the locking mechanisms of FIGS. 61A, 62A, and 63A.

FIG. 64B shows another perspective view of the handle of FIG. 64A.

FIG. 65 shows a cross-sectional side view of another example case assembly where a back side of the carrier is clamped to a back portion of the case.

FIG. 66A shows a magnified cross-sectional side view of another example locking mechanism that includes a locking end and an actuator end joined to the locking end at an obtuse angle.

FIG. 66B shows a magnified cross-sectional side view of another example locking mechanism that includes a locking end and an actuator end joined to the locking end at a straight angle.

FIG. 66C shows a magnified cross-sectional side view of another example locking mechanism that includes a locking end and an actuator end joined to the locking end at an acute angle.

FIG. 67A shows a magnified cross-sectional side view of another example locking mechanism that includes a locking end and an actuator end joined to the locking end at an obtuse angle actuated by a movable wedge.

FIG. 67B shows a magnified cross-sectional side view of another example locking mechanism that includes a locking end and an actuator end joined to the locking end at a straight angle actuated by a movable wedge.

FIG. 68A shows a magnified cross-sectional side view of another example locking mechanism that includes a locking end actuated by a pulley mechanism with a wire.

FIG. 68B shows a magnified cross-sectional side view of another example locking mechanism that includes a locking end actuated by a gear train.

FIG. 69 shows a perspective view of an example rotary actuator to actuate the locking mechanisms of FIG. 41A or 41B.

FIG. 70A shows a perspective view of another example locking mechanism with a locking end that securely couples multiple carriers to a case. The locking end is actuated by a linkage mechanism.

FIG. 70B shows a side view of the locking mechanism of FIG. 70A.

FIG. 70C shows a front view of the locking mechanism of FIG. 70A.

FIG. 71 shows a perspective view of another example locking mechanism with a locking end that securely couples multiple carriers to a case. The locking end is actuated by a different linkage mechanism.

FIG. 72 shows a cross-sectional side view of another example locking mechanism with a locking end that securely couples multiple carriers to a case and a linkage mechanism that is slidably actuated along the depth of a case assembly to engage or disengage the locking end.

FIG. 73A shows a cross-sectional side view of another example locking mechanism with a locking end that securely couples multiple carriers to a case and a linkage mechanism that is slidably actuated along the width of a case assembly to engage or disengage the locking end.

FIG. 73B shows a top view of the linkage mechanism of FIG. 73A.

FIG. 73C shows a front view of the linkage mechanism of FIG. 73A.

FIG. 74A shows a top view of another example locking mechanism with a locking end that securely couples multiple carriers to a case and a linkage mechanism that is slidably actuated along the width of a case assembly to engage or disengage the locking end. The linkage mechanism further includes a push release mechanism.

FIG. 74B shows a magnified cross-sectional view of the push release mechanism.

FIG. 75A shows a cross-sectional side view of an example linkage mechanism for the locking mechanisms of FIG. 43A or 44 where the linkage mechanism is rotatably actuated to engage or disengage the locking end. The locking mechanism is shown engaged.

FIG. 75B shows a cross-sectional side view of the linkage mechanism of FIG. 75A where the locking mechanism is shown disengaged.

FIG. 76A shows a cross-sectional side view of another example locking mechanism that includes a locking end actuated by a slider.

FIG. 76B shows a cross-sectional side view of another example locking mechanism that includes a locking end actuated by a four-bar linkage mechanism actuated by a slider.

FIG. 76C shows a magnified side view of the slider to actuate the locking mechanisms of FIGS. 49A and 49B.

FIG. 77A shows a top, front, right-side perspective view of another example modular signal processing system that includes a carrier and a case with a push-push locking mechanism.

FIG. 77B shows a cross-sectional view of the carrier and the case of FIG. 77A according to the cross-section A-A of FIG. 78E.

FIG. 78A shows a top, rear, left-side perspective view of the carrier of FIG. 77A.

FIG. 78B shows a bottom, rear, right-side perspective view of the carrier of FIG. 77A.

FIG. 78C shows a right-side view of the carrier of FIG. 77A.

FIG. 78D shows a magnified perspective view of the push-push locking mechanism of FIG. 77A.

FIG. 78E shows a magnified perspective view of the push-push locking mechanism of FIG. 77A.

FIG. 78F shows a left-side view of the locking mechanism of FIG. 77A.

FIG. 78G shows a cross-sectional view of the locking mechanism of FIG. 77A according to the cross-section A-A of FIG. 78E.

FIG. 78H shows a cross-sectional view of the locking mechanism of FIG. 77A according to the cross-section B-B of FIG. 78E.

FIG. 78I shows a front perspective view of a subassembly of the locking mechanism of FIG. 77A with an actuator.

FIG. 78J shows a rear perspective view of the subassembly of FIG. 78I.

FIG. 78K shows a front perspective view of a subassembly of the locking mechanism of FIG. 77A with a latch carrier.

FIG. 78L shows a rear perspective view of the subassembly of FIG. 78K.

FIG. 79A shows a bottom view of an example backplane power distribution circuit board.

FIG. 79B shows a top view of the backplane power distribution circuit board of FIG. 79A.

FIG. 80 shows a circuit diagram of the backplane power distribution circuit board of FIG. 79A.

FIG. 81A shows a top view of an example power and data communications circuit board.

FIG. 81B shows a bottom view of the power and data communications circuit board of FIG. 81A.

FIG. 82A shows a circuit diagram of a microcontroller in the power and data communications circuit board of FIG. 81A.

FIG. 82B shows a circuit diagram of a communications and power connector in the power and data communications circuit board of FIG. 81A.

FIG. 82C shows a circuit diagram of a status light emitting diode (LED) in the power and data communications circuit board of FIG. 81A.

FIG. 82D shows a circuit diagram of a reset supervisor in the power and data communications circuit board of FIG. 81A.

FIG. 82E shows a circuit diagram of an Espressif (ESP) Prog circuit board in the power and data communications circuit board of FIG. 81A.

FIG. 82F shows a circuit diagram of an ESP Debug circuit board in the power and data communications circuit board of FIG. 81A.

FIG. 82G shows a circuit diagram of a wireless communication device in the power and data communications circuit board of FIG. 81A.

FIG. 82H shows a circuit diagram of a Bluetooth Low Energy (BLE) module in the power and data communications circuit board of FIG. 81A.

FIG. 82I shows a circuit diagram of a 15V input in the power and data communications circuit board of FIG. 81A.

FIG. 82J shows a circuit diagram of a cooling fan in the power and data communications circuit board of FIG. 81A.

FIG. 82K shows a circuit diagram of a 12V regulator in the power and data communications circuit board of FIG. 81A.

FIG. 82L shows a circuit diagram of a 3.3V regulator in the power and data communications circuit board of FIG. 81A.

FIG. 82M shows a circuit diagram of a 12V single-ended primary-inductor converter (SEPIC) switching converter in the power and data communications circuit board of FIG. 81A.

FIG. 82N shows a circuit diagram of a backplane connector in the power and data communications circuit board of FIG. 81A.

FIG. 82O shows circuit diagrams of a 5V regulator and a cooling fan in the power and data communications circuit board of FIG. 81A.

FIG. 82P shows circuit diagrams of various current sensing devices in the power and data communications circuit board of FIG. 81A.

FIG. 82Q shows a circuit diagram of a spare power connection in the power and data communications circuit board of FIG. 81A.

FIG. 82R shows a circuit diagram of power test points in the power and data communications circuit board of FIG. 81A.

FIG. 83A shows a top view of an example carrier electronics circuit board.

FIG. 83B shows a bottom view of the carrier electronics circuit board of FIG. 83A.

FIG. 84A shows a circuit diagram of a microcontroller in the carrier electronics circuit board of FIG. 83A.

FIG. 84B shows a circuit diagram of an insulation-displacement contact (IDC) connector in the carrier electronics circuit board of FIG. 83A.

FIG. 84C shows a circuit diagram of a spring-pin printed circuit board assembly (PCBA) connector in the carrier electronics circuit board of FIG. 83A.

FIG. 84D shows a circuit diagram of electrically reversible programmable read-only memory (EEPROM) with a unique identifier (UID) in the carrier electronics circuit board of FIG. 83A.

FIG. 84E shows a circuit diagram of a status LED in the carrier electronics circuit board of FIG. 83A.

FIG. 84F shows a circuit diagram of an electromagnetic interference suppression component in the carrier electronics circuit board of FIG. 83A.

FIG. 84G shows a circuit diagram of a −12V Enable circuit in the carrier electronics circuit board of FIG. 83A.

FIG. 84H shows a circuit diagram of a current monitor in the carrier electronics circuit board of FIG. 83A.

FIG. 84I shows a circuit diagram of a +12V Enable circuit in the carrier electronics circuit board of FIG. 83A.

FIG. 84J shows a circuit diagram of a +5V Enable circuit in the carrier electronics circuit board of FIG. 83A.

FIG. 84K shows circuit diagrams of capacitive touch sensors in the carrier electronics circuit board of FIG. 83A.

FIG. 85A shows a top view of an example pogo pin connector board.

FIG. 85B shows a bottom view of the pogo pin connector board of FIG. 85A.

FIG. 86A shows a circuit diagram of a circuit board electrical connector in the pogo pin connector board of FIG. 85A.

FIG. 86B shows a circuit diagram of a pogo pin electrical connector in the pogo pin connector board of FIG. 85A.

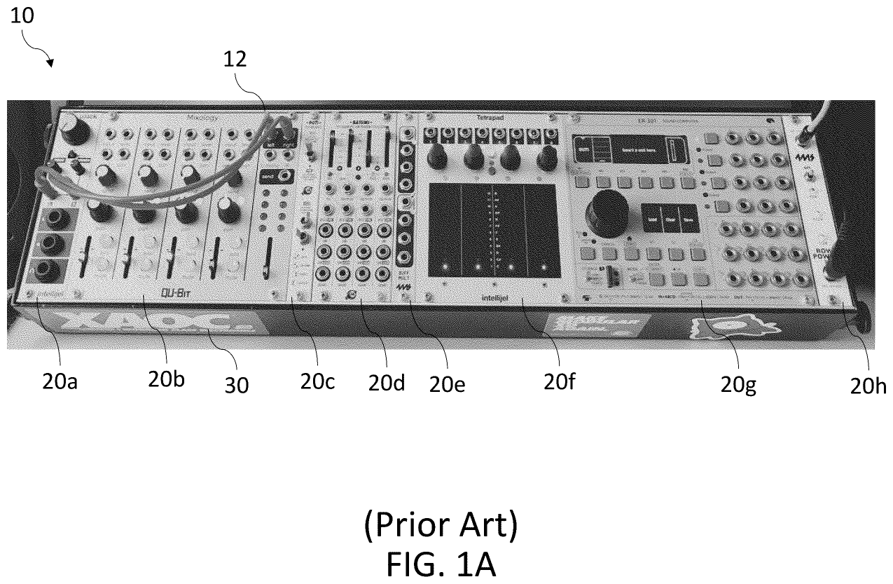

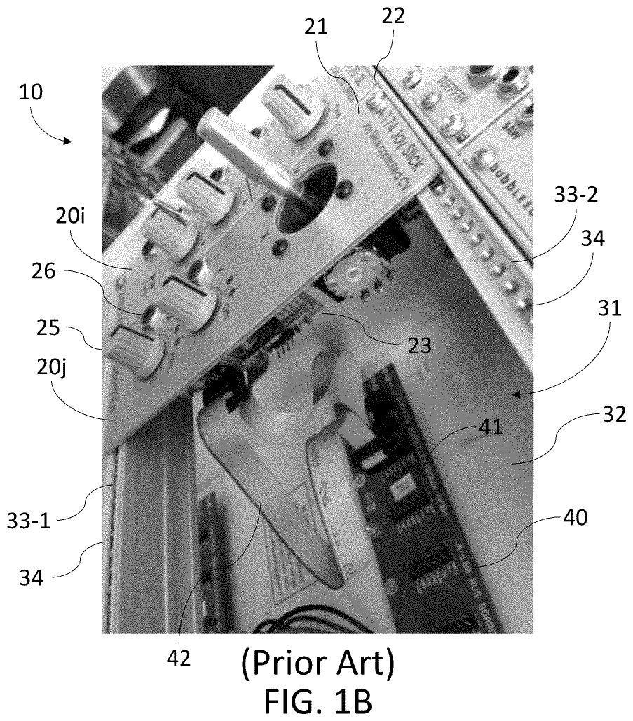

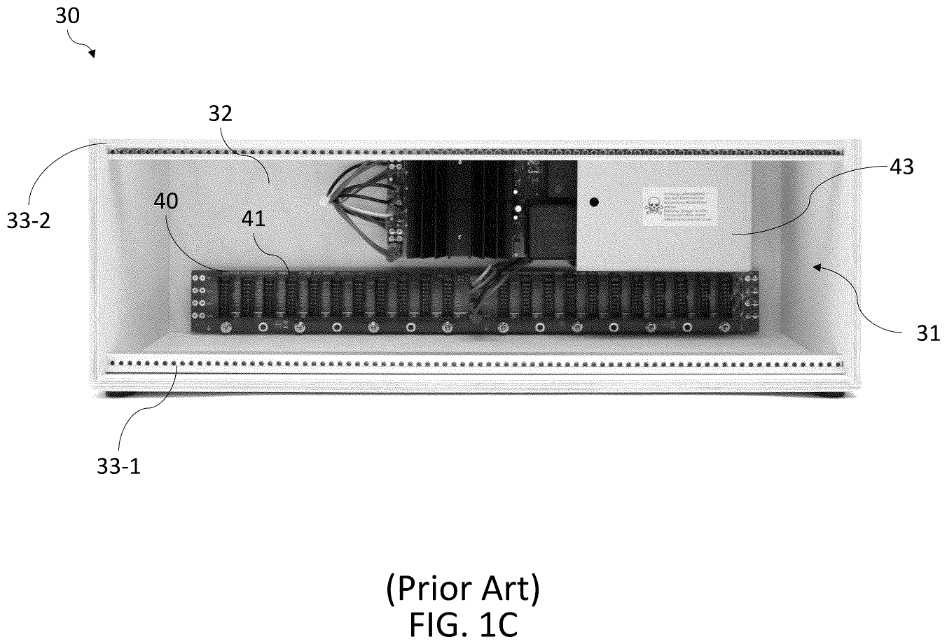

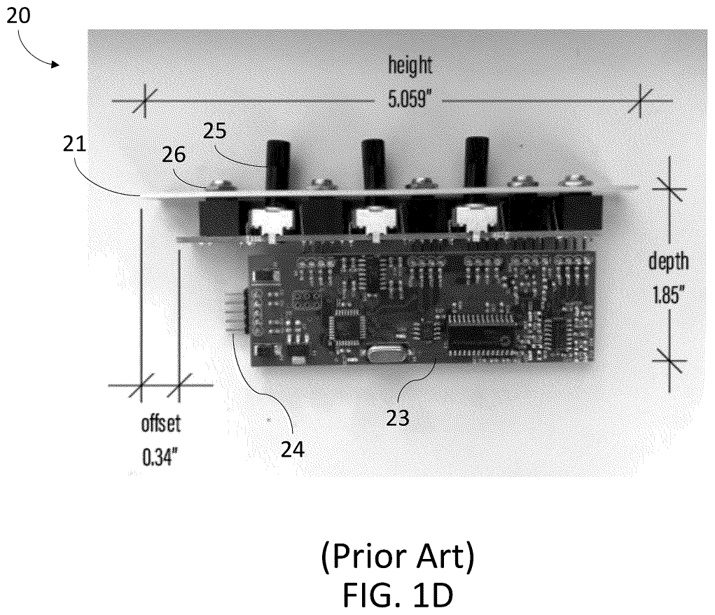

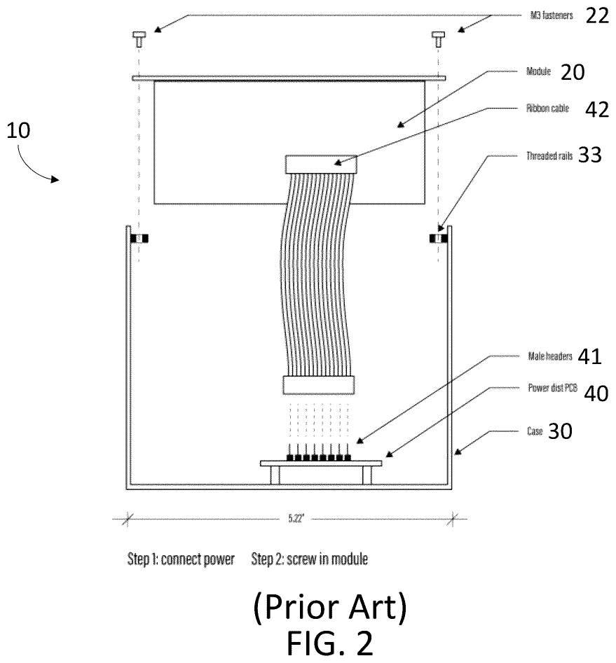

### DETAILED DESCRIPTION

Following below are more detailed descriptions of various concepts related to, and implementations of, a case assembly for a modular synthesizer and other modular signal processing systems that includes a carrier and a case that improves the case of installing and uninstalling a module. The electronics of the carrier and the case can also provide additional functionality, such as tracking and storing the identity and location of the modules, remote control, and transmission of timing or clock signals. It should be appreciated that various concepts introduced above and discussed in greater detail below may be implemented in multiple ways. Examples of specific implementations and applications are provided primarily for illustrative purposes so as to enable those skilled in the art to practice the implementations and alternatives apparent to those skilled in the art.

The figures and example implementations described below are not meant to limit the scope of the present implementations to a single embodiment. Other implementations are possible by way of interchange of some or all of the described or illustrated elements. Moreover, where certain elements of the disclosed example implementations may be partially or fully implemented using known components, in some instances only those portions of such known components that are necessary for an understanding of the present implementations are described, and detailed descriptions of other portions of such known components are omitted so as not to obscure the present implementations.

In the discussion below, various examples of inventive case assemblies are provided, wherein a given example or set of examples showcases one or more particular features of a carrier, carrier electronics, a case, and case electronics. It should be appreciated that one or more features discussed in connection with a given example of a case assembly may be employed in other examples of case assemblies according to the present disclosure, such that the various features disclosed herein may be readily combined in a given case assembly according to the present disclosure (provided that respective features are not mutually inconsistent).

Certain dimensions and features of the case assembly are described herein using the terms “approximately,” “about,” “substantially,” and/or “similar.” As used herein, the terms “approximately,” “about,” “substantially,” and/or “similar” indicates that each of the described dimensions or features is not a strict boundary or parameter and does not exclude functionally similar variations therefrom. Unless context or the description indicates otherwise, the use of the terms “approximately,” “about,” “substantially,” and/or “similar” in connection with a numerical parameter indicates that the numerical parameter includes variations that, using mathematical and industrial principles accepted in the art (e.g., rounding, measurement or other systematic errors, manufacturing tolerances, etc.), would not vary the least significant digit.

### 1. An Example Case Assembly with a Side-Mounted Carrier

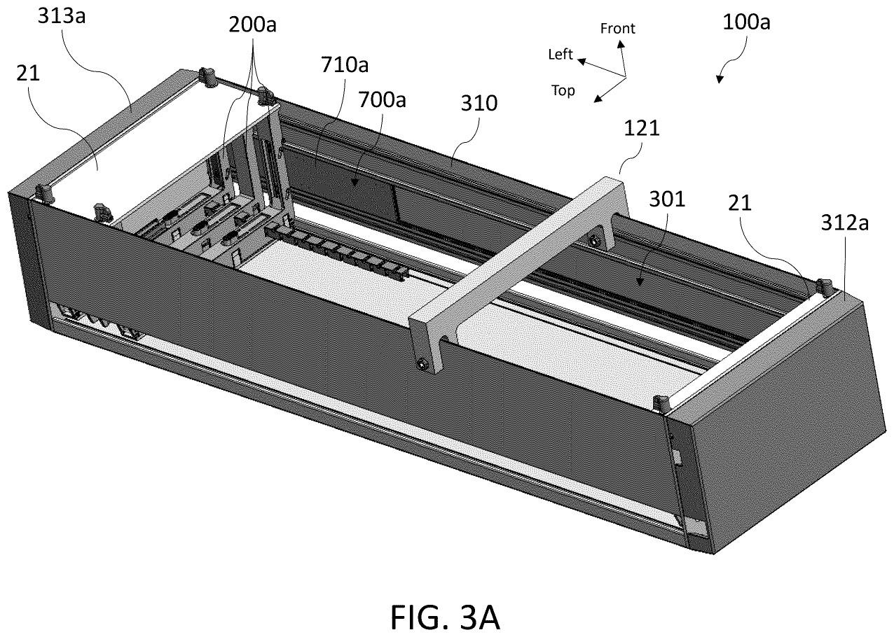

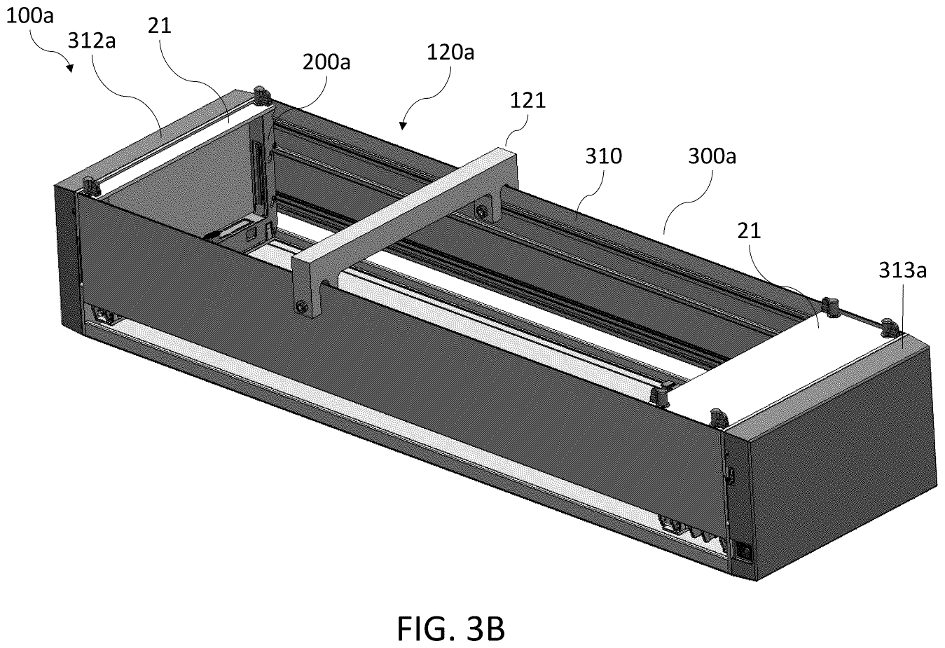

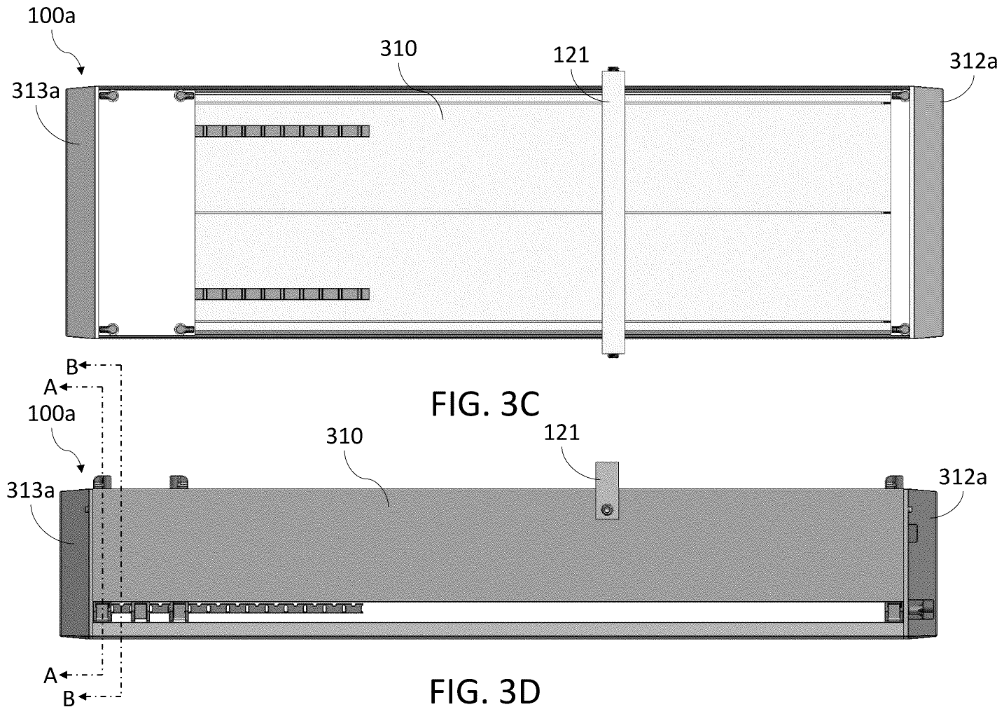

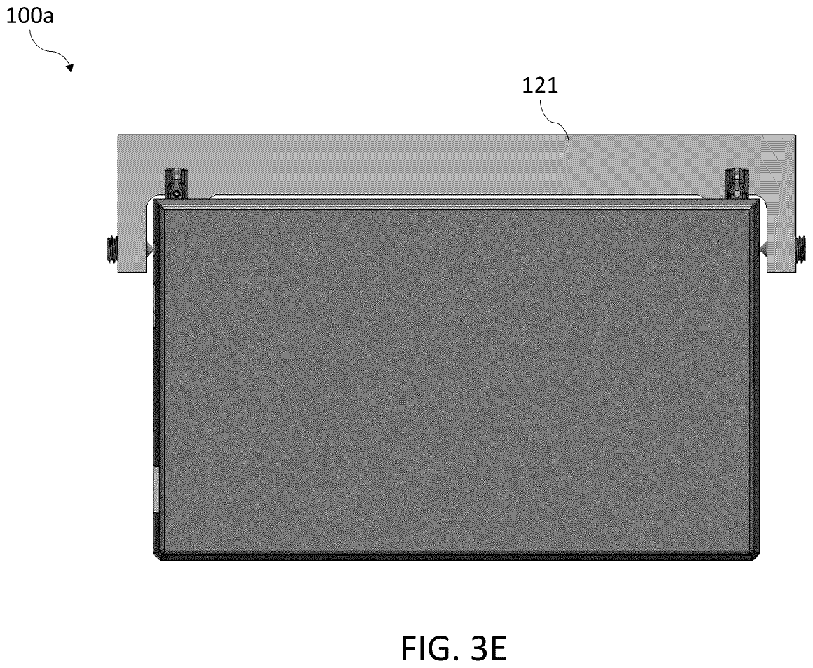

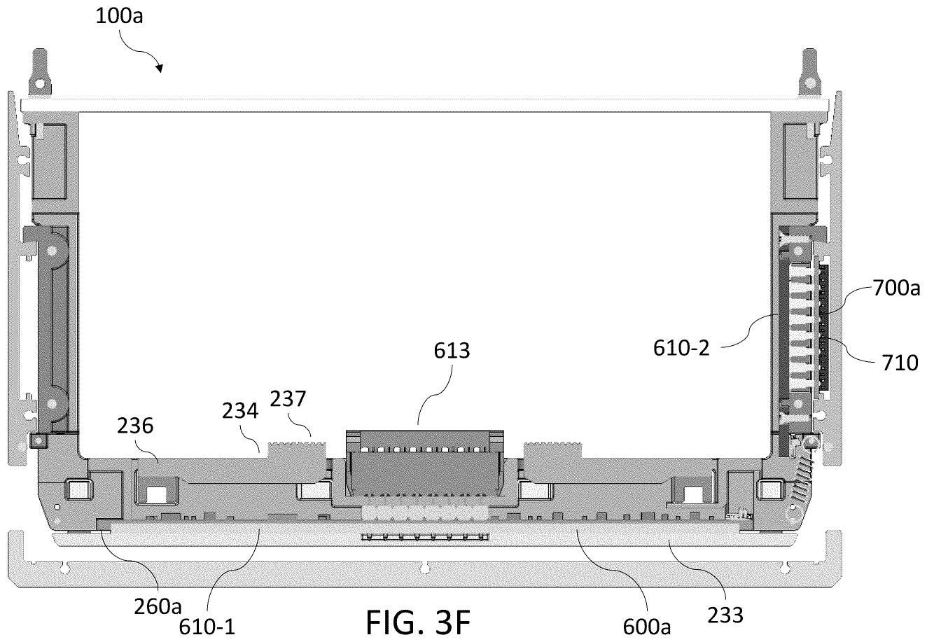

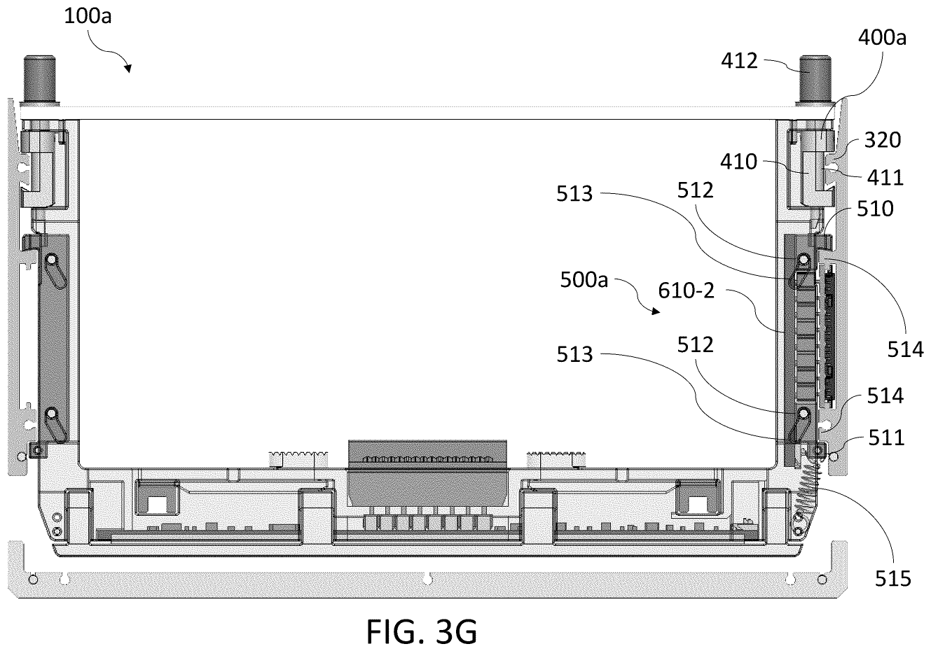

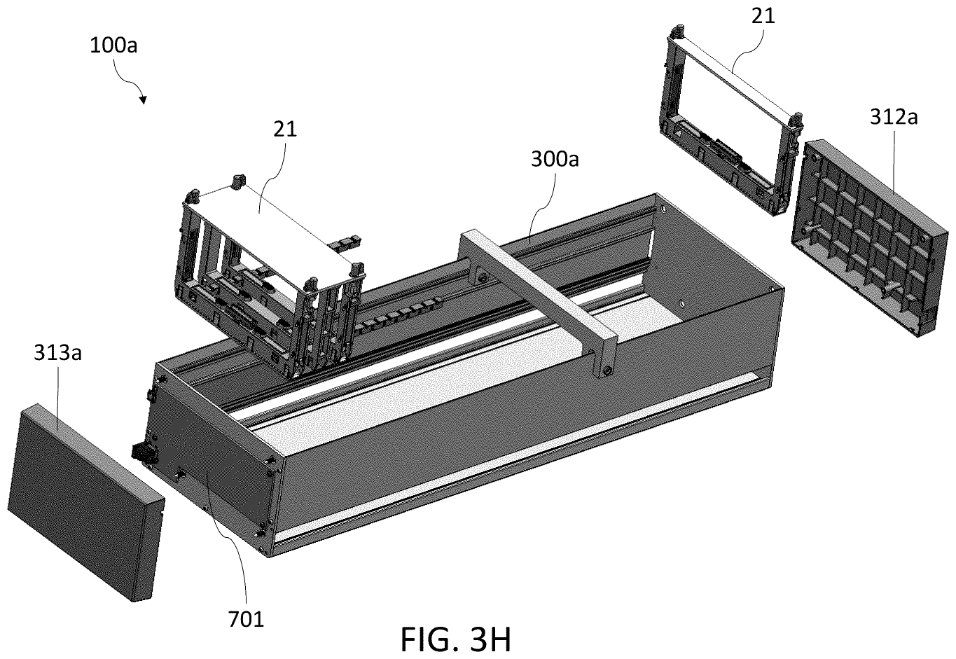

FIGS. 3A-3I show an example modular signal processing system 100a with a case assembly 120a that includes a case 300a and one or more carriers 200a supporting one or more modules 20. In FIGS. 3A-3I, each faceplate 21 is representative of a module 20 that can be installed.

As shown, each module 20 is supported by at least one carrier 200a. In some instances, multiple carriers 200a can be used to support one module. Specifically, the module 20 is mechanically coupled to the carrier 200a via at least one module attachment mechanism 240a. The carrier 200a also includes carrier electronics 600a to provide electrical power and, in some implementations, data communication to the module 20. The electronics 23 of the module 20 can be electrically coupled to the carrier electronics 600a via an electrical cable 130. The carrier 200a can be disposed within a cavity 301 of the case 300a and mechanically coupled to the case 300a via a combination of an alignment mechanism 400a and a locking mechanism 500a. The case 300a further includes case electronics 700a to provide at least electrical power and, in some implementations, data communication and control signals to one or more modules 20. Thus, the carrier 200a and the module 20 form a single discrete assembly that can be installed and uninstalled from the case 300a together. Said in another way, the carrier 200a can be mounted to the module 20 in a semi-permanent manner to provide the module 20 a mechanical interface, an electrical interface, and an electronic interface with the case 300a.

In some implementations, the same carrier 200a can be deployed in different cases 300a having different geometries (e.g., different depths). This can be accomplished, in part, by designing the carrier 200a and the case 300a such that the carrier 200a is mechanically coupled to one or more sides of the case 300a. For example, the respective features of the alignment mechanism 400a and the locking mechanism 500a can be disposed on the sides of the frame 310 of the case 300a and the frame 210 of the carrier 200a. Additionally, the carrier electronics 600a can be mounted to the side of the frame 210 and the case electronics 700a can be mounted to the side of the frame 310. Thus, the carrier 200a can be installed into a case 300a with different depths, thus allowing the user to more easily replace and swap modules 20 between different case assemblies 120a.

Additionally, the case assembly 120a can include a clamp 121 that is slidable along the case 300a. The clamp 121 can be used to adjust the position of a module along the width of the case 300a.

In the following, the various features of the case assembly 120a are described for one example application where the modular signal processing system 100a is a modular synthesizer. Thus, the modular signal processing system 100a is also referred to as a modular synthesizer 100a. However, it should be appreciated that the case assembly 120a and the various components forming the case assembly 120a can be used in other modular signal processing systems 100a as well. For example, the modular signal processing system 100a can be various signal conditions systems including, but not limited to, various metrology systems with various sensors (e.g., piezoelectric sensors, capacitive sensors, temperature sensors, photo) and motion control systems (e.g., robotics).

### 1.1 Carrier Design

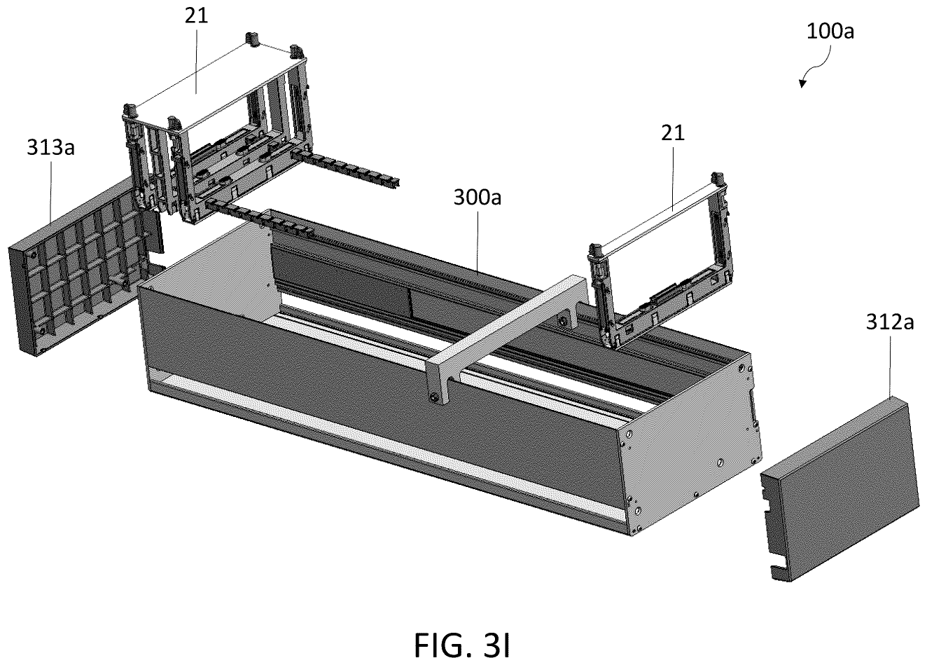

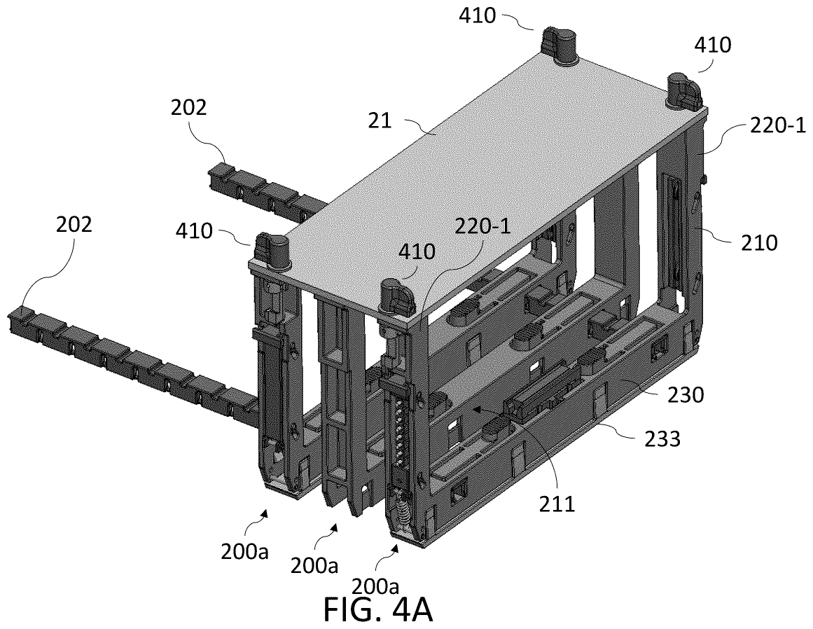

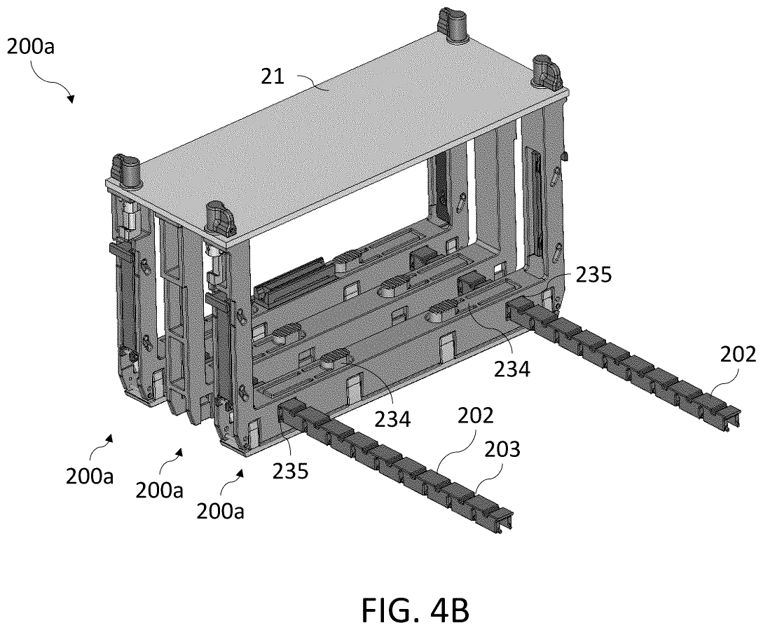

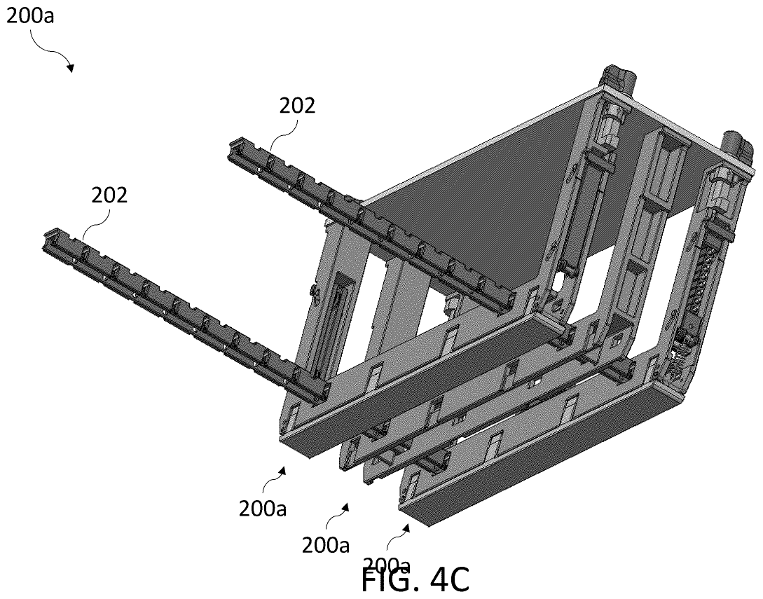

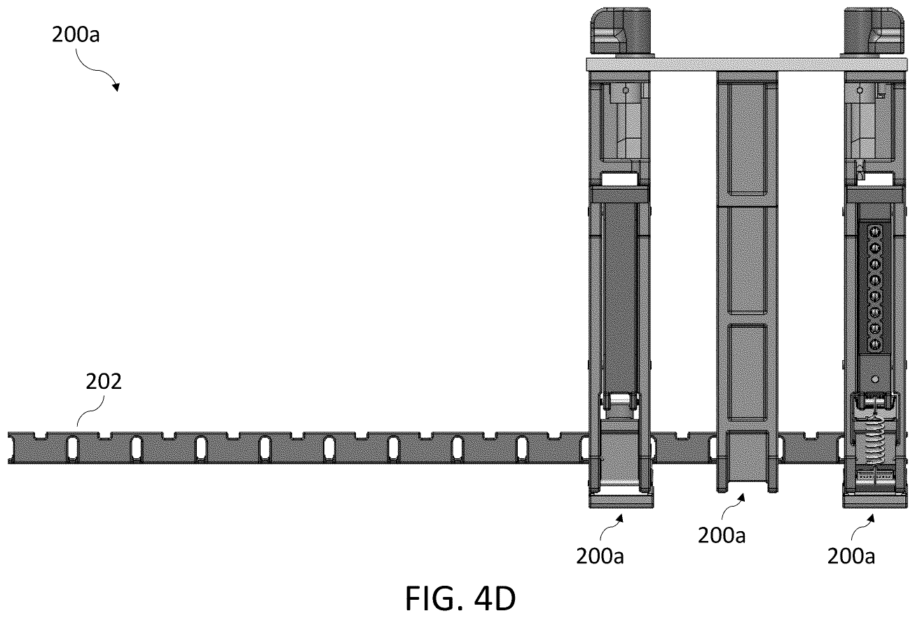

FIGS. 4A-4D show several additional views of multiple carriers 200a. As shown, each carrier 200a includes a frame 210 with a base portion 230 and a pair of arms 220-1 and 220-2 that together define an aperture 211. The frame 210 generally supports various mechanical features to mechanically couple the module 20 (represented by the face plate 21) to the carrier 200a and mechanically couple the carrier 200a to the case 300a. Additionally, the frame 210 also includes a bottom cover 233 with a circuit board attachment mechanism 260a to mechanically couple the carrier electronics 600a (e.g., the circuit board 610-1) to the frame 210.

The carrier 200a can generally accommodate different sized modules 20 without imposing any constraints on the placement of the module 20 within the case 300a. In other words, the carrier 200a allows the modules 20 to be arranged in the case 300a in the same manner as in previous modular synthesizers. This is achieved, in part, by the aperture 211 being shaped and/or dimensioned to allow portions of the module 20 disposed in the cavity 301 of the case 300a, such as the module's electronics 23, to pass through the aperture 211 unimpeded. In other words, the arms 220-1 and 220-2 of the carrier 200a wrap around module 20 such that the carrier 200a can be mechanically coupled to the faceplate 21 without increasing the overall width of the module 20. This allows the respective faceplates 21 of the modules 20, which are each supported by a carrier 200a, to abut one another in the same manner as in previous modular synthesizers. Said another way, the width of the carrier 200a and the module 20 together is equal to the width of the module 20 alone.

Generally, the depth of the module (i.e., the module's extent into the cavity 301 of the case 300a) typically varies between modules. To compensate for this variability, the aperture 211 of the frame 210 can be shaped and dimensioned to accommodate modules 20 with a larger depth. That way, the electronics 23 of modules 20 with a smaller depth can still pass through the aperture 211. In some implementations, the dimensions of the carrier 200a can also depend on the type of case 300a used in the case assembly 120a. For example, the overall depth of the carrier 200a can be less than or equal to about 2 inches to support installations in skiff-style cases. In another example, the overall depth of the carrier 200a can be greater than about 2 inches to support installations in rack-style cases. The exterior height of the carrier 200a can generally range between about 1 inch and about 10 inches. The exterior width of the carrier 200a can range between about 0.1 inches and about 1 inch.

FIG. 4A shows three carriers 200a can support a single module. However, it should be appreciated that this is a non-limiting example and that one or more carriers 200a can generally be used to support one or more modules. For example, one carrier 200a can support one module, two carriers 200a can support one module, and so on. The assembly of carriers 200a can further provide one or more alignment mechanisms 400a to secure a module to the carrier(s) 200a. For example, FIG. 4A shows the assembly of carriers 200a can provide four twist locks 410 aligned to corresponding openings (not shown) at respective corners of the faceplate 21. As shown, not all carriers 200a in the assembly of FIG. 4A can support a twist lock 410 (see middle carrier 200a). In some implementations, when multiple carriers 200a are used to support a module, only one of the carriers 200a may include the carrier electronics 600a for that module.

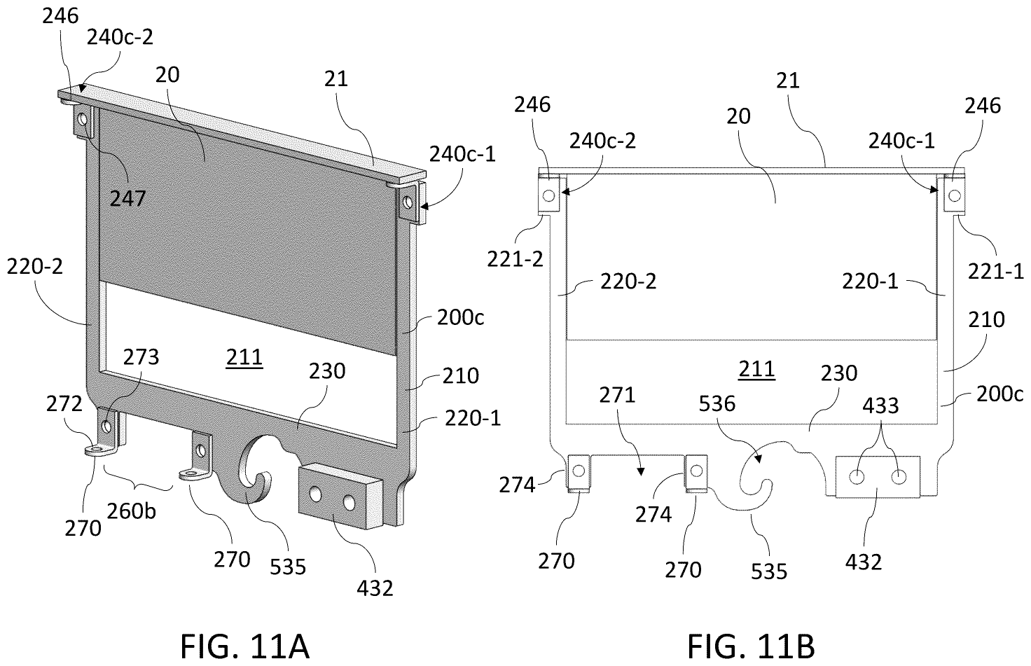

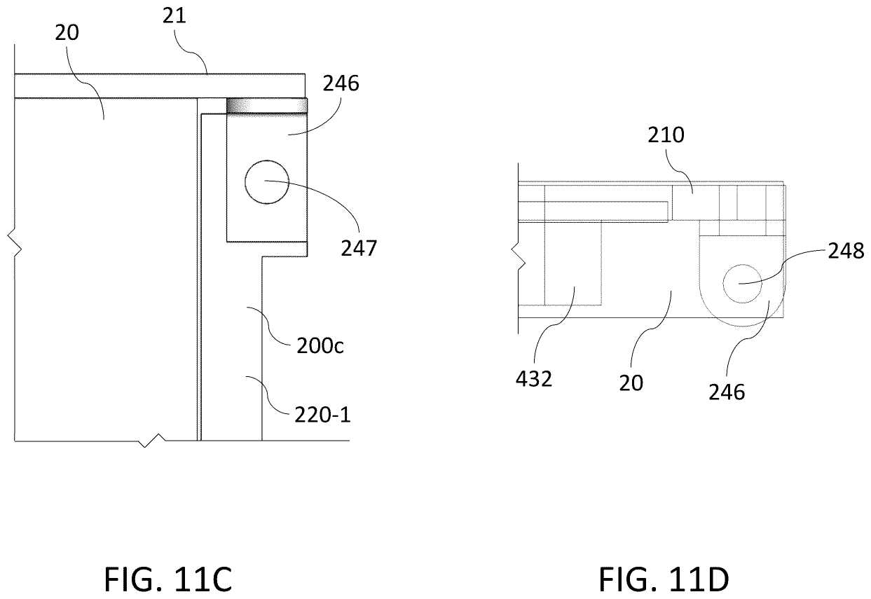

The carrier 200a can be formed from various metals, polymers, and composites including, but not limited to, aluminum, steel, copper, polycarbonate, polyoxymethylene, acrylic, glass-filled nylon, fiberglass, and any combinations of the foregoing. As described above, the carrier 200a can include an assembly of components, in part, to provide the various mechanical mounting features to support the module 20 and/or to define movable components in the alignment mechanism 400a or the locking mechanism 500a. However, it should be appreciated that, in some implementations, the carrier 200a can be formed as a single monolithic component (see, for example, the carriers 200d-200j in FIGS. 11A-14B).

In some implementations, one or more carriers 200a supporting one or more modules 20 may be mounted together as a subassembly before being installed together into the case 300a. This may provide greater flexibility and convenience by allowing users to readily preassemble and swap out subsets of modules as desired. For example, FIGS. 4A and 4B show the carriers 200a can be mounted to a pair of rails 202. As shown, the frame 210 of each carrier 200a may include a pair of openings 235 disposed on the bottom section 230 through which the rails 202 may be respectively inserted. The bottom section 230 further includes a pair of locking mechanisms 234 to securely couple the frame 210 to a portion of the rails 402. For example, the locking mechanism 234 may each include a snap fit connector with an end 236 that engages a channel 203 on the rail 202. The snap fit connector may be actuated by a button 237 to release the locking mechanism 234 from the rail 202 and thus allow the carrier 200a to slide along the rail 202. As shown in FIGS. 4A-4C, the rails 202 may have a length sufficient to accommodate multiple carriers 200a supporting one or more modules.

### 1.2 Case Design

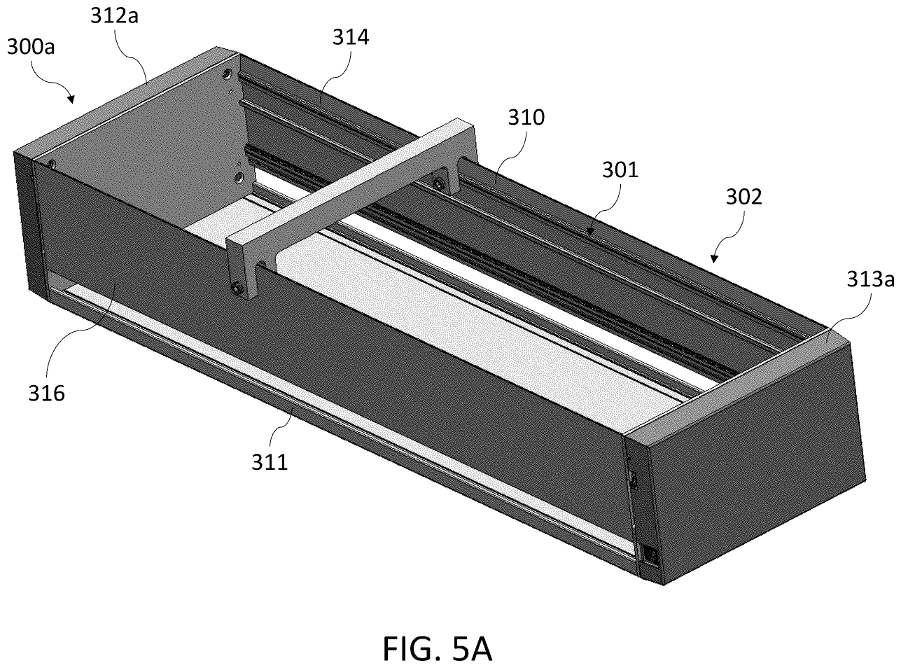

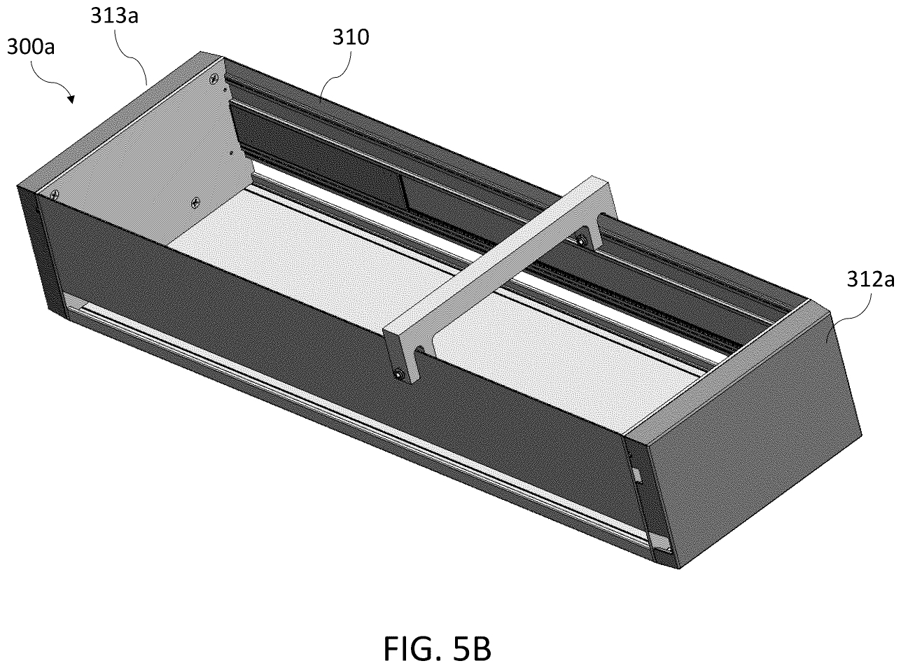

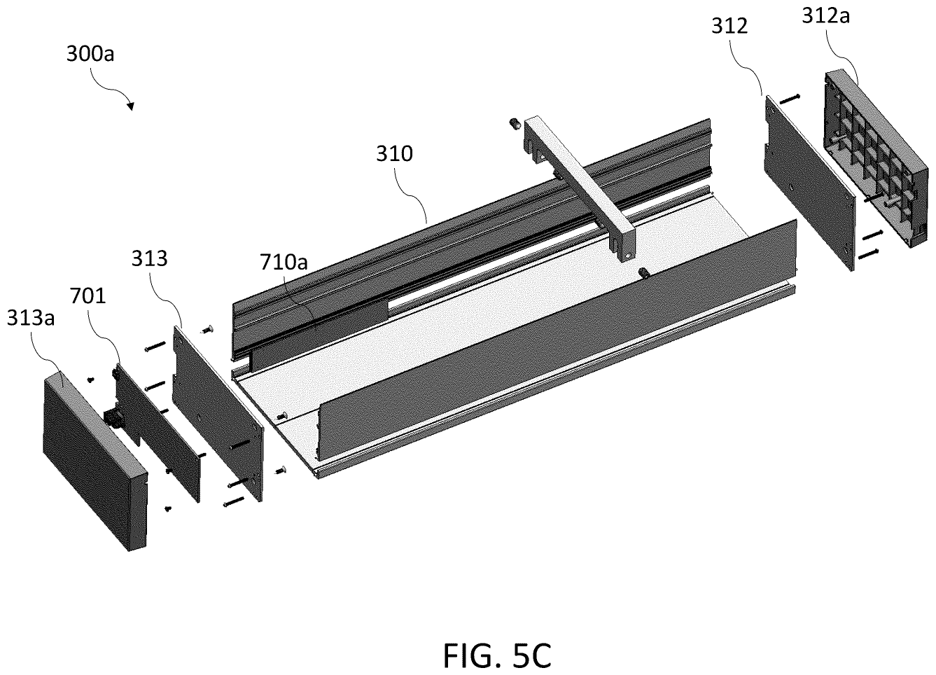

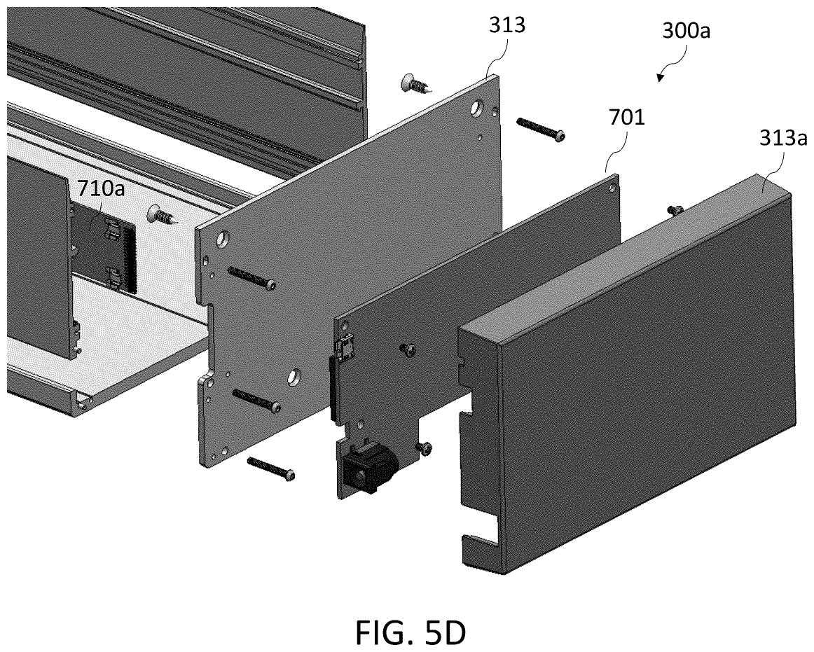

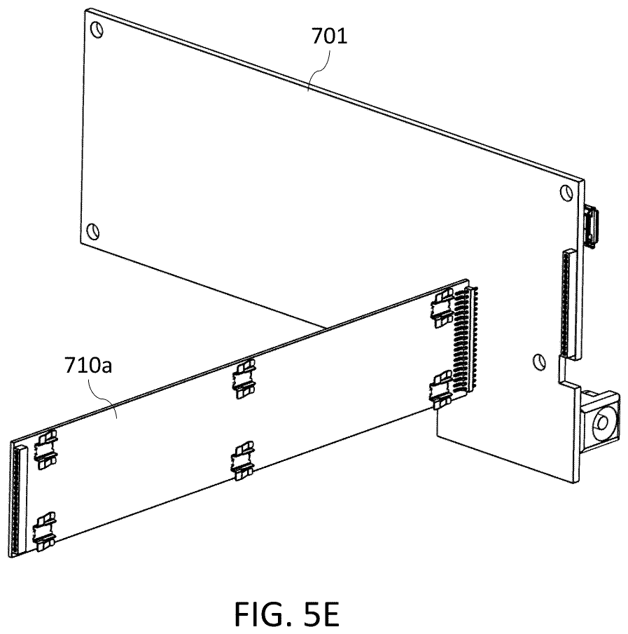

FIGS. 5A-5E show several additional views of the case 300a. As shown, the case 300a includes a frame 310 that defines a cavity 301 with a front opening 302 through which the modules 20 and the carriers 200a can be inserted or removed from the case 300a.

As shown in FIGS. 5A and 5B, the case 300a can be formed as an enclosure to contain the case electronics 700a, the carriers 200a, and portions of the modules 20 (e.g., the module's electronics 23) where only the faceplates 21, the user input controls 25, and the input and/or output ports 26 are exposed. As shown, the frame 310 is shaped as a rectangular box with a back portion 311, a top portion 314, and a bottom portion 316 that are coupled together via a right end panel 312 and a left end panel 313. The frame 310 can further include end covers 312a and 313a to cover the right end panel 312 and the left end panel 313, respectively. The foregoing components of the frame 310 may be coupled together through a combination of fasteners and/or snap-fit connections as shown in FIGS. 5C and 5D.

The case 300a can have various geometries to accommodate different arrangements of modules 20. For example, FIGS. 5A and 5B show the case 300a can be shaped as rectangular box where the modules 20 are arranged in a row along a single axis similar to previous modular synthesizers, such as the modular synthesizer 10. In another example, the case 300a can have a curved shape where the modules 20 are disposed along a curvilinear axis. In some implementations, the faceplates 21 of the modules 20 can also be shaped based on the geometry of the case 300a. For example, the faceplate 21 can have a rectangular shape. In another example, the faceplate 21 can have a trapezoidal shape or shaped as an annulus sector to conform with a case 300a with a curved shape.

The case 300a can be a rack-style case where the depth of the cavity 301 is greater than about 2 inches. More generally, the depth of the cavity 301 can range between about 1 inch and about 5 inches. The exterior depth of the case 300a can be similar to the depth of the cavity 301 especially when the case 300a is formed of a thin material (e.g., sheet metal). The exterior height of the case 300a can generally range between about 1 inch and about 10 inches. The exterior width of the case 300a can range between about 0.5 inches and about 120 inches.

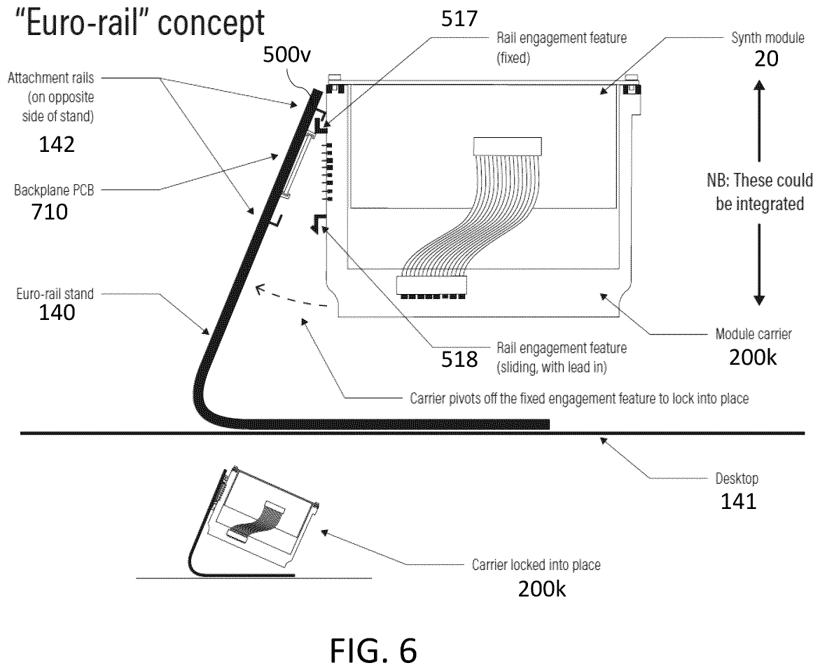

The geometry of the case 300a can also vary based on the manner in which the modular signal processing system 100a is deployed and used. For example, the modular signal processing system 100a can be deployed on a desk or a table. Here, the case 300a can be a skiff-style case where the depth of the cavity 301 is less than or equal to about 2 inches. In another example, the modular signal processing system 100a can be installed in a server rack. In yet another example, the modular signal processing system 100a can be installed on a stand. For instance, FIG. 6 shows an example stand 140 configured to support one or more carriers 200k with modules 20 (referred to herein as the Euro-rail concept). As shown, the stand 140 can be placed onto a flat surface 141 and support a circuit board 710 to supply power and data communication. The carrier 200k can be coupled to the stand 140 via a locking mechanism 500v. The stand 140 can include rails 142 to facilitate mechanical attachment of the carriers 200k. Each carrier 200k can include rail engagement features 517 and 518 to facilitate slidable engagement to the rails 142.

It should be appreciated that, in some implementations, the case 300a can be a chassis that provides the structural frame 310. Unlike an enclosure, the frame 310 can have openings exposing the case electronics 700a, the carriers 200a, and the module's electronics 23. In this implementation, the chassis can be installed into a larger enclosure that contains one or more case assemblies 120a similar to multiple rack-style cases disposed in a server rack enclosure.

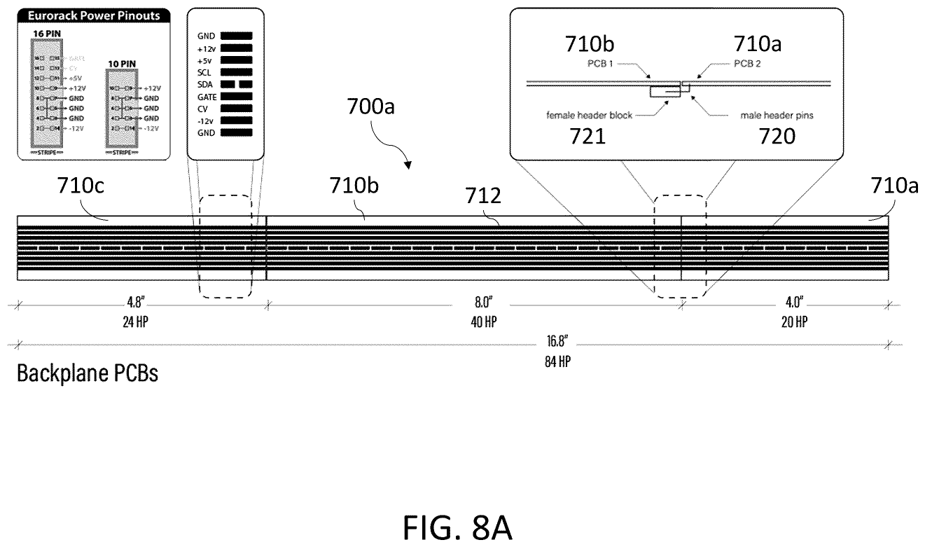

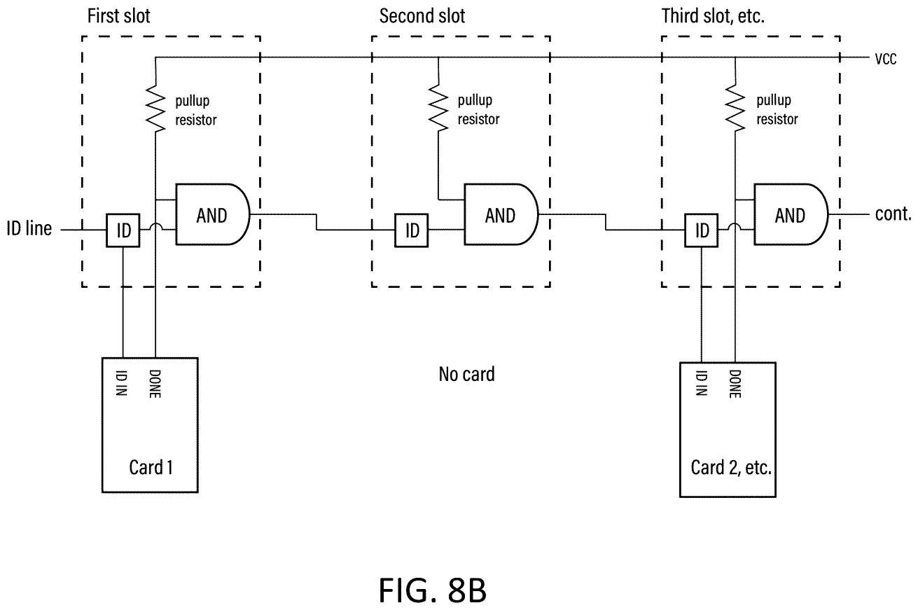

The case 300a can be formed from various metals, polymers, and composites including, but not limited to, aluminum, steel, copper, polycarbonate, polyoxymethylene, acrylic, glass-filled nylon, fiberglass, and any combinations of the foregoing. As described above, the case 300a can include an assembly of components, in part, to provide various mechanical mounting features to support the module 20 and/or to define movable components in the alignment mechanism 400a or the locking mechanism 500a. In some implementations, the case 300a can also be mechanically and electrically expandable (see, for example, the case electronics 700a in FIG. 8A). In some implementations, the case 300a can be formed as a single monolithic component.

### 1.3 Mechanical Interconnection

The alignment mechanism 400a is used, in part, to partially constrain the carrier 200a to the case 300a such that the carrier 200a cannot be readily removed from the case 300a while allowing the position of the carrier 200a within the case 300a to be adjusted. For example, the alignment mechanism 400a can include one or more twist locks 410. Each twist lock 410 can be rotatable via a knob 412. Each twist lock 410 can further include a recess shaped to surround a protrusion 320 of the case 300a when the twist lock 410 is rotated. The twist lock(s) 410 can prevent accidental removal of the carrier 200a from the case 300a. Thus, when the carrier 200a is coupled to the case 300a via the alignment mechanism 400a, the carrier 200a is not removable from the cavity 301, but can still slide along the width of the cavity 301 allowing the user to position the carrier 200a and, by extension, the module 20 within the case 300a as desired. In some implementations, the alignment mechanism 400a can also provide some play between the carrier 200a and the case 300a along the height of the case assembly 200a so that the carrier 200a can be more precisely aligned to the case 300a before being locked in place by the locking mechanism 500a. Although the alignment mechanism 400a includes twist locks 410, it should be appreciated that other quick-release features can be used including, but not limited to, a snap-fit connector, a clamp, a twist lock, a linkage mechanism, a cam lock, a push button, and any combinations of the foregoing.

The alignment mechanism 400a can further include an actuator to engage or disengage the twist locks. As shown, the actuator can be a rotatable knob disposed on the front of the faceplate 21 of a module 20. More generally, the alignment mechanism 400a can include various actuators disposed on the carrier 200a or the case 300a including, but not limited to, a switch, a lever, a button, and any combinations of the foregoing.

In some implementations, the alignment mechanism 400a does not include an actuator, instead relying on the application of a sufficiently large force applied to the carrier 200a, the module 20, and/or the case 300a to engage and/or disengage the alignment mechanism 400a. For example, the alignment mechanism 400a can include one or more snap-fit connectors disposed on the carrier 200a that mechanically couple to one or more rails on the case 300a to mechanically couple and constrain the carrier 200a to the case 300a along one or more axes. When inserting or removing the carrier 200a and the module 20 from the case 300a, the user can push or pull on the faceplate 21 of the module 20 such that the resultant force applied between the snap-fit connectors and the rails causes the snap-fit connectors to bend, thus engaging or disengaging the alignment mechanism 400a.

Once the user positions the carrier 200a and the module 20 to a desired location in the case 300a, the locking mechanism 500a is used to lock the carrier 200a in place at the desired location. Said in another way, the locking mechanism 500a mechanically constrains the carrier 200a to the case 300a such that the carrier 200a is not readily movable along any axis relative to the case 300a.

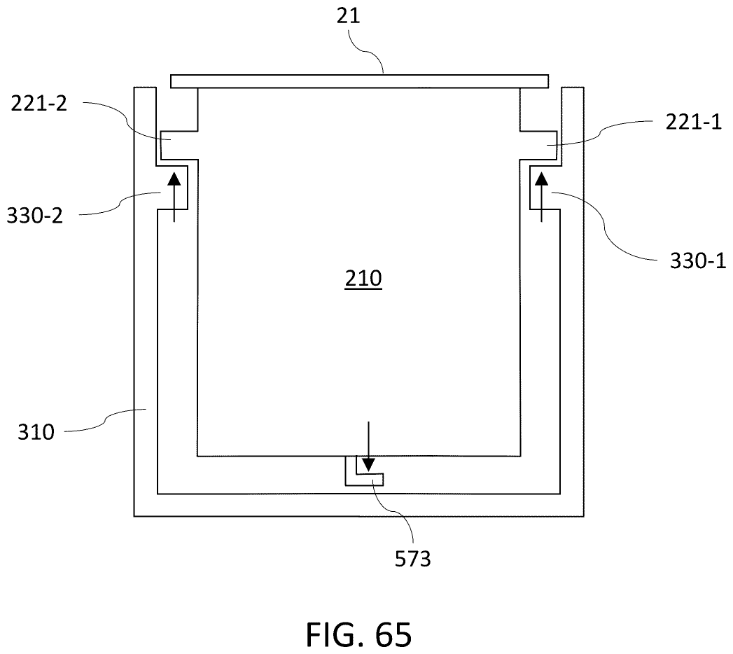

In some implementations, the locking mechanism 500a can apply a force (e.g., a clamping force) onto the carrier 200a and the case 300a to reduce or, in some instances, mitigate unwanted play or backlash between the carrier 200a and the case 300a. For example, the locking mechanism 500a can press the frame 210 of the carrier into the frame 310 giving rise to reactionary forces applied between the connector ends of the carrier and the ledges of the case that mechanically constrain the carrier 200a to the case 300a (see, for example, the forces applied to the carrier in FIG. 65). The locking mechanism 500a can be actuated without the use of any tools (i.e., in a tool-less manner) and/or without requiring any separate components for attachment (e.g., a fastener).

Additionally, the carrier electronics 600a and the case electronics 700a can be connected via an array of pogo pins 612 disposed on at least one circuit board 610 of the carrier electronics 600a and electrical traces 712 disposed on at least one circuit board 710 of the case electronics 700a, as discussed in greater detail below. The force generated by the engagement of the locking mechanism 500a can also be utilized to press the pogo pins 612 against the electrical traces 712, thus electrically and communicatively coupling the carrier electronics 600a to the case electronics 700a. In other words, the engagement of the locking mechanism 500a can mechanically, electrically, and communicatively couple the carrier 200a to the case 300a at the same time.

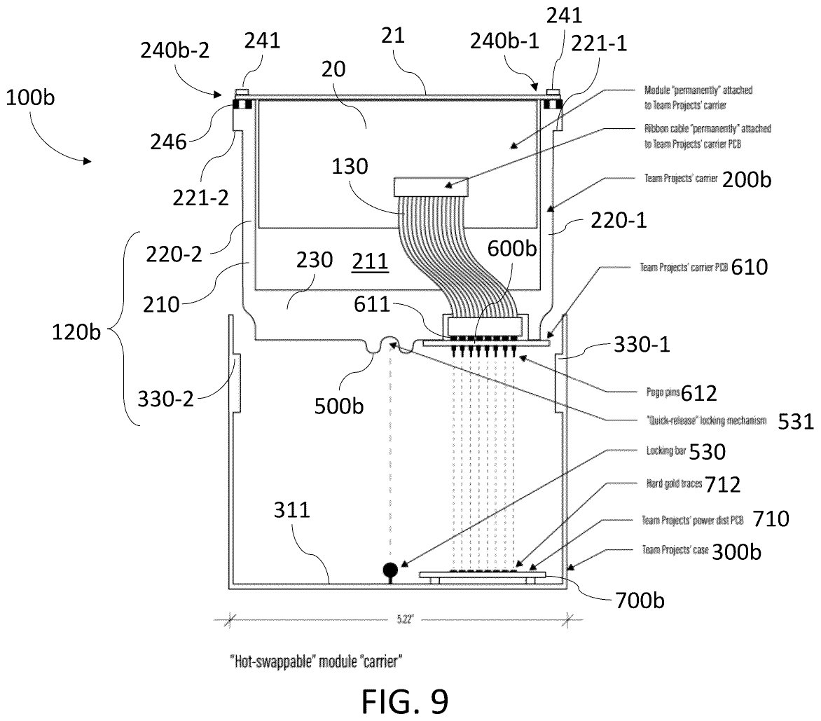

The locking mechanism 500a can be engaged by inserting the carrier 200a into the case 300a at an angle such that the connector ends of the carrier on one side engage corresponding ledges of the case. The carrier can then be rotated and pushed downwards to engage the connector ends and ledge disposed on the opposite side. In some implementations, the locking mechanism 500a can include various actuators disposed on the carrier 200a or the case 300a including, but not limited to, a switch, a lever, a button, and any combinations of the foregoing. Although the locking mechanism 500a is used to separately lock each carrier 200a to the case 300a, it should be appreciated that, in some implementations, the locking mechanism can be configured to securely lock multiple carriers 200a to the case 300a at the same time (see, for example, the locking mechanism 500c in FIGS. 9A and 9B).

FIG. 3G shows the locking mechanism 500a can include, in part, a pair of connector ends 510 and 511 mounted to the circuit board 610-2. Alternatively, the connector ends 510 and 511 can be integrally formed as a single component. The single component can further support, for example, the circuit board 610-2. The assembly of the connector ends 510 and 511 and the circuit board 610-2 can be movably coupled to the frame 310. This can be accomplished, for example, by each of the connector ends 510 and 511 having a pin 512 that is slidably coupled to corresponding slots 513 on the frame 210 of the carrier 200a. The slots 513 can be shaped to guide the movement of the assembly of the connector ends 510 and 511 and the circuit board 610-2 when connecting the carrier electronics 600a to the case electronics 700a. In particular, movement of the circuit board 610-2 can allow alignment of pogo pins 612 to corresponding electrical traces 712 (see further details below). The connector ends 510 and 511 can be shaped to securely latch onto corresponding ledges 514 on the case 300a. The locking mechanism 500a further includes a spring 515 configured to provide a retaining force that applies a force to the assembly of the connector ends 510 and 511 and the circuit board 610-2 such that the pogo pins 612 are pressed against the electrical traces 712. However, it should be appreciated that, in some implementations, the locking mechanism 500a may not include the spring 515. In particular, when the carrier 200a is mounted to the case 300a via multiple locking mechanisms 500a, only a subset (e.g., one locking mechanism 500a) may include the spring 515.

It should be appreciated that the alignment mechanism 400a and the locking mechanism 500a are non-limiting examples. Other examples of alignment mechanisms and locking mechanisms to support a side-mounted carrier are contemplated herein. See, for example, the alignment mechanisms 400c-4000 and/or the locking mechanisms 500d-500ao.

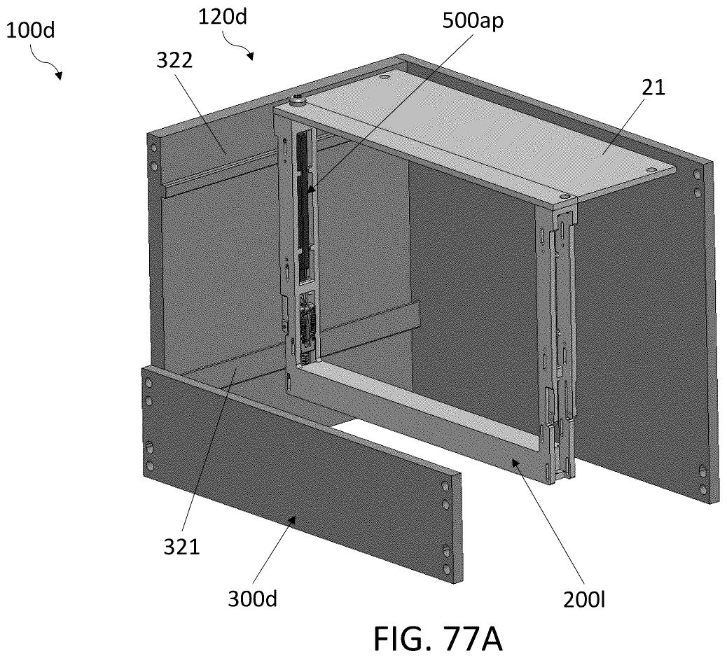

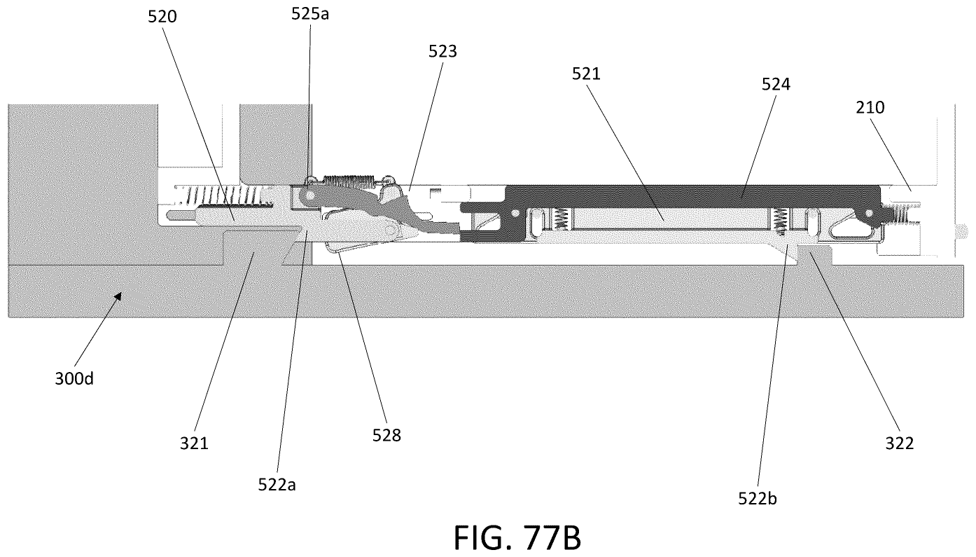

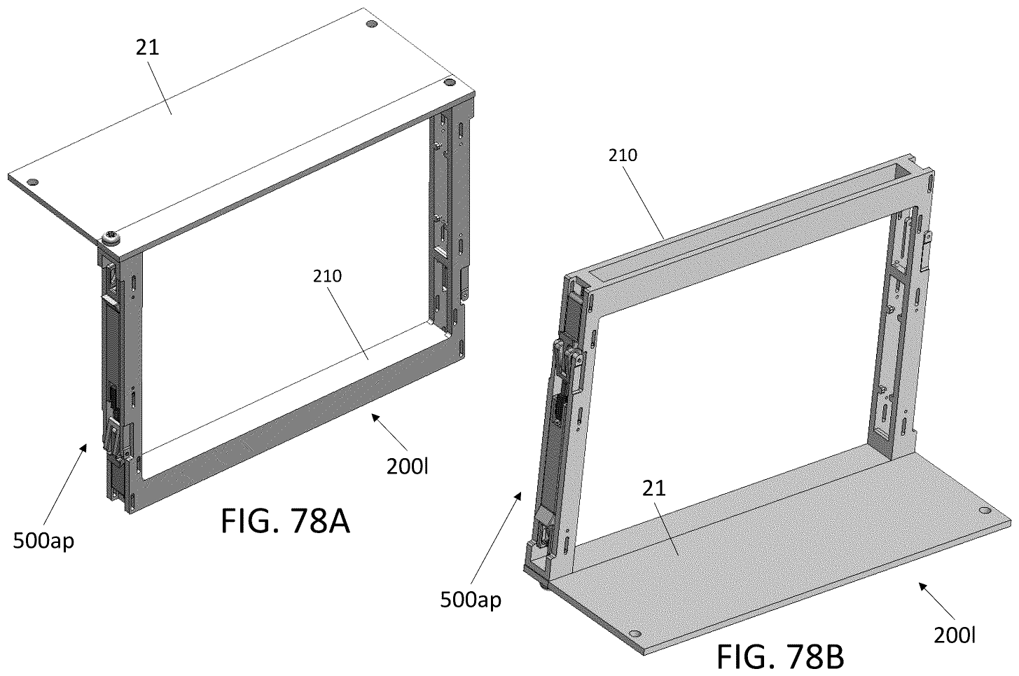

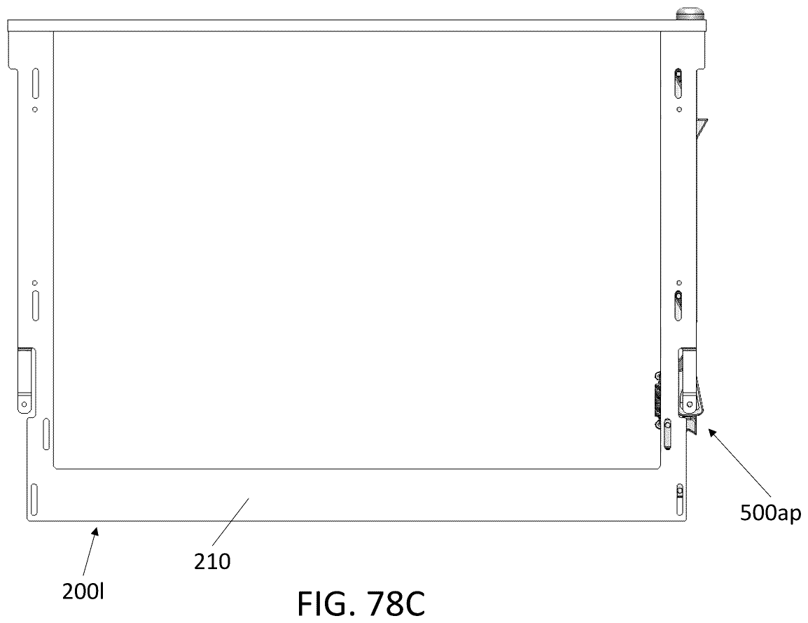

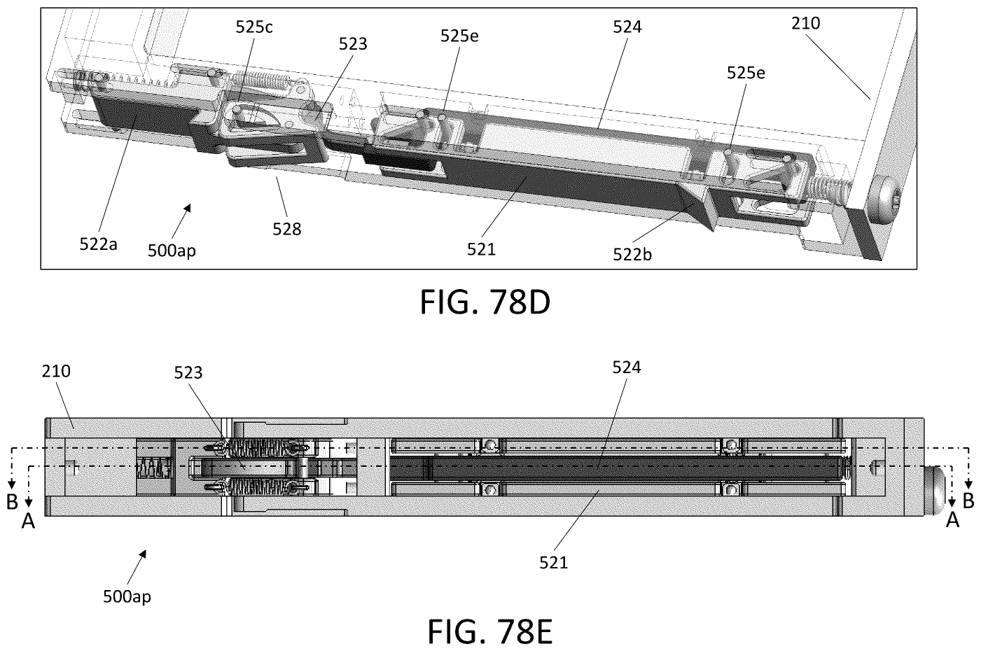

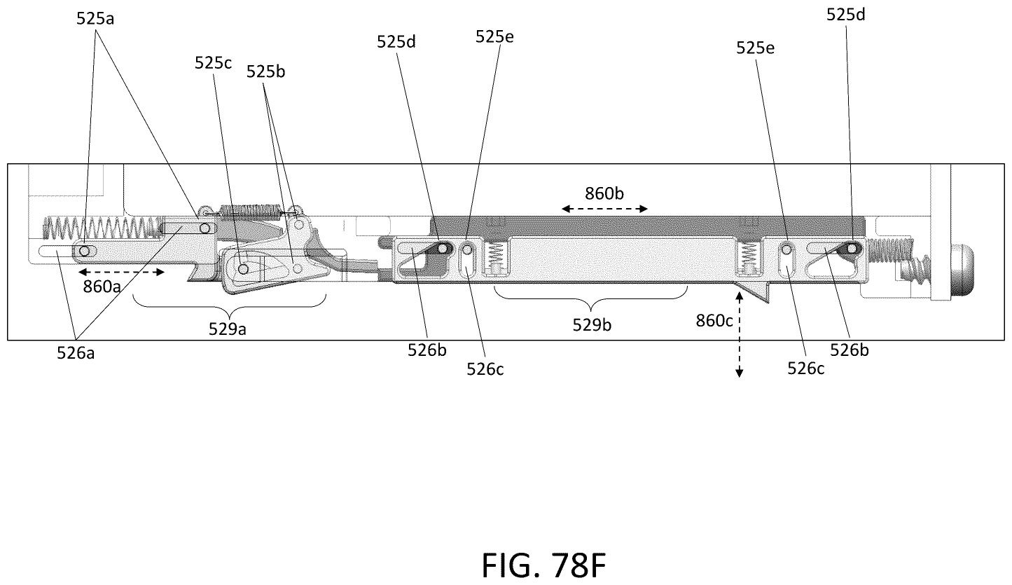

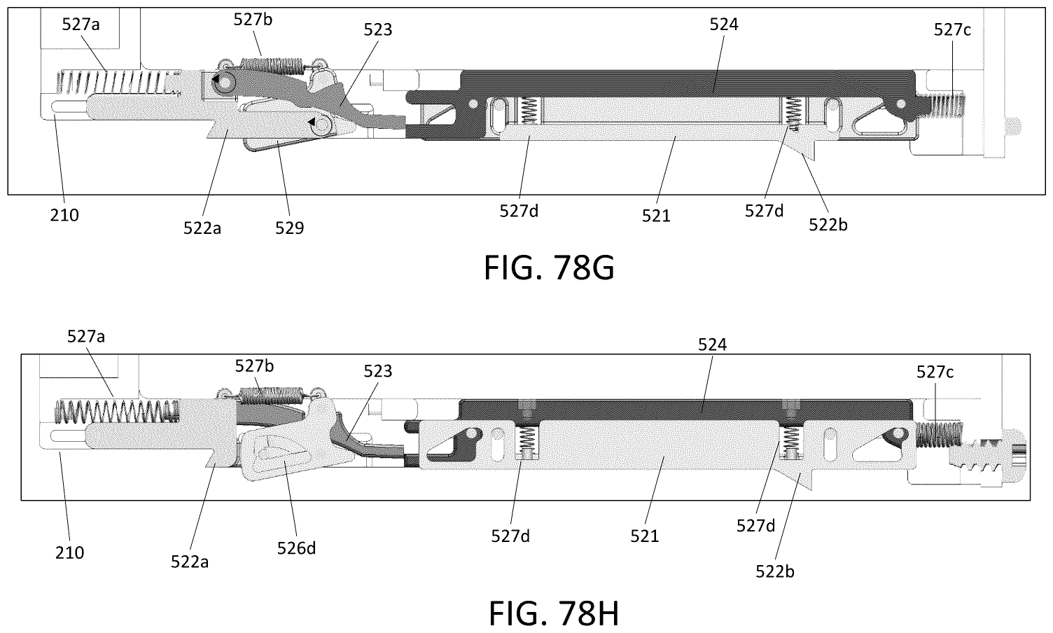

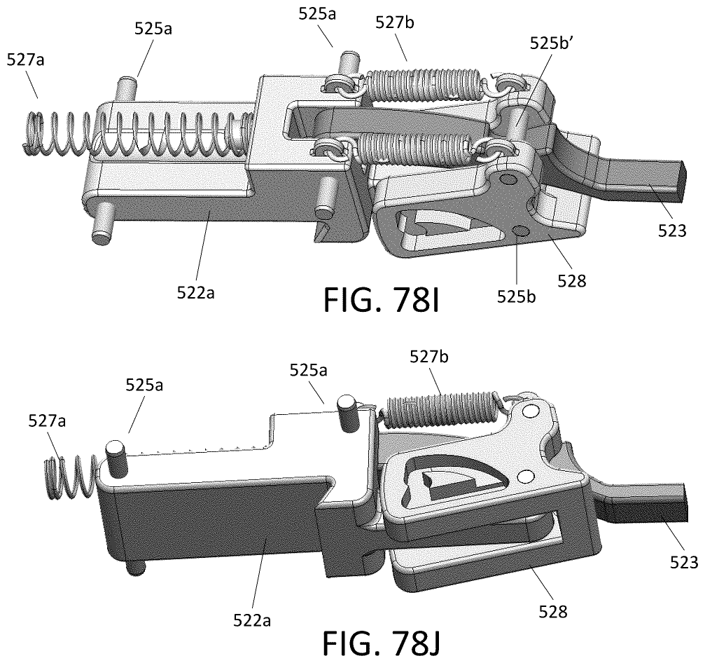

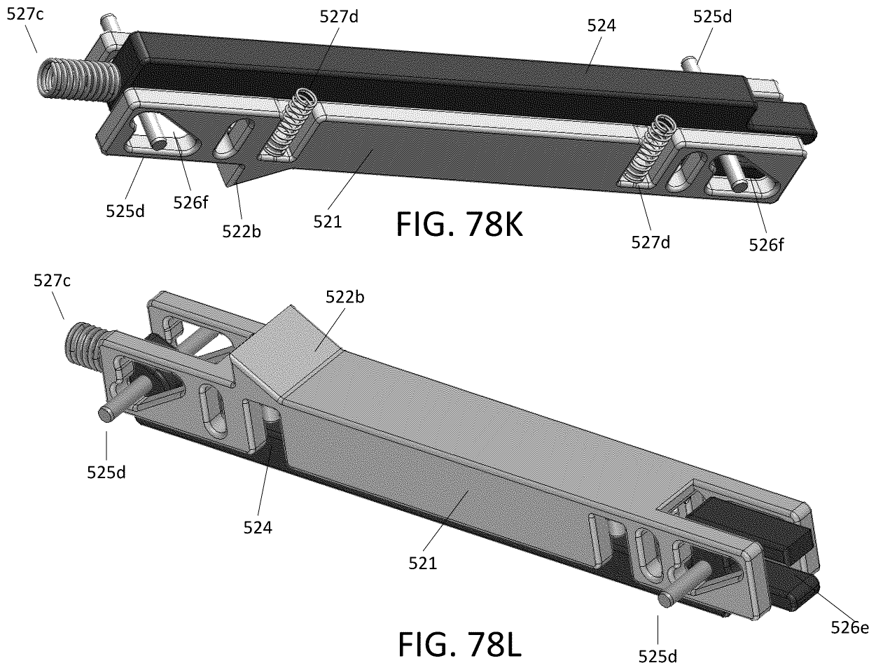

In yet another example, FIGS. 77A and 77B show a modular signal processing system 100d with a case assembly 120d comprising a carrier 200l, a case 300d, and a push-push locking mechanism 500ap. In this example, the locking mechanism 500ap can be engaged (e.g., locked) or disengaged (e.g., unlocked) by pushing onto a portion of the carrier 200l or the module supported by the carrier 200l (e.g., the faceplate 21). As shown, the case 300d can include ledges 321 and 322. FIGS. 78A-78C show the carrier 200l can include the locking mechanism 500ap to securely couple the carrier 200l to the case 300d. The locking mechanism 500ap can include a pair of connector ends 522a and 522b that contact the ledges 321 and 322, respectively, thereby securely coupling the carrier 200l to the case 300d (see FIG. 77B).

FIGS. 78D-78H show the locking mechanism 500ap is movably coupled to the frame 210 to facilitate engagement and disengagement with the case 300d. As shown, the locking mechanism 500ap includes two subassemblies: a first subassembly 529a including an actuator 250; and a second subassembly 529b including a latch carrier 521. In the first subassembly 529a, the actuator 520 can include the connector end 522a and can be rotatably coupled to a pawl 523 and a cam 528 (e.g., a carotid cam) (see FIGS. 781 and 78J). The cam 528 can be rotatably coupled to the actuator 520 via a pin 525b. An additional pin 525b′ can be included to displace the pawl 523 as the cam 528 is displaced. The cam 528 is further coupled to the actuator 520 via a pair of springs 527b. The springs 527b, the cam 528, and the pawl 523 are together configured to retain the locking mechanism 500ap in a locked position until, for example, the user presses the carrier 200l.

The actuator 520 can be slidably coupled to the frame 210 and configured to move along an axis 860a as the locking mechanism 500ap is actuated. This is accomplished by the actuator 520 having a set of pins 525a rigidly coupled to the actuator 520 and disposed within corresponding slots 526a on the frame 210 of the carrier 200l. The pins 525a may thus slidably move along the slots 526a. Additionally, the cam 528 can include a channel 526d formed thereon. A pin 525c rigidly coupled to the frame 210 is disposed in the channel 526d and configured to move along the channel 526d. Thus, as the actuator 520 moves along the axis 860a, the cam 528, and by extension, the pawl 523 move and rotate based on the path of the channel 526d. The channel 526d defines two state to stably support the pin 525c. These two states correspond to the locked and unlocked states. A spring 527a is further coupled to the actuator 520 and the frame 210 to maintain the connector end 522a in a locked position.

In the second subassembly 529a, the latch carrier 521 can include the connector end 522b and is movably coupled to a slider 524 via a set of pins 525d. (see FIGS. 78K and 78L). The pins 525d are disposed within respective slots 526f formed in the latch carrier 521. The pins 525d are further disposed within corresponding slots 526b on the frame 210 to further constrain the motion of the slider 524 and the latch carrier 521 with respect to the frame 210. In this example, the pins 525d can be arranged such that movement of the slider 524 along an axis 860b (e.g., parallel to the axis 860a) results in movement of the latch carrier 521 along an axis 860c. In some implementations, the axes 860b and 860c can be orthogonal.

The latch carrier 521 can be slidably coupled to the frame 210 via pins 525e, which are rigidly mounted to the frame 210 and disposed within slots 526c on the latch carrier 521. Thus, the pins 525e can move along respective slots 526c as the locking mechanism 500ap is actuated. The second subassembly 529b can further include a spring 527c coupled to the slider 524 to generate a force along the axis 860b. The second subassembly 529b can also include a pair of springs 527d coupled to the latch carrier 521 to generate a force along the axis 860c. The springs 527c and 527d can be configured to maintain the locking mechanism 500ap in a locked state.

When the locking mechanism 500ap is actuated (e.g., to release the carrier 200l from the case 300d), the movement of the slider 524 along the axis 860b causes two effects. First, the slider 524 causes the latch carrier 521 to move along the axis 860c, thus disengaging the connector end 522b from the ledge 322. Second, the slider 524 physically contacts the pawl 523. The end of the slider 524 and/or the pawl 523 can be shaped such that contact between the foregoing components causes the pawl 523 to rotate (e.g., about the pin 525a shown in FIG. 77B) and move into a notch 526e formed at the end of the slider 524. This, in turn, causes the respective subassemblies 529a and 529b to move closer together along a direction parallel to the axes 860a and 860b, thus allowing the connector end 522a to be disengaged from the ledge 321.

### 1.4 Electrical and Electronic Interconnection

The carrier electronics 600a provide an electrical interface to electrically couple the electronics 23 of the module 20 to the case electronics 700a in a simpler manner compared to previous modular synthesizers. In some implementations, the carrier electronics 600a can also provide an electronic interface to network the modules together and facilitate data transmission and/or control signals to or from each of the modules. This can be accomplished, in part, by the carrier electronics 600a having at least one circuit board 610 with one or more pogo pins 612 to electrically contact corresponding electrical traces 712 on at least one circuit board 710 of the case electronics 700a.

For example, FIG. 3F shows the carrier electronics 600a includes a circuit board 610-1 mounted to a bottom portion of the carrier 200a and a circuit board 610-2 mounted to a side portion of the carrier 200a. The circuit board 610-1 is also referred to herein as the “carrier electronics circuit board 610-1.” The circuit board 610-2 is also referred to herein as the “pogo pin connector board 610-2.” The circuit boards 610-1 and 610-2 are connected via a cable (not shown) and respective connector ports. A circuit board 710 mounted along the side of the case 300a. As shown, the circuit board 610-2 of the carrier electronics 600a is connected to the circuit board 710 of the case electronics 700a via pogo pins.

The pogo pins 612 are spring-loaded electrical connectors that include a movable plunger coupled to a spring housed in a barrel. The mechanical compliance of the pogo pins 612 and the force generated by the spring can thus maintain an electrical connection with the electrical traces 712 of the case electronics 700a without the use of a separate electrical cable and/or an interlocking electrical connector. In one example, the carrier electronics 600a can include an electrical connector 613 mounted to the circuit board 610-1 to facilitate electrical connection of the carrier electronics 600a to the electronics 23 of the module 20. In another example, the carrier electronics 600a can include at least one circuit board 610 with one or more connector pins 611 (see, for example, FIG. 9). An electrical cable 130, in turn, can connect the connector pins 611 to a corresponding electrical connector (e.g., the connector 24) on the electronics 23. The connector pins 611 and the electrical cable 130 can thus be used, in part, to accommodate modules 20 developed for previous modular synthesizers.

Compared to previous modular synthesizers, which typically require an electrical cable (e.g., the ribbon cable 42) to be manually connected or disconnected each time the module 20 is installed or removed, respectively, the electrical cable 130 in the carrier 200a is only connected to the module 20 once when first mounting the module 20 to the carrier 200a. Once the module is mounted to the carrier 200a, the carrier electronics 600a and the electronics 23 of the module 20 can be electrically and communicatively coupled to the case electronics 700a by pressing the pogo pins 612 against with the electrical traces 712. In some implementations, the locking mechanism 500a can impart an additional clamping force to facilitate and maintain electrical contact between the pogo pins 612 and the electrical traces 712, as described above. Likewise, the carrier electronics 600a and the electronics 23 can be electrically and communicatively decoupled from the case electronics 700a by physically removing the carrier 200a and the module 20 from the case 300a.

The carrier electronics 600a are coupled directly to the frame 210 of the carrier 200a via the circuit board attachment mechanism 260a as described above. More generally, various attachment mechanisms can be used to mechanically couple the carrier electronics 600a to the frame 210 including, but not limited to, a fastener (e.g., a rivet, a screw fastener, a bolt fastener), an adhesive, and a snap-fit connection. In some implementations, the carrier electronics 600a are disposed within a recess or a cavity formed in the frame 210.

The case electronics 700a are generally coupled directly to the frame 310 of the case 300a. Similar to the carrier electronics 600a, the case electronics 700a can be mechanically coupled to the frame 310 via various attachment mechanisms including, but not limited to, a fastener (e.g., a rivet, a screw fastener, a bolt fastener), an adhesive, and a snap-fit connection. The circuit boards 710 can generally be shaped and/or dimensioned to support one or more carriers 200a. In some implementations, the circuit board 710 can have a height of about 4.8 inches. In some implementations, the circuit board 710 can have a width of 1.25 inches, 4 inches, 8 inches, or 12 inches. More generally, the width of the circuit board 710 can range between about 1.25 inches and about 12 inches. The height of the circuit board 710 can generally range between about 1 inch and 3 inches.

The electrical traces 712 are thin strips of an electrical conductor (e.g., gold, copper) formed on one or more of the circuit boards 710. The electrical traces 712 can span a portion or, in some instances, the entirety of the width of the circuit board 710 (see, for example, the case electronics 700a in FIG. 8A). The geometry of the electrical traces 712 provides flexibility in the installation of the carrier 200a by ensuring the carrier electronics 600a can be electrically and communicatively coupled to the case electronics 700a regardless of the position of the carrier 200a in the case 300a.

Generally, the case electronics 700a and the carrier electronics 600a are mounted, respectively, on the frame 310 and the frame 210 such that the pogo pins 612 and the electrical traces 712 are aligned along the height of the case assembly 120a when the carrier 200a is mechanically coupled and secured to the case 300a.

The carrier electronics 600a and the case electronics 700a can generally provide various electrical connections to facilitate the operation and control of the module 20 including, but not limited to, electrical power connections (e.g., +12V, −12V, +5V connections), ground connections, control voltage connections, gate/trigger connections, and clock signal connections. As shown in FIG. 3H, this can be facilitated, in part, by the case electronics 700a including a circuit board 701 (also referred to herein as the “power and data communications circuit board 701”) to directly receive and provide electrical power and/or data communication to the circuit board(s) 710. FIG. 5E shows the circuit board 701 may be directly connected to the circuit board(s) 710a via a pair of mating electrical connectors. The circuit boards 710a, in turn, provide a backplane along which power and data is provided to the carriers 200a and the modules 20.

Each electrical connection can include a separate electrical trace 712 and a corresponding pogo pin 612. For example, the carrier electronics 600a and the case electronics 700a can transmit electrical power from a power supply (not shown) to the module 20. The power supply can provide either direct current (DC) or alternating current (AC) power. In another example, the carrier electronics 600a and the case electronics 700a can transmit clock signals to control, for example, the tempo of the acoustic signals generated by the module 20. In some implementations, the carrier electronics 600a and the case electronics 700a can provide electrical connections that conform to a particular standardized format (e.g., Eurorack) as discussed in more detail below.

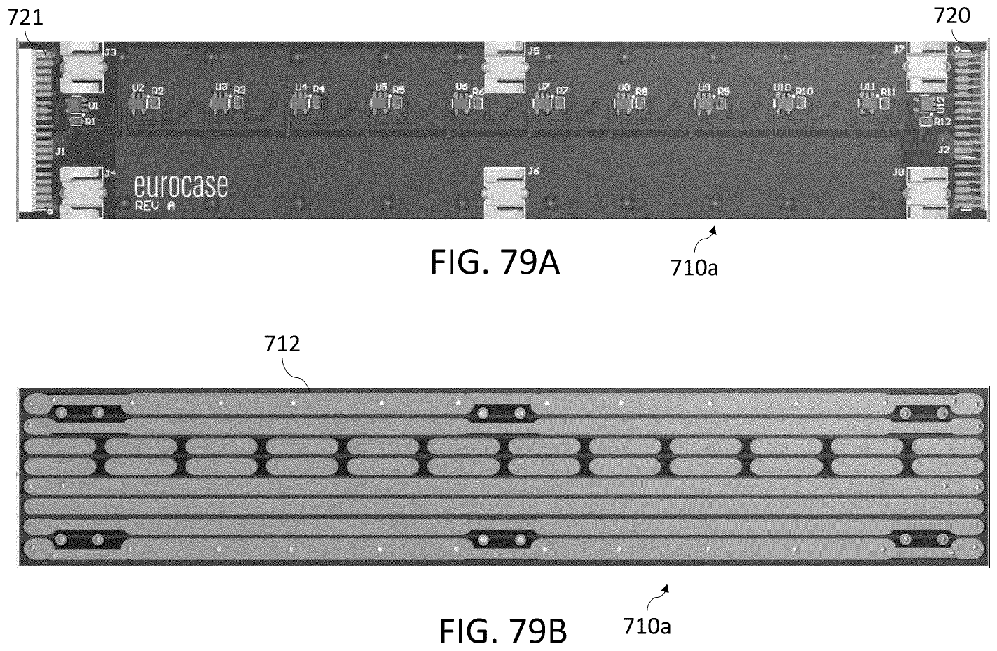

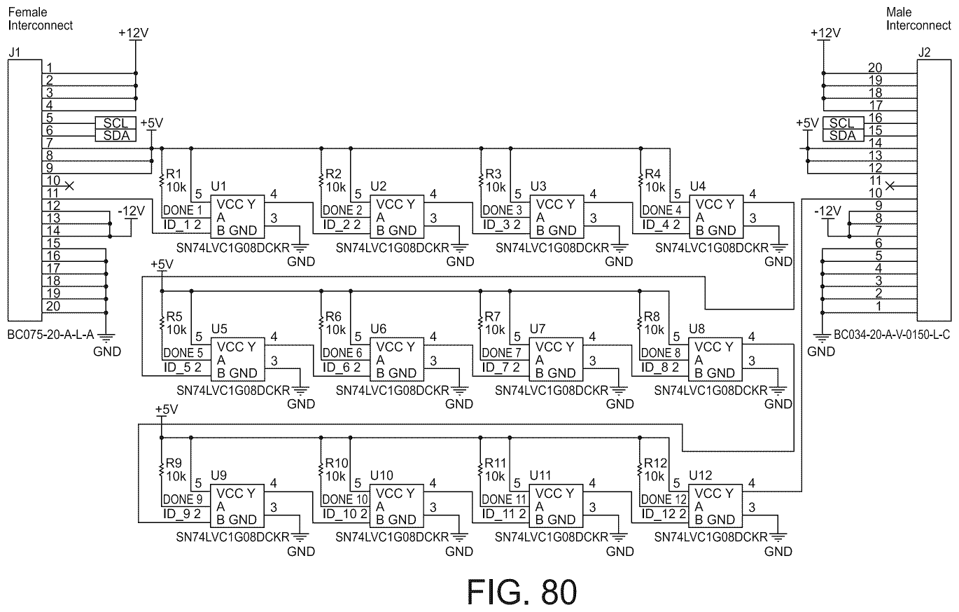

FIGS. 79A and 79B show additional views of the circuit board 710a, which is used to form a backplane to supply power and data communications to one or more modules 20. As shown, the circuit board 710a includes the electrical traces 712 as well as the male header pins 720 and the female header block 721. As described above, multiple circuit boards 710a can be joined together by connecting respective male header pins 720 and female header blocks 721 of different circuit boards 710a together. FIG. 80 shows a circuit diagram for the circuit board 710a. It should be appreciated that the circuit board 710a shown in FIGS. 79A-80 is a non-limiting example and the other combinations and arrangements of electronic components that provide the same or similar functionality as the circuit board 710a are also contemplated herein.

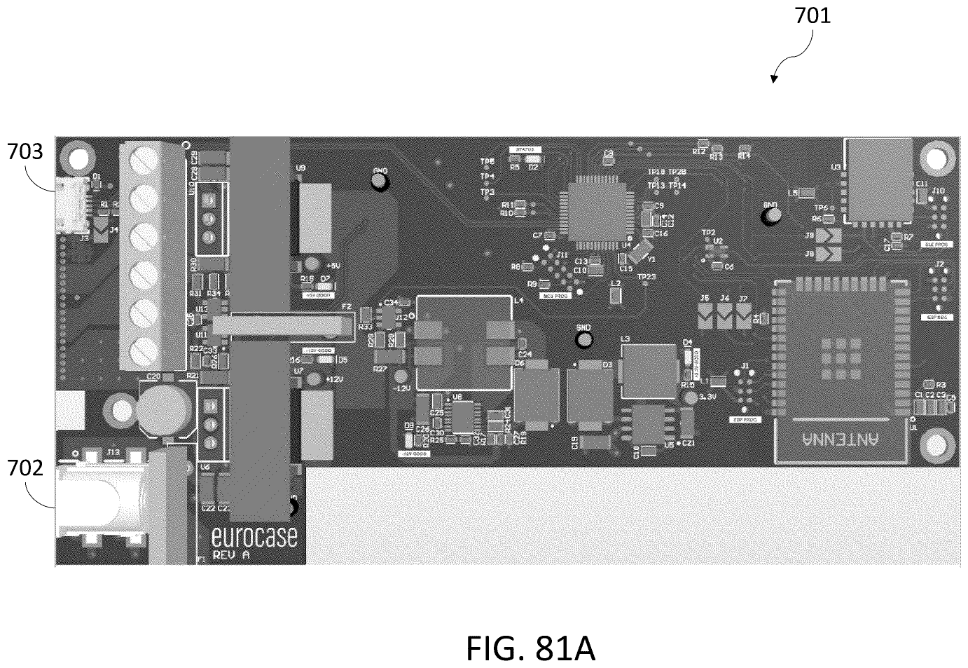

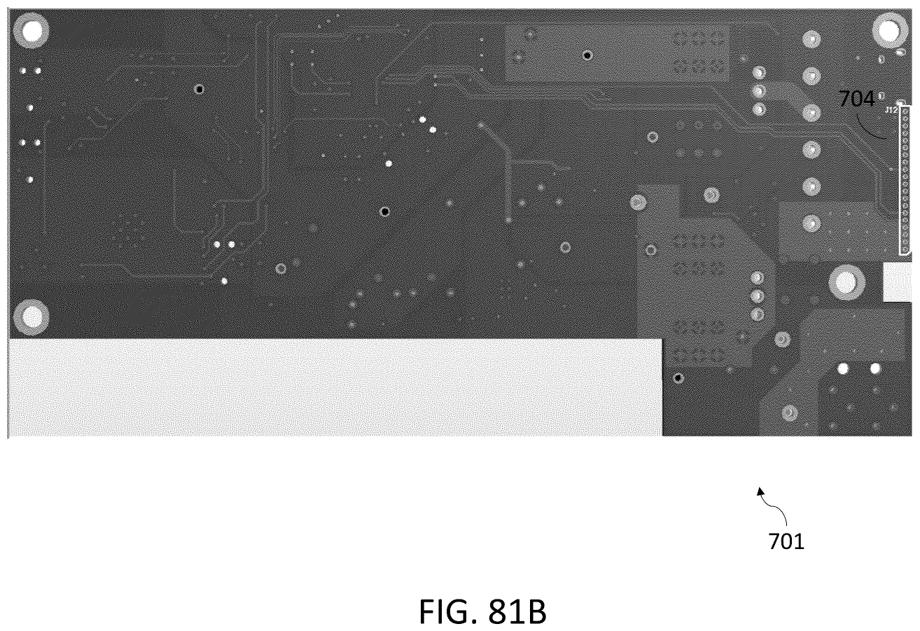

FIGS. 81A and 81B show additional views of the power and data communications circuit board 701. As shown, the circuit board 701 can include an electrical power port 702 to receive electrical power from an external source. For example, the port 702 can receive AC power. The circuit board 701 further includes a data communications port 703. The data communications port can be, for example, a Universal Serial Bus (USB) port. The circuit board 701 also includes an electrical connector 704 to directly connect the circuit board 701 to the circuit board 710a.

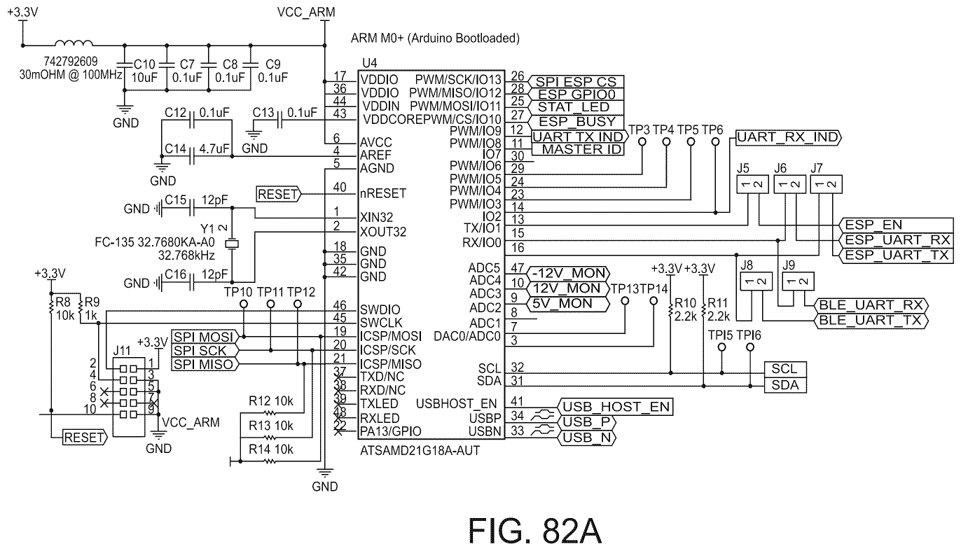

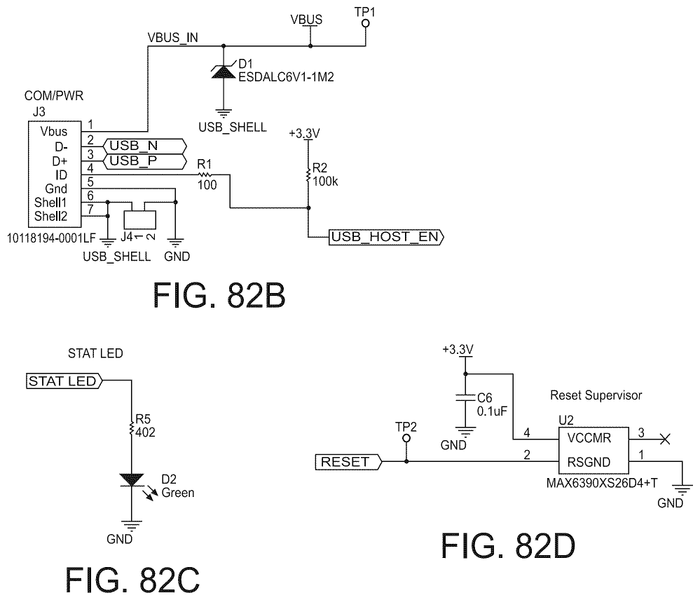

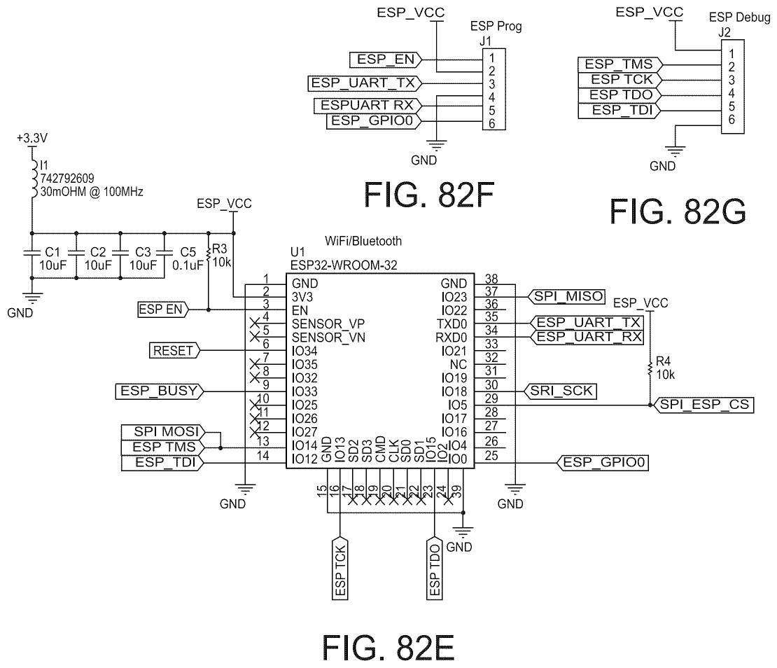

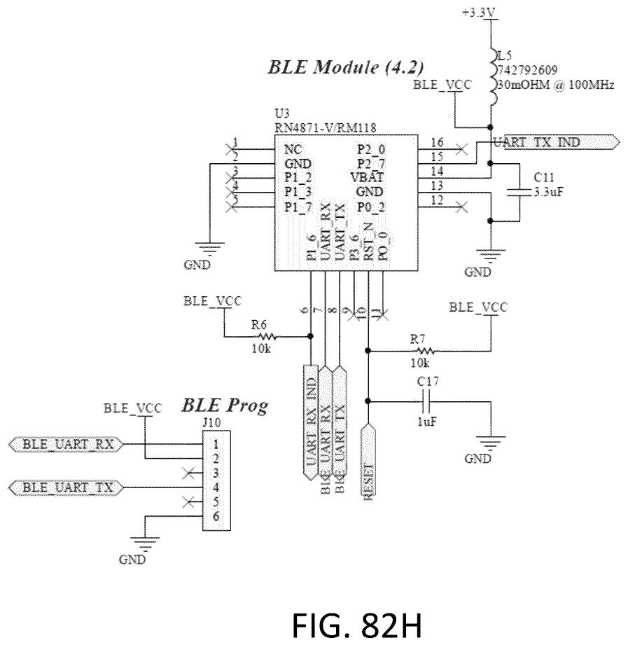

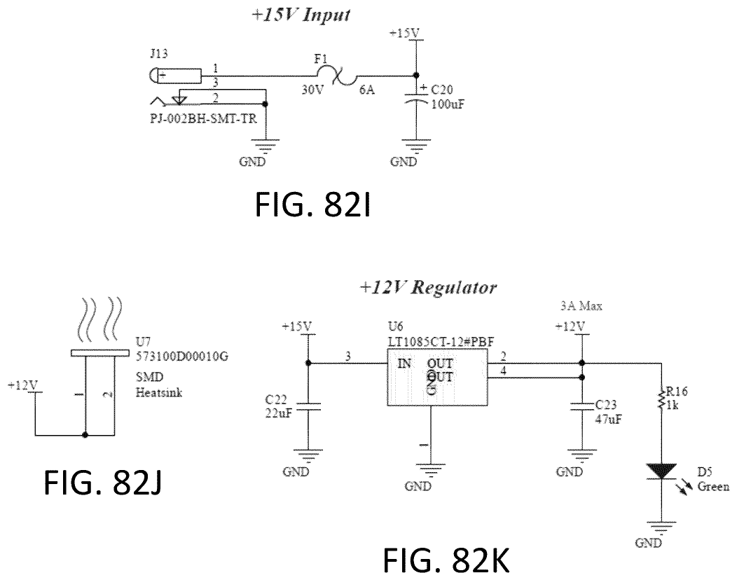

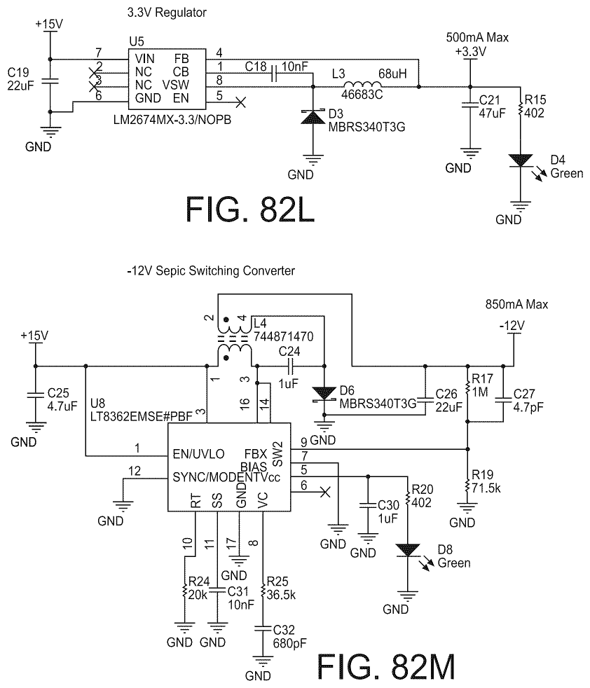

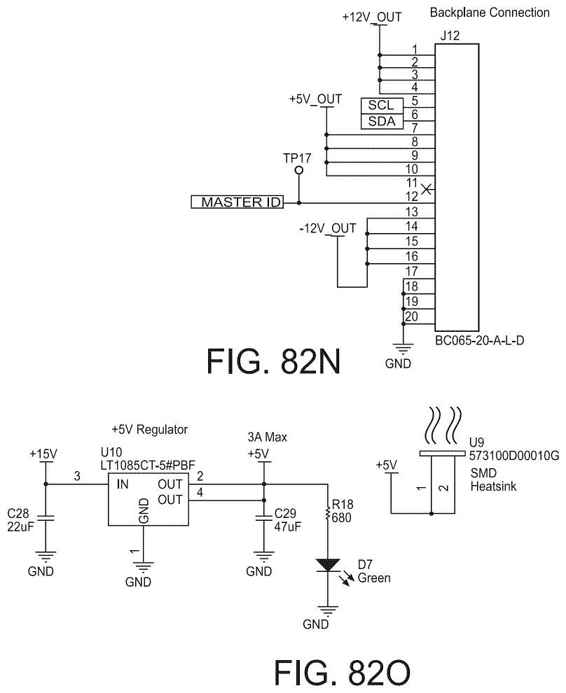

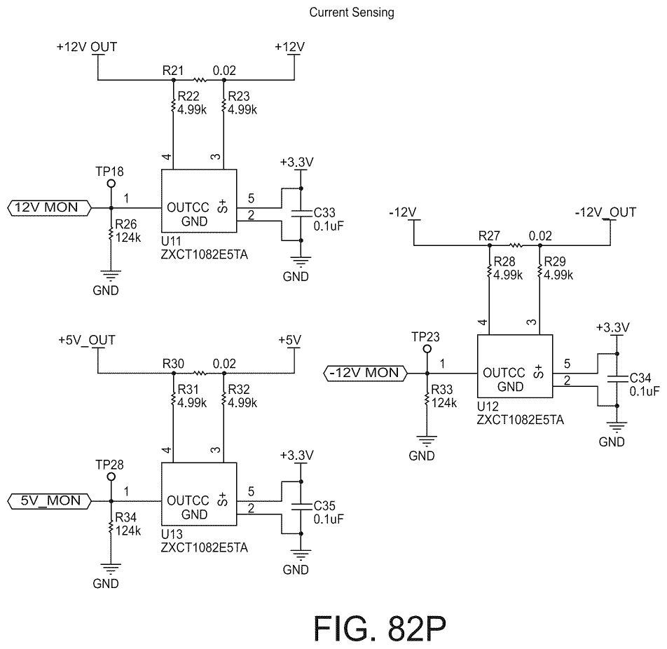

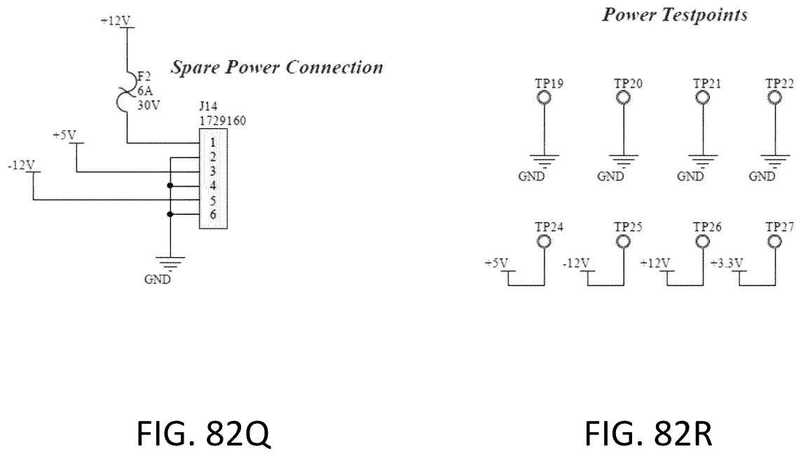

FIGS. 82A-82R show circuit diagrams for various electronic components of the circuit board 701. In particular, FIG. 82A shows a circuit diagram of a microcontroller. FIG. 82B shows a circuit diagram of a communications and power connector (e.g., the ports 702 and 703). FIG. 82C shows a circuit diagram of a status light emitting diode (LED). FIG. 82D shows a circuit diagram of a reset supervisor. FIG. 82E shows a circuit diagram of an Espressif (ESP) Prog circuit board. FIG. 82F shows a circuit diagram of an ESP Debug circuit board. FIG. 82G shows a circuit diagram of a wireless communication device. FIG. 82H shows a circuit diagram of a Bluetooth Low Energy (BLE) module. FIG. 82I shows a circuit diagram of a 15V input. FIG. 82J shows a circuit diagram of a cooling fan. FIG. 82K shows a circuit diagram of a 12V regulator. FIG. 82L shows a circuit diagram of a 3.3V regulator. FIG. 82M shows a circuit diagram of a 12V single-ended primary-inductor converter (SEPIC) switching converter. FIG. 82N shows a circuit diagram of a backplane connector. FIG. 82O shows circuit diagrams of a 5V regulator and a cooling fan. FIG. 82P shows circuit diagrams of various current sensing devices. FIG. 82Q shows a circuit diagram of a spare power connection. FIG. 82R shows a circuit diagram of power test points. It should be appreciated that the circuit board 701 and the various electronic components and circuitry included therein shown in FIGS. 81A-82R are non-limiting examples and that other combinations and arrangements of electronic components that provide the same or similar functionality as the circuit board 701 are also contemplated herein.

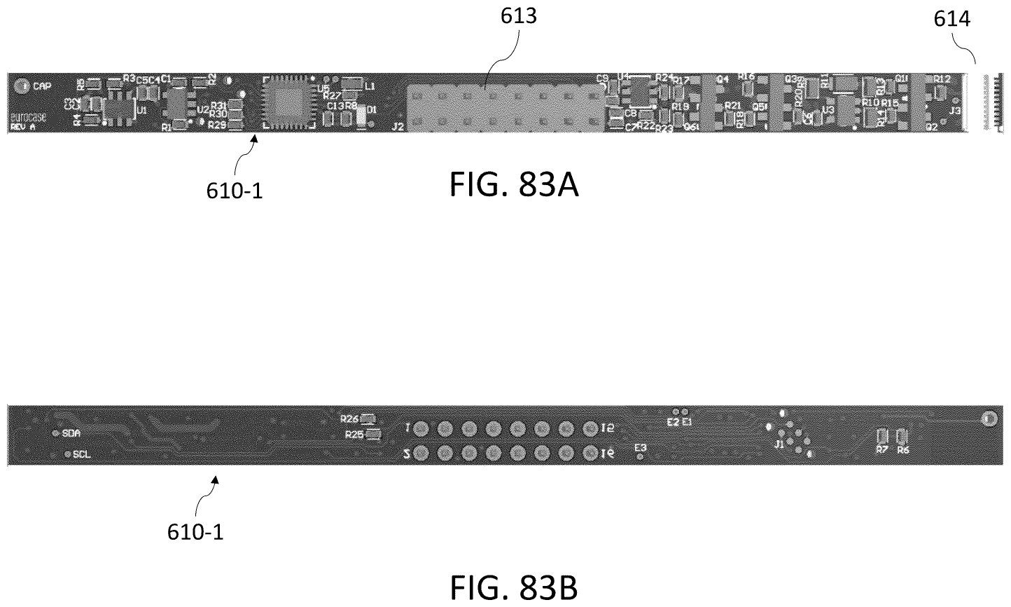

FIGS. 83A and 83B show additional views of the carrier electronics circuit board 610-1 forming part of the carrier electronics 600a. As shown, the circuit board 610-1 includes the electrical connector 613 for connection to a module 20. The circuit board 610-1 further includes an electrical connector 614 to connect to another portion of the carrier electronics 600a, such as the pogo pin connector board 610-2 via an electrical cable.

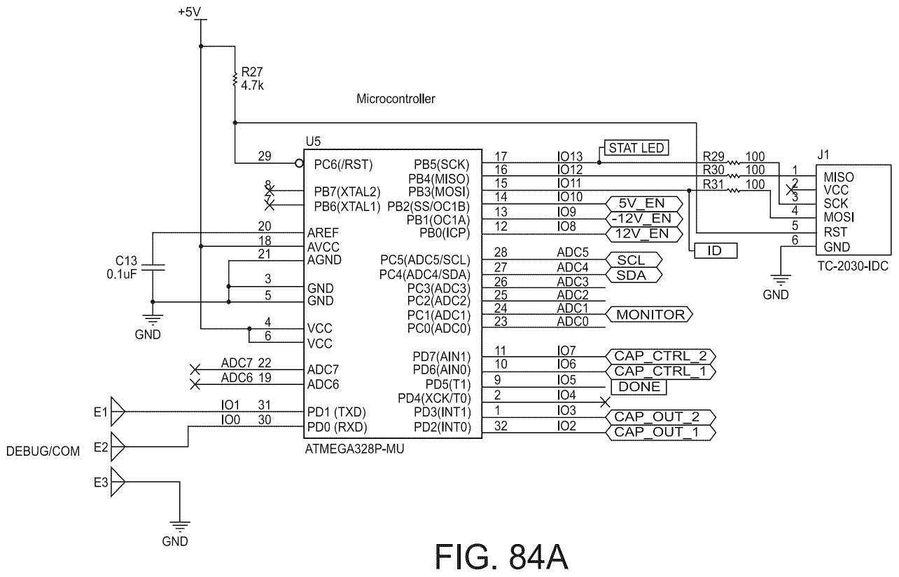

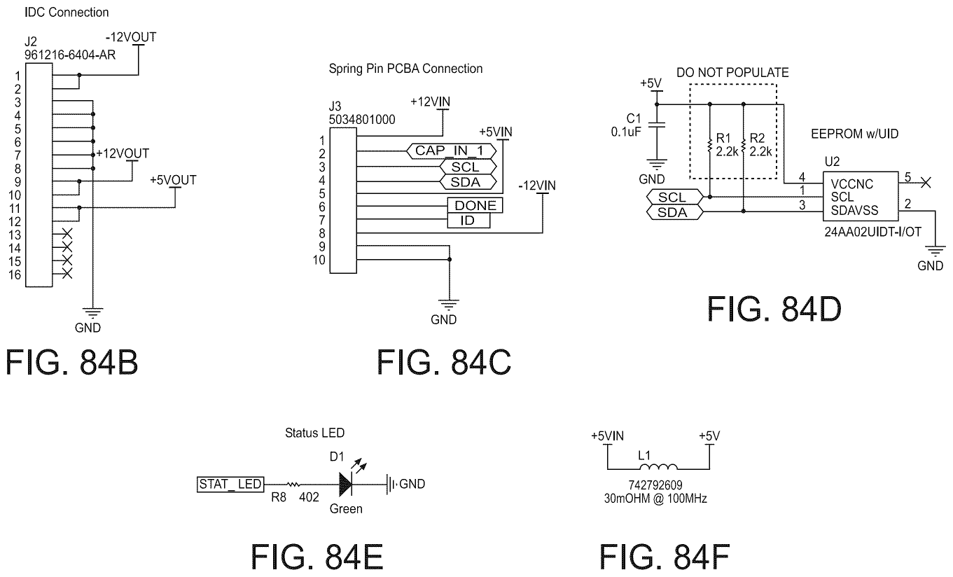

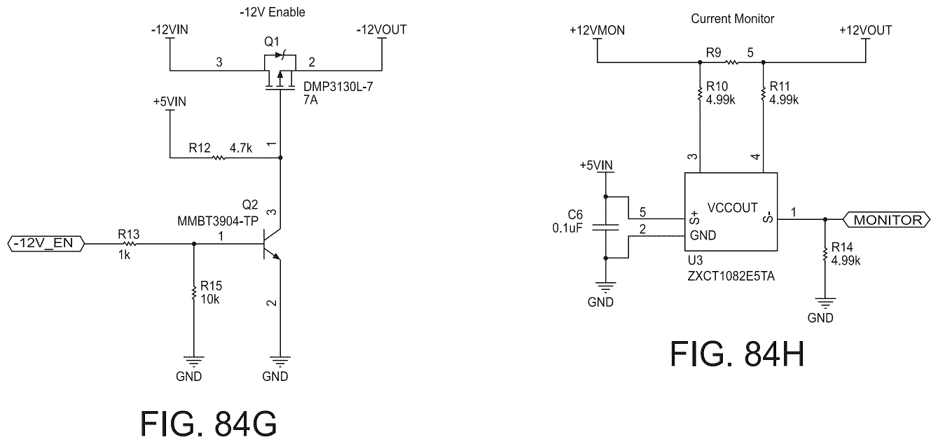

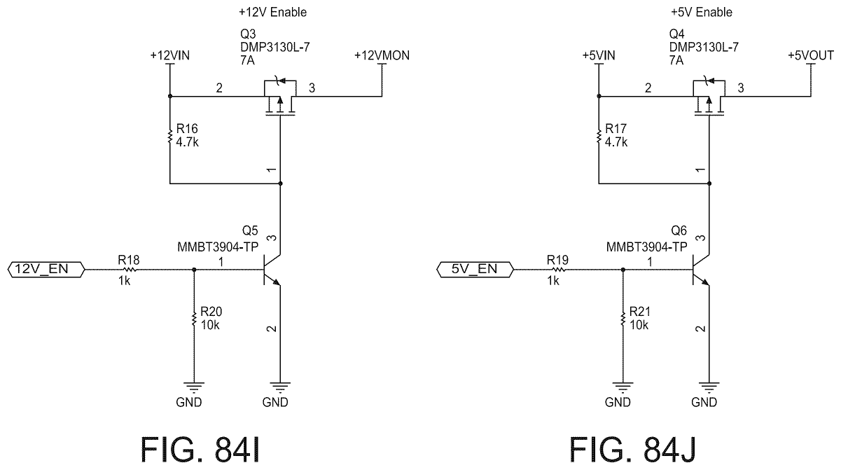

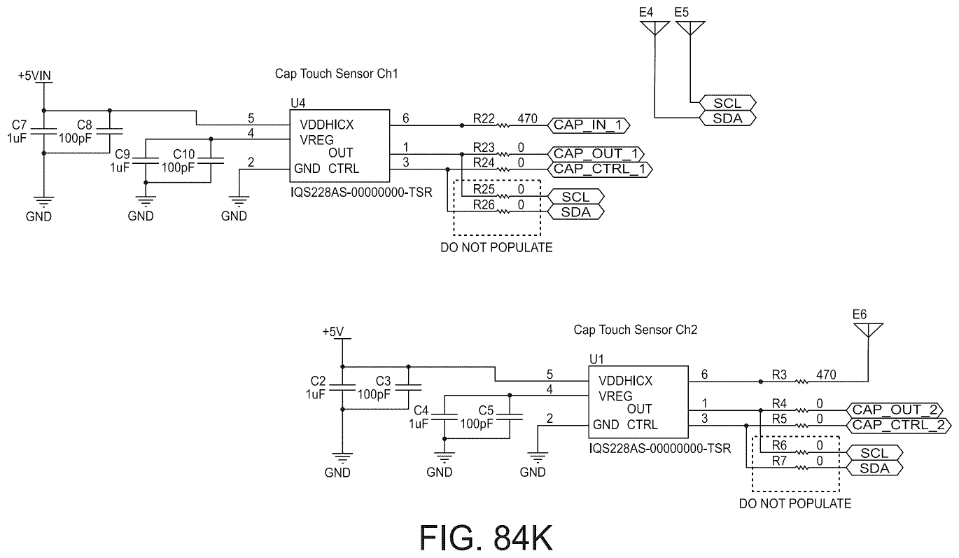

FIGS. 84A-84K show circuit diagrams for various electronic components of the circuit board 610-1. FIG. 84A shows a circuit diagram of a microcontroller. FIG. 84B shows a circuit diagram of an insulation-displacement contact (IDC) connector. FIG. 84C shows a circuit diagram of a spring-pin printed circuit board assembly (PCBA) connector. FIG. 84D shows a circuit diagram of electrically reversible programmable read-only memory (EEPROM) with a unique identifier (UID). FIG. 84E shows a circuit diagram of a status LED. FIG. 84F shows a circuit diagram of an electromagnetic interference suppression component. FIG. 84G shows a circuit diagram of a −12V Enable circuit. FIG. 84H shows a circuit diagram of a current monitor. FIG. 84I shows a circuit diagram of a +12V Enable circuit. FIG. 84J shows a circuit diagram of a +5V Enable. FIG. 84K shows circuit diagrams of capacitive touch sensors. It should be appreciated that the circuit board 610-1 and the various electronic components and circuitry included therein shown in FIGS. 83A-84K are non-limiting examples and that the other combinations and arrangements of electronic components that provide the same or similar functionality as the circuit board 610-1 are also contemplated herein.

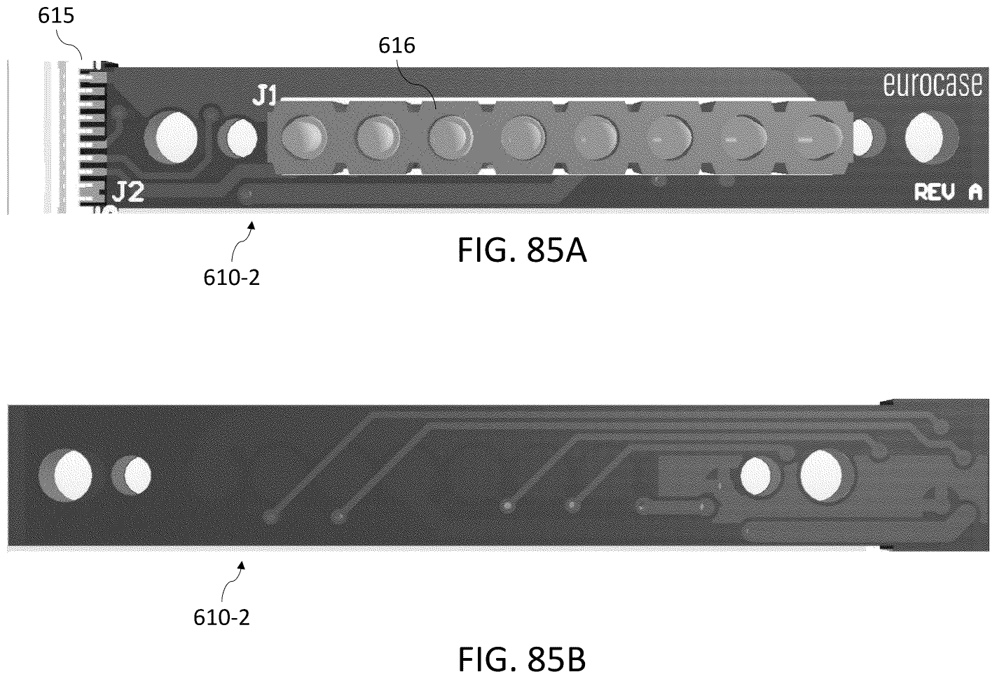

FIGS. 85A and 85B show additional views of the pogo pin connector board 610-2 forming part of the carrier electronics 600a. As shown, the circuit board 610-2 includes an electrical connector 615 for connection to another portion of the carrier electronics 600a, such as the circuit board 610-1 via an electrical cable. The circuit board 610-2 further includes a pogo pin electrical connector 616 to electrically couple the carrier 200a to the traces 712 of the circuit board 710a.

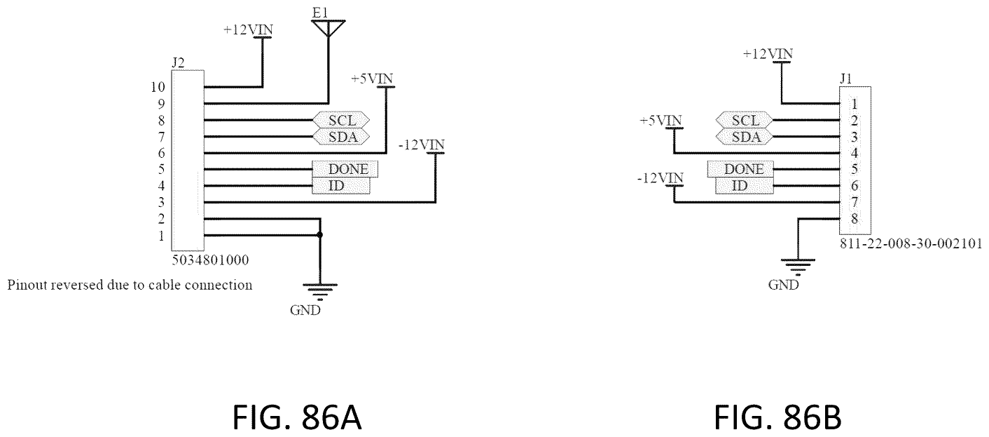

FIG. 86A shows a circuit diagram of a circuit board electrical connector. FIG. 86B shows a circuit diagram of a pogo pin electrical connector. It should be appreciated that the circuit board 610-2 and the various electronic components and circuitry included therein shown in FIGS. 85A-86B are non-limiting examples and that the other combinations and arrangements of electronic components that provide the same or similar functionality as the circuit board 610-2 are also contemplated herein.

### 1.5 Networking and Control of the Case Assembly

As described above, the case electronics 700a can generally provide various electrical connections to facilitate the operation and control of the modules 20. In some implementations, the case electronics 700a can further include a controller (not shown) that provides additional functionality to aid the operation of the modular signal processing system 100a. The controller can be a processor disposed directly on one of the circuit boards 710 or disposed on a separate circuit board communicatively coupled to the circuit boards 710 via an electrical cable. In some implementations, the controller can be disposed within the cavity 301 of the case 300a. In some implementations, the controller can be disposed in a separate housing and communicatively coupled to the circuit boards 710 via an electrical cable. The controller can further include onboard memory (e.g., volatile and non-volatile memory). In some implementations, the controller can also be communicatively coupled to a remote computer to provide the user various data regarding the operation and configuration of the modular signal processing system 100a and/or to receive various command inputs from the user to control the operation of the modular signal processing system 100a. The computer can generally include a processor coupled to a display device (e.g., a monitor) and an input device (e.g., a mouse, a keyboard, a touchscreen). For example, the computer can be stationary device (e.g., a desktop computer, a server) or a portable device (e.g., a laptop, a tablet, a smartphone).

In one example, the controller can be used to identify the modules 20 installed in the case assembly 120a and their respective positions in the case 300a. The identity of the module 20 can be determined based on the type of module installed (e.g., amplifier, filter) and/or the model number of the module. This can be accomplished in several ways.

The following are several examples in which the case electronics 700a provides dedicated sets of electrical traces at each possible location a module 20 and associated carrier electronics 600a can be installed. However, it should be appreciated the same approaches can be adapted for case electronics 700a with electrical traces that are shared between multiple modules 20 and respective carrier electronics 600a.

In one approach, the case electronics 700a can include dedicated lines, for example, from a multiplexer to each location a module 20 can be positioned in the case assembly 120a where an identity resistor, parallel collection of jumpers, or one-wire or I2C type identity number chip can be read to identify the module. Alternatively, a daisy chain signal can be used where the modules 20 can be identified based on their respective positions within the signal. A digital identity associated with that portion of the signal can be read similar to a Joint Test Action Group (JTAG) interface.

In another approach, the order of the modules 20 can be checked when the modular signal processing system 100a is powered on. This can be accomplished, for example, using a signal line that is split at each location a module 20 can be positioned in the case assembly 120a. A signal transmitted along the signal line is passed on from one location to another location once the module 20 is identified. For locations that do not support a module 20, the signal is still passed onto the next location.

For example, FIG. 8B shows one example implementation that utilizes logic gates. As shown, each location has an AND gate on the backplane and a pullup resistor on the ‘Done’ input so that the ‘ID’ signal can be passed through to the next location even if no module 20 is present. When initially powered up, the carrier electronics 600a for each module 20 make the ‘Done’ outputs of the logic gates low, preventing the ID signal from being transmitted to the location. The carrier electronics 600a for each module 20 then waits for the ‘ID in’ signal to go high, which indicates that the controller wants to identify it.

The controller changes the ‘ID’ signal up at the first location and thereafter communicates with the first module 20 in the modular signal processing system 100a. Once the first module 20 has been identified, the carrier electronics 600a associated with the first module 20 makes the ‘Done’ output at the first logic gate go high and then ignores further ID requests so that the next module 20 respond. This process continues until no modules 20 respond, at which point the controller determines all the modules 20 have been accounted for. The order of the modules 20 thus corresponds to the order in which the modules 20 were identified.

In some implementations, the ‘ID’ signal can also be provided on one of the normal signal lines between the case electronics 700a and the carrier electronics 600a. This additional signal line can be in the form an additional electrical trace and an additional pogo pin. In some implementations, the signal can be provided on two normal signal lines formed using two additional electrical traces and two additional pogo pins to reduce potential gate delays when many modules 20 are installed (e.g., hundreds of modules 20). The AND gate can be a 74LVC1G08.

In another approach, the case electronics 700a can include another signal line with a relatively high resistance per length with one end connected to a positive power supply and another end connected to a negative power supply. When the carrier electronics 600a and the module 20 are connected, it can measure its position by measuring the electrical resistance relative to one end of the signal line and transmit the position to the controller. Alternatively, the controller is connected directly to the signal line and the positive power supply with a known resistance. When the carrier electronics 600a and the module 20 are connected, the carrier electronics 600a connect to the negative power supply at the signal line. The controller can then measure the position of the module 20 directly and instruct the carrier electronics 600a and the module 20 to disconnect from the signal line.

In another approach, each location can have a location ID defined by different subsets of the traces that are grounded. For example, location 0 has traces 1, 2, and 3 grounded, location 1 has only traces 2 and 3 grounded, and so on. The carrier electronics 600a can have I2C, a unique I2C address, and can sense the ID pins. Additionally, the carrier electronics 600a can include pull up lines on the ID sense pins. The controller can send a message to all possible I2C addresses. If the controller does not receive a response from a particular location, then there is no carrier electronics 600a and module 20 connected. If there is a response, the carrier electronics 600a can reply with the socket ID. In this manner, the identity and location of each module 20 can be determined.

In implementations where the carrier electronics 600a does not include a micro-controller, each location can include a device (e.g., PCF8574) and one or more jumpers to identify the module 20. Generally, two electrical connections can support I2C and log 2 (Number of modules 20) of electrical traces for the location ID. Alternatively, the case electronics 700a can include a resistor divider to identify the location via a voltage and each carrier electronics 600a can use I2C ADC to identify the module 20 associated with the position via three electrical connections.

In another approach, a location number can be associated with each location on the case electronics 700a so that a unique ID is not needed for each module 20 and associated carrier electronics 600a. This can be accomplished by incorporating voltage divider resistors at each location on the case electronics 700a, which are connected to each carrier electronics 600a via an analog-digital converter (ADC) using a single electrical trace. Alternatively, the case electronics 700a can include multiple electrical traces that connect to the carrier electronics 600a to provide a binary address. Thus, when the module 20 and the carrier electronics 600a are connected, the carrier electronics 600a reads the location number. Then, the controller can transmit a signal to the location number and the carrier electronics 600a can transmit a signal to inform the controller the identity and position of the module 20 installed. In some implementations, the controller can transmit a signal to all location numbers to monitor the presence, identity, and locations of modules 20 installed and/or uninstalled at any time.

Once the controller determines the identity of the modules 20 and their relative positions in the case 300a, the controller can then save and record this data onto the onboard memory for future reference. In this manner, the case assembly 120a can conveniently store different configurations, which can aid the user when testing different configurations of modules 20. Additionally, the controller can also utilize this data to generate a digital representation of the modular signal processing system 100a with the different modules 20 and display the digital representation onto the display device of the computer.

In another example, the controller can monitor the operation of each module 20. For instance, the controller can measure the current draw from each module 20 installed in the case assembly 120a to determine if the module 20 is being used while the modular signal processing system 100a is in operation, and/or the amount of electrical power consumed by each module 20. This data can also be used to track the duration each module 20 is used, for example, when the modular signal processing system 100a is playing a particular track.

In yet another example, the controller can be used to directly control the operation of one or more modules 20 installed in the case assembly 120a. For instance, the controller can be used to selectively turn on and off specific modules 20 installed in the case assembly 120a. The controller can also be used to transmit various control signals to each module 20. As described above, the case electronics can generally provide various electrical connections for each module. For example, FIG. 8A shows the case electronics 700a provides a ground connection (GND), a +12V connection, a −12V connection, a +5V connection, a gate connection (GATE), a control voltage connection (CV), and a clock signal connection (SCL, SDA).

In previous modular synthesizers, particularly modular synthesizers conforming to the Eurorack format, the GATE and CV connections were provided, but seldom used due, in part, to signal conflicts along the bus lines in the power bus. In this manner, the user can utilize the controller, for example, to transmit a centralized clock signal to specific modules 20 to control the tempo of the audio signals generated by the modules 20 instead of relying exclusively on patch cables. This can allow the user to remotely generate different clock signals using, for example, the remote computer communicatively coupled to the controller.

In some implementations, the case assembly 120a can be electrically coupled to other case assemblies installed, for example, in a single, larger enclosure. The case assembly 120a can generally be electrically coupled to another case assembly 120a or a different case assembly provided the electrical connections are compatible. In one example, multiple case assemblies 120a can share one or more power supplies to supply electrical power to the respective modules installed in each case assembly 120a. In another example, the respective controllers of each case assembly 120a can be communicatively coupled together and/or to a single computer.

### 1.6 Example Methods for Assembly, Installation, and Uninstallation

As noted above, one of the primary benefits of the case assemblies described herein is simplifying the process of installing and uninstalling a module, which allows a user to more easily reconfigure a modular signal processing system. In the following, several example methods of installing and uninstalling a module using the carrier 200a and the case 300a are provided to highlight this particular benefit. It should be appreciated, however, that the methods discussed below are non-limiting examples and that, more generally, other module attachment mechanisms, locking mechanisms, and alignment mechanisms can be used.

A module 20 can be first mechanically, electrically, and communicatively coupled to a carrier 200a using the following steps: (A1) aligning the faceplate 21 of the module 20 to the posts of the module attachment mechanisms 240a that form a portion of the twist lock of the alignment mechanism 400a, (A2) mechanically coupling the faceplate 21 to the carrier via the knobs, and (A3) connecting a first end of the electrical cable 130 to the connector pins 611 of the carrier electronics 600a and a second end of the electrical cable 130 to the connector 24 of the module's electronics 23 thereby electrically coupling the module 20 to the carrier electronics 600a.

As described above, the carrier 200a can remain coupled to the module 20 in a semi-permanent manner. The carrier 200a further provides a mechanical interface and an electrical interface to facilitate installation of the module 20 to the case 300a. In some implementations, the carrier 200a and the module 20 can be installed via the following steps: (B1) inserting the carrier 200a and the module 20 into the cavity 301 of the case 300a, (B2) actuating the twist locks of the alignment mechanism 400a to mechanically couple the carrier 200a to the case 300a such that the carrier 200a is slidably movable relative to the case 300a, (B3) slidably moving the carrier 200a and the module 20 to a desired location in the case 300a, (B4) actuating the locking mechanism 500a to mechanically constrain the carrier 200a to the case 300a thereby maintaining the carrier 200a and the module 20 at the desired location, and (B5) while mechanically constraining the carrier 200a, pressing the pogo pins 612 of the carrier electronics 600a against the electrical traces 712 of the case electronics 700a via the locking mechanism 500a thereby electrically and communicatively coupling the carrier electronics 600a to the case electronics 700a.

In some implementations, the carrier 200a and the module 20 can be uninstalled from the case 300a using the following steps: (C1) actuating the locking mechanism 500a to mechanically release the carrier 200a from the case 300a such that the carrier 200a is slidably movable relative to the case 300a while remaining mechanically coupled to the case 300a, (C2) while actuating the locking mechanism 500a, moving the pogo pins 612 from the electrical traces 612 to electrically decouple the carrier electronics 600a from the case electronics 700a, (C3) actuating the twist locks of the alignment mechanism 400a to mechanically decouple the carrier 200a and the case 300a, and (C4) removing the carrier 200a and the module 20 from the cavity 301 of the case 300a.

### 1.7 Example Modules

The case assembly 120a, as described above, can mechanically, electrically, and communicatively support one or more modules 20. Various modules 20 can be installed into the case assembly 120a including, but not limited to, an oscillator (e.g., a voltage-controlled oscillator, a low-frequency oscillator), an amplifier, a filter, an envelope generator, and a noise generator. As described above, the frame 210 of the carrier 200a can include an aperture 211 to allow portions of the module 20 to pass through such that the overall width of the module 20 remains unchanged when coupled to the carrier 200a. Thus, the number of modules 20 that can be installed into the case assembly 120a is limited only by the relative dimensions of the case 300a and the modules 20.

Generally, the height of the modules 20 remains fixed while the width and the depth can vary. The case assembly 120a can generally support modules 20 with different widths using one or more carriers 200a. For example, the carrier 200a can be mounted to one side of the module 20 and the remainder of the module 20 can be cantilevered. In another example, two carriers 200a can be mounted to opposing sides of the module 20 to provide additional mechanical support particularly for heavier and/or larger modules 20. Additionally, the aperture 211 of the carrier 200a can accommodate modules 20 with different depths as described above.

In some implementations, one or more modules 20 can be installed into the case assembly 120a such that only a portion of the cavity 301 of the case 300a is occupied. The remaining, unoccupied space in the case 300a can still be covered, for example, by one or more blank faceplates (not shown) mounted to one or more carriers 200a so that the electronics of the modules 20 that are installed into the case 300a are not exposed. For example, a kit can be provided with multiple blank faceplates that have different widths to cover unoccupied portions of the case 300a that can vary in dimensions depending on the number and size of the modules 20 installed in the case 300a.

In some implementations, the case assembly 120a can also support modules 20 designed for a particular standardized format. Various standardized formats have been developed, in part, to ensure compatibility between modules and cases developed by different manufacturers. Examples of these standardized formats include, but are not limited to, Eurorack, Buchla, Frac, Modcan A, Module of the Month (MOTM), Moog Unit (MU), Serge, and 500 Series.

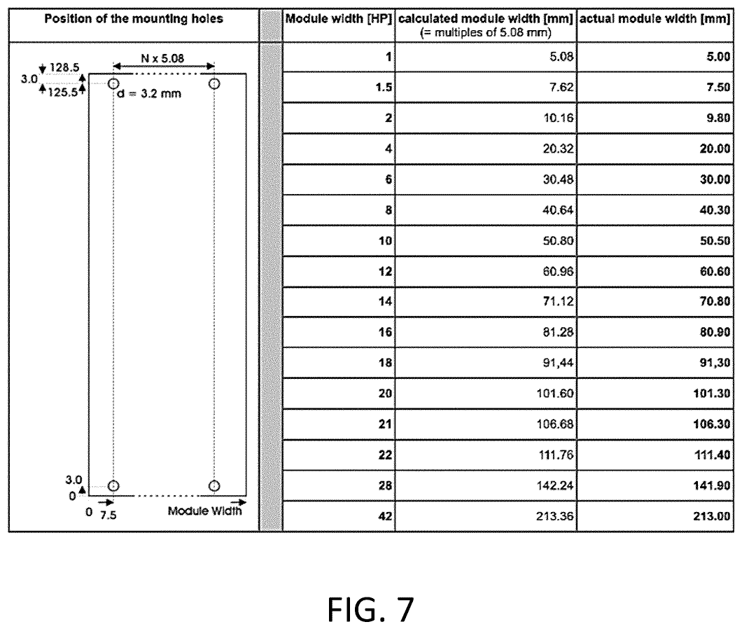

The standardized formats typically include a mechanical specification that constrains the physical dimensions of the module 20 and an electrical specification that defines the electrical connections to use with the module 20. For example, FIG. 7 shows a diagram and a table of the mechanical specification for the Eurorack format, which is based on the standardized dimensions of 19-inch server racks. As shown, the mechanical specification primarily constrains the dimensions of the faceplate 21 of the module 20, in part, because the faceplate 21 typically provides one or more attachment points (e.g., fastener openings) to mechanically couple the module 20 to a case.

Specifically, the faceplate 21 is constrained to have a height of about 128.5 mm, which corresponds to a 3U rack height (e.g., 5.25 inches, or 133.4 mm) minus the thickness of the sides or lips of a typical case. The width of the module 20 is defined in integer multiples of a horizontal pitch (HP) unit where 1 HP equals 0.2 inches. Eurorack modules typically have a width that ranges between 2 HP and 84 HP where 84 HP corresponds to the width of a typical 19-inch server rack. More generally, the width of the module 20 is greater than or equal to 1 HP with no upper limit on the width. Since the height of the module 20 is fixed, the size of a Eurorack module and a Eurorack case are typically defined based on their respective widths. For example, a Eurorack case with an 84 HP width can hold 7 modules with a 12 HP width (7×12=84) or 6 modules with a 14 HP width (6×14=84). The depth of the module 20 in the Eurorack format can vary and is generally not constrained by the mechanical specification. Eurorack modules typically have a depth that ranges between 1 inch to 5 inches.

The electrical specification for the Eurorack format specifies a common power supply that can distribute electrical power to one or multiple modules via, for example, the power bus 40 or a flying bus cable with multiple connectors. Typically, Eurorack modules are electrically connected to a case via 0.1″ spaced IDC ribbon-cable connectors with either 10-pin or 16-pin configurations. The 10-pin configuration includes two pins for +12V electrical connections, two pins for −12V electrical connections, and six pins for ground (GND) connections. The 16-pin configuration shares the same electrical connections as the 10-pin configuration with the addition of two pins for +5V electrical connections, two pins for Gate connections, and two pins for Control Voltage (CV) connections.

To support a module 20 designed for a particular standardized format, the carrier 200a can be tailored to conform with both the mechanical and electrical specifications of the format. For example, if the module 20 is a Eurorack module, the posts of the module attachment mechanisms 240a can be positioned on the frame 210 to align with the fastener openings on the faceplate 21 of the module 20. In another example, the carrier 200a can be shaped and/or dimensioned to fit into a space (e.g., the cavity 301 of the case 300a) with a height of about 128.5 mm. In yet another example, the carrier electronics 600a can provide electrical connections that accommodate the 10-pin and/or 16-pin configurations typically used for Eurorack modules.

In some implementations, the case 300a can also conform with both the mechanical and electrical specifications of a standardized format. For example, the case 300a can be shaped and/or dimensioned to fit into a 19-inch server rack. Specifically, the case 300a can have an exterior height of about 133.4 mm (5.25 inches) corresponding to a 3U rack height. The cavity 301 of the case 300a can have a height of about 128.5 mm. The cavity 301 can also have a width chosen in increments of HP units. For example, the cavity 301 can have a width of 64 HP (12.8 inches), 84 HP (16.8 inches), and 104 HP (20.8 inches). More generally, the width of the cavity 301 can range between 2 HP and 120 HP.

The term “about,” when used to describe the dimensions of the module 20, the carrier 200a, and/or the case 300a, are intended to cover manufacturing tolerances. For example, “about 1 inch” can correspond to the following dimensional ranges: 0.99 to 1.01 inches (+/−1% tolerance), 0.992 to 1.008 inches (+/−0.8% tolerance), 0.994 to 1.006 inches (+/−0.6% tolerance), 0.996 to 1.004 inches (+/−0.4% tolerance), 0.998 to 1.002 inches (+/−0.2% tolerance), including all values and sub-ranges in between.

It should be appreciated, that in some implementations, the carrier 200a and the case 300a do not both have to conform with the mechanical and electrical specifications of a standardized format. For example, the carrier 200a can still be configured to support Eurorack modules while the case 300a can be shaped and/or dimensioned without any constraints. In another example, the carrier 200a can support a module 20 that doesn't conform to any standardized format while the case 300a is designed to fit into a 19-inch server rack. That way, the case assembly 120a can be installed into larger enclosures supporting multiple cases that are designed in accordance with the Eurorack format while accommodating modules 20 that don't conform to the Eurorack format. In yet another example, the case 300a can include case electronics 700a that provides the electrical connections to support a Eurorack module and additional electrical connections to support modules 20 that conform to another standardized format or modules 20 that don't conform to any format.

In some implementations, the various mechanical and electrical features of the carrier 200a can also be integrated into a module. Said in another way, new modules can be developed together with the case assembly to create a new format. For example, the faceplate and the frame 210 can be integrally formed together with mechanical features that form, at least in part, the alignment mechanism 400a and the locking mechanism 500a. In another example, the electronics of the module can include a circuit board that integrates the pogo pins 612, thus further simplifying the case of installing and/or uninstalling the module by eliminating the electrical cable 130.

### 1.8 Expansion of the Case Assembly

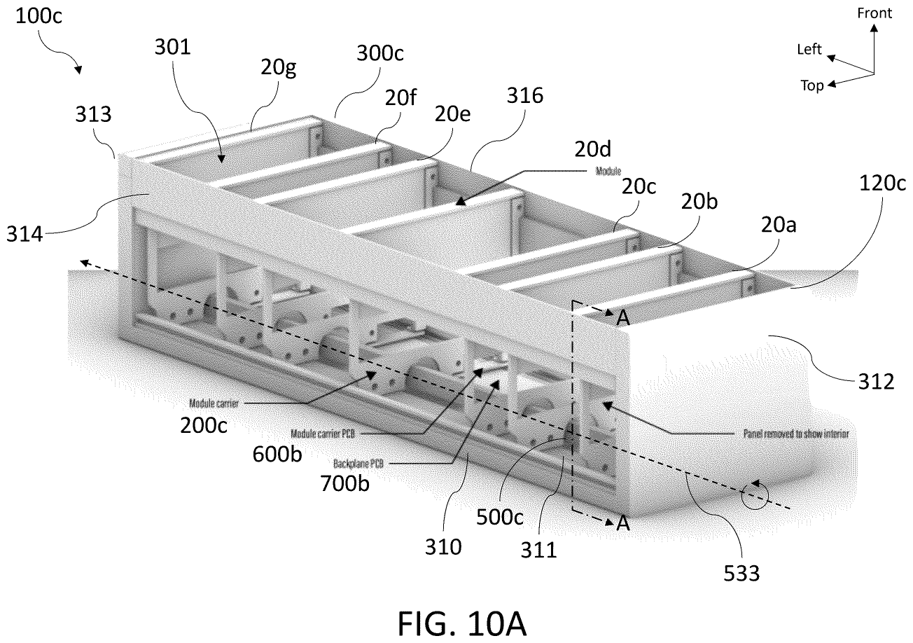

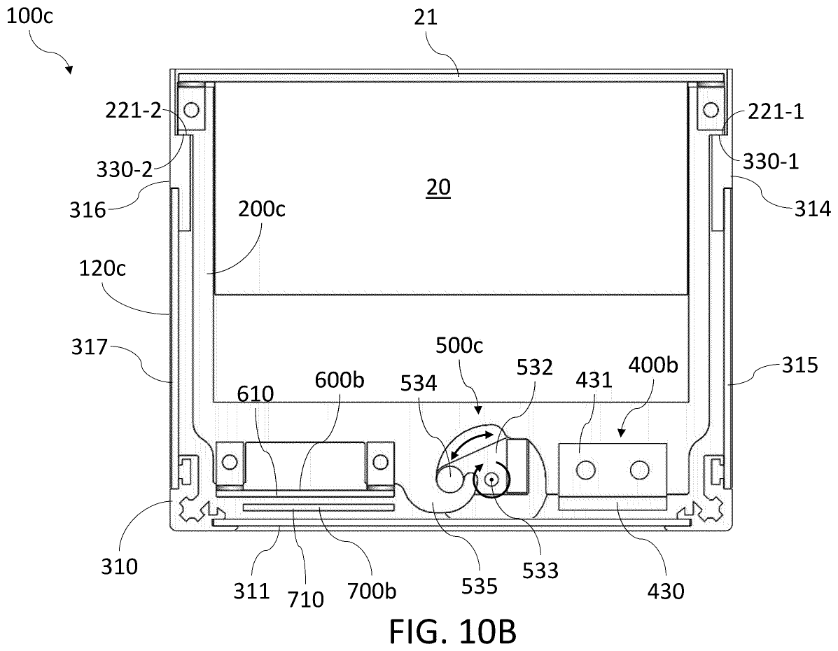

The case 300a can also be mechanically and electrically expandable along at least the width of the case assembly 120a to support more modules 20 and/or larger-sized modules 20 in the case assembly 120a. For example, the frame 310 of the case 300a can be an assembly of one or more wall sections that each define a top, bottom, and back portion of the cavity 301 and provide the mechanical features (e.g., the . . . ) to support the carrier 200a. The frame 310 can further include a right end panel and a left end panel that define the right and left sides of the cavity 301, respectively. For example, the frame 310 in the case 300c shown in FIG. 10A includes a top portion 314 and a bottom portion 316 joined together via a right end panel 312 and a left end panel 313. The respective wall sections and the right/left end panels can be mechanically coupled together via various attachment mechanisms including, but not limited to, a snap-fit connector, a fastener, and a dowel pin.

In some implementations, the wall sections forming the frame 310 can have the same cross-sectional geometry. For example, the wall sections can be formed via an extrusion process. Additionally, the wall sections can have different widths so that the user has more options to mechanically expand the case 300a to any desired width. For example, the wall sections can have a width ranging between 2 HP and 120 HP.

The case electronics 700a can also be expandable provided the power supply used in the case assembly 120a can support additional modules 20. For example, FIG. 8A shows example case electronics 700a with multiple circuit boards 710a-710c connected together in series to span a larger width. Said in another way, the circuit boards 710a-710c are daisy-chained together. As shown, the respective electrical traces 712 of the circuit boards 710a and 710b can be electrically and communicatively coupled together via a combination of male header pins 720 disposed at one end of the circuit board 710a and a female header block 721 disposed at one end of the circuit board 710b. The circuit boards 710b and 710c can also be electrically and communicatively coupled together via another set of male header pins (not shown) and another female header block (not shown). The male header pins 720 and the female header block 721 provide pin connections that correspond to the multiple electrical traces 712 supported on each of the circuit boards 710a and 710b. Each of the circuit boards 710a-710c can be mechanically supported by the case 300a.

The case electronics 700a can also include different-sized circuit boards 710 to provide greater flexibility to expand the case 300a to a desired width. For example, FIG. 8A shows the circuit board 710a has a width of 20 HP, the circuit board 710b has a width of 40 HP, and the circuit board 710c has a width of 24 HP.

### 1.9 Auxiliary Devices

The case assembly 120a can also support auxiliary devices to further improve user interaction with the modular signal processing system 100a. The auxiliary devices can generally be mechanically mounted to the carrier 200a or the case 300a and electrically and communicatively coupled to the carrier electronics 600a and/or the case electronics 700a.

In one example, the carrier 200a can include a touch sensor to provide the user an additional control input for the module. In some implementations, the touch sensor can be capacitive touch sensor mounted to the module attachment mechanism 240a. Specifically, the capacitive touch sensor can be electrically and communicatively coupled to the fastener 241 and thus actuated by the user touching the fastener 241. The capacitive touch sensor can be used, for example, to turn the module 20 on or off, or to cycle between different clock signals provided by the case electronics 700a.

In another example, the carrier 200a can include a visual indicator to provide the user feedback on the operating status of the module 20 supported by the carrier 200a. For instance, the visual indicator can emit green light when the module 20 is turned on and ready to use, red light when the module 20 is turned off, and/or white light if the module 20 is receiving a clock signal at which point the capacitive touch sensor can be used to cycle through different clock signals for the module 20.

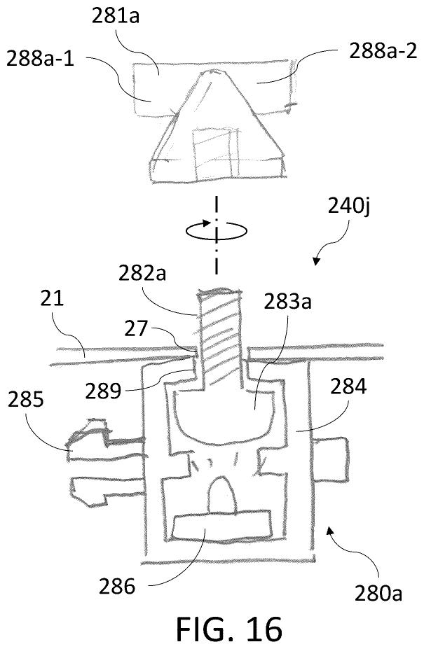

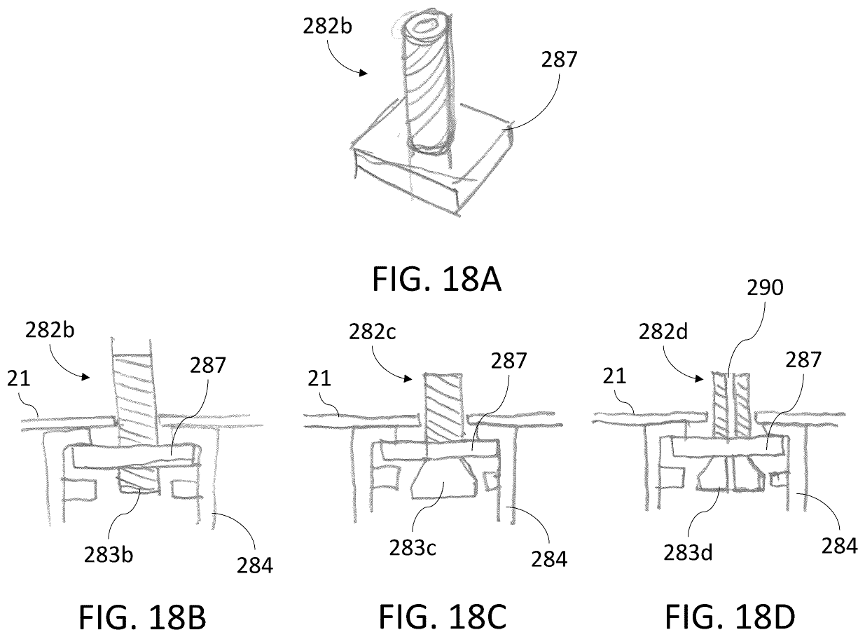

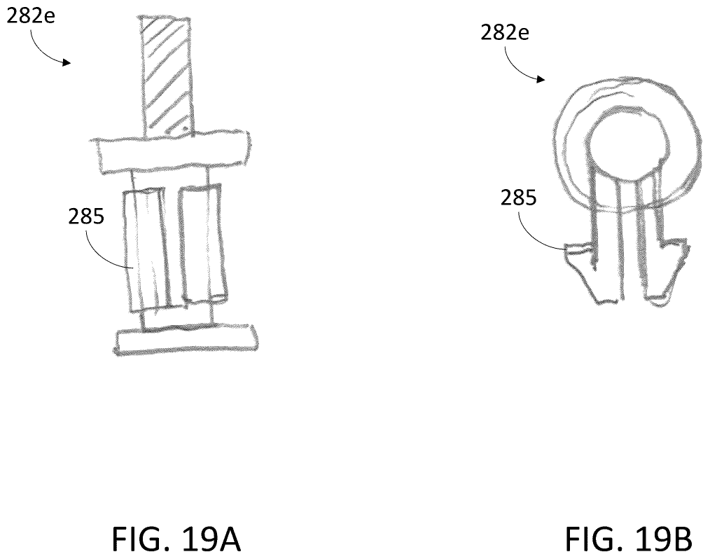

In some implementations, the visual indicator can be a light emitting diode coupled to the frame 210 near the module attachment mechanism 240a (see, for example, the LED indicator 286 in FIG. 16). In some implementations, the visual indicator can be disposed behind the faceplate 21 of the module 20 and emit light through the fastener used to attach the module 20 to the carrier 200a (e.g., the fastener 241). For example, the fastener can be formed of either a transparent material (e.g., transparent polycarbonate) or include an opening to allow light to pass through the fastener (see, for example, the fastener 282d in FIG. 18D).

### 2. An Example Case Assembly with a Back-Mounted Carrier

As described above, in some implementations, it can be preferable for the carrier to be mechanically coupled to the sides of the case to accommodate cases designed for different modes of deployment (e.g., a skiff-style case deployed on a desk, a rack-style case deployed in a vertical rack). For example, the case assembly 100a includes a carrier 200a that is mechanically coupled to the top portion 314 and the bottom portion 316 of the case 300a and electrically and communicatively coupled to case electronics 700a disposed on the top portion 314 of the case 300a. However, it should be appreciated the case assembly 120a is a non-limiting example and that the case assemblies described herein can also include carriers that are mechanically coupled to, for example, a back portion of the case.

2.1 An Example Case Assembly with a Locking Bar

FIG. 9 shows another example modular signal processing system 100b with a case assembly 120b that includes a carrier 200b mechanically coupled to a back portion 311 of a case 300b and carrier electronics 600b electrically and communicatively coupled to case electronics 700b disposed on the back portion 311 of the case 300b. The case assembly 120b and its constituent components, such as the carrier 200b and the case 300b, can generally include one or more of the same features described above with respect to the case assembly 120a. For brevity, detailed discussions of these features are not repeated below.

As shown, the carrier 200b includes a frame 210 with a base portion 230 and a pair of arms 220-1 and 220-2 that together define an aperture 211 for a portion of the module 20 (e.g., the electronics 23) to pass through. The carrier 200b further includes module attachment mechanisms 240b-1 and 240b-2 to mechanically couple a module 20 to the carrier 200b. Specifically, each of the module attachment mechanisms 240b-1 and 240b-2 includes a bracket 246 that defines a fastener opening (not shown) and fastener 241 that is inserted through corresponding fastener openings (not shown) on the faceplate 21 of the module 20 and the bracket 246. In some implementations, the size of the fastener openings on the brackets 246 and the locations of the brackets 246 on the frame 210 can be tailored to accommodate modules 20 designed for a particular standardized format (e.g., the Eurorack format).

The carrier 200b further includes carrier electronics 600b disposed on a back side of the base portion 230. The carrier electronics 600b includes a circuit board 610, which can be mechanically coupled to the frame 210 using various attachment mechanisms including, but not limited to, a fastener, an adhesive, and a snap-fit connection. The circuit board 610 includes electrical connectors 611 (e.g., male header pins) to facilitate connection with the module 20. In particular, an electrical cable 130 (e.g., a ribbon cable) can be connected at one end to the electrical connectors 611 of the carrier electronics 600b and at another end to a corresponding electrical connector (not shown) on the module's electronics. In this manner, the carrier 200b provides both a mechanical interface and an electrical interface to couple the module 20 to the case 300b and the case electronics 700b, respectively.

### 2.1.1 Mechanical Interconnection

The case assembly 120b further includes a locking mechanism 500b to securely couple the carrier 200b to the case 300b. As shown in FIG. 9, the locking mechanism 500b includes a quick-release mechanism 531 formed on a back side of the base portion 230 of the carrier 200b that mechanically engages a locking bar 530 disposed on the back portion 311 of the case 300b. The locking bar 530 provides an anchor point to mechanically constrain the carrier 200b. In some implementations, the locking bar 530 can span the width of the case 300b such that multiple carriers 200b can be mechanically coupled to the locking bar 530. Additionally, the position of the carrier 200b within the case 300b can also be adjusted by slidably moving the carrier 200b along the locking bar 530 before the quick-release mechanism 531 is engaged.

In one example, the quick-release mechanism 531 can include a clamping mechanism (not shown), such as a movable hook, to lock the carrier 200b in place at a desired location along the locking bar 530. In some implementations, the clamping mechanism can impart a clamping force to further reduce or, in some instances, mitigate unwanted play or backlash between the carrier 200b and the case 300b. The quick-release mechanism 531 can include an actuator (not shown), such as a sliding switch, a lever, or a turn knob, disposed on the carrier 200b or the case 300b for the user to use to lock and/or release the carrier 200b from the case 300b.

FIG. 9 also shows the carrier 200b can include a pair of overhang portions 221-1 and 221-2 disposed on the arms 220-1 and 220-2, respectively, that physically contact respective ledges 330-1 and 330-2 (also referred to herein as a “ledge 330”) formed on the sides of the case 300b when the carrier 200b is installed into the case 300b. The overhang portions 221-1 and 221-2 and the ledges 330-1 and 330-2 provide additional points of contact between the carrier 200b and the case 300b to improve the mechanical stability of the carrier 200b and the module 20 after installation. Said in another way, the overhang portions 221-1 and 221-2 and the ledges 330-1 and 330-2 ensure the carrier 200b and the module 200b are not supported solely by the locking bar 530.

### 2.1.2 Electrical and Electronic Interconnection

The case electronics 700b are disposed on the backside portion 311 of the case 300b. Similar to the case electronics 700a and 700a, the case electronics 700b includes one or more circuit boards 710 with multiple electrical traces 712 that each correspond to a particular electrical connection. The circuit board 610 of the carrier electronics 600b can further include pogo pins 612 that electrically contact respective electrical traces 712 when the carrier 200b is installed into the case 300b. In some implementations, the combined weight of the carrier 200b and the module 20 can be sufficient to ensure the pogo pins 612 maintain electrical contact with the electrical traces 712. In some implementations, the locking mechanism 500b can generate an additional force to push the pogo pins 612 against the electrical traces 712.

2.2 An Example Case Assembly with a Rotatable Locking End

FIGS. 9A and 9B show another example case assembly 120c for a modular signal processing system 100c that includes a locking mechanism 500c with a rotatable locking end 532 mounted to the case 300c to mechanically couple multiple carriers 200c to the case 300c. FIGS. 10A-10D show several additional views of the carrier 200c supporting a module 20. The case assembly 120c and its constituent components, such as the carrier 200c and the case 300c, can generally include one or more of the same features described above with respect to the case assemblies 120a and 120b. For brevity, detailed discussions of these features are not repeated below.

As shown, multiple modules 20 (e.g., the modules 20a-20g) can be installed into the case 300c with each module 20 being mechanically and electrically supported by at least one carrier 200c. Similar to the case assemblies 120a and 120b, the carrier 200c provides a mechanical interface and an electrical interface between the module 20 and the case 300c. Specifically, each module 20 is mechanically coupled to the carrier 200c via a pair of module attachment mechanisms 240c-1 and 240c-2. The carrier 200c also includes the carrier electronics 600b described above, which are electrically and communicatively coupled to the electronics of the module 20 (e.g., the electronics 23) via an electrical cable (not shown). Similarly, the case 300c includes the case electronics 700b described above, which are electrically and communicatively coupled to the carrier electronics 600b via a combination of pogo pins on the carrier electronics 600b and electrical traces on the case electronics 700b. The case assembly 120c further includes an alignment mechanism 400b to align and position the carrier 200c in the case 300c before the locking mechanism 500c is engaged. Similar to the case assembly 120b, the carrier 200c is mechanically coupled to a back portion 311 of the case 300c and the case electronics 700b are disposed on the back portion 311 as well.

### 2.2.1 Case Design

As shown in FIG. 10A, the case 300c includes a frame 310 that defines a cavity 301 to contain the carriers 200c and portions of the modules 20. The frame 310 is generally shaped as a rectangular box with a top portion 314 and a bottom portion 316 joined together via a right end panel 312 and a left end panel 313. The top portion 314 further includes a removable panel 315 and the bottom portion 316 similarly includes a removable panel 317 to provide access into the cavity 301 particularly after the carriers 200c and the modules 20 are installed. In some implementations, the back portion 311 is also a separate panel coupled to the top portion 314 and the bottom portion 316 of the frame 310.

In some implementations, the case 300c is dimensioned to conform with a particular standardized format, such as the Eurorack format. For example, the width of the cavity 301 can be 64 HP (12.8 inches), 84 HP (16.8 inches), or 104 HP (20.8 inches). More generally, the width of the cavity 301 is at least 0.4 inches (2 HP). The height of the case 300c can also be about 5.25 inches so that the case assembly 120c can be installed into a server rack (e.g., a 19-inch server rack).

### 2.2.2 Carrier Design

FIGS. 10A and 10B show the carrier 200c includes a frame 210 with a base portion 230 and a pair of arms 220-1 and 220-2 that together define an aperture 211 for a portion of the module 20 (e.g., the electronics 23) to pass through. The module attachment mechanisms 240c-1 and 240c-2 are disposed at the front ends of the arms 221-1 and 221-2, respectively. As shown in FIGS. 10C and 10D, the module attachment mechanisms 240c-1 and 240c-2 each include an L-shaped bracket 246 with a pair of fastener openings 247 and 248. The bracket 246 is mechanically coupled to the frame 210 via a fastener (e.g., a screw, a bolt, a rivet) inserted through the fastener opening 247 and a corresponding fastener opening (not shown) on the respective ends of the arms 221-1 and 221-2. The module 20 is mechanically coupled to the bracket 246 via another fastener (e.g., the fastener 241) inserted through the fastener opening 248 and a corresponding fastener opening (not shown) on the faceplate 21 of the module 20.

The frame 210 also includes a circuit board attachment mechanism 260b to mechanically couple the carrier electronics 600b, in particular the circuit board 610, to the frame 210. The circuit board attachment mechanism 260b includes a pair of L-shaped brackets 270 disposed on a back side of the base portion 230 where each bracket 270 has a pair of fastener openings 272 and 273. The bracket 270 is mechanically coupled to the frame 210 via a fastener (not shown) inserted through the fastener opening 273 and a corresponding fastener opening (not shown) on the frame 210. The carrier electronics 600b are mechanically coupled to the bracket 270 via another fastener (not shown) inserted through the fastener opening 272 and a corresponding fastener opening (not shown) on the circuit board 610. In some implementations, the base portion 230 includes a pair of integrally formed tabs 274 to support the brackets 270 and an aperture 271 formed between the tabs 274 to provide clearance for various circuit elements disposed on the circuit board 610.

### 2.2.3 Mechanical Interconnection

As noted above, the case assembly 120c includes an alignment mechanism 400b to align and position the carrier 200c in the case 300c. FIG. 10A shows the alignment mechanism 400b includes a magnet 430 coupled to the back portion 311 of the case 300c and a magnet 431 coupled to the carrier 200c. FIGS. 10A and 10B show the magnet 431 can be supported by a mounting base 432 formed on the backside of the base portion 230. As shown, the mounting base 432 includes a pair of fastener openings 433 to mechanically couple the magnet 431 to the carrier 200c.

The magnets 430 and 431 are configured to be magnetically attracted to one another. In other words, the respective portions of the magnets 430 and 431 that physically contact one another have opposite magnetic poles. When the carrier 200c is inserted into the case 300c, the magnets 430 and 431 generate a magnetic attraction force to retain the carrier 200c in the case 300c. However, the magnetic attraction force generated between the magnets 430 and 431 can generally be tailored to allow the user to adjust the position and/or alignment of the carrier 200c relative to the case 300c before the locking mechanism 500c is engaged. The magnitude of the magnetic attraction force can be modified, in part, by using magnets with different geometries and/or magnets composed of different materials. For example, the magnetic attraction force can be tailored to be sufficiently large to retain the carrier 200c and the module 20 in the case 300c when the case 300c is flipped upside down. In other words, the magnetic attraction force is greater than the gravitational weight of the carrier 200c and the heaviest module 20 supported. However, the magnetic attraction force can also be tailored to be sufficiently small (e.g., less than 100 N) so that the user can readily remove the carrier 200c from the case 300c.

The locking mechanism 500c includes a locking end 532 rotatably coupled to the case 300c that can be actuated by the user to either lock the carrier 200c in place within the case 300c or release the carrier 200c for removal. As shown in FIG. 10B, the locking end 532 rotates about a rotation axis 533 via, for example, a rod or an axle supported at both ends by openings or slots (not shown) on the right end panel 312 and the left end panel 313 of the case 300c. In some implementations, the locking end 532 can be disposed on the back portion 311 of the case 300c. However, it should be appreciated the locking end 532 can more generally be disposed anywhere within the cavity 301. The locking end 532 further includes a bar 534 that securely couples the carrier 200c to the case 300c by physically contacting a hook 535 formed on the base portion 230 of the carrier 200c. FIG. 10B further shows the base portion 230 of the carrier 200c defines a channel 536 for the bar 534 to move along as the locking end 532 is rotated between locked and unlocked positions.

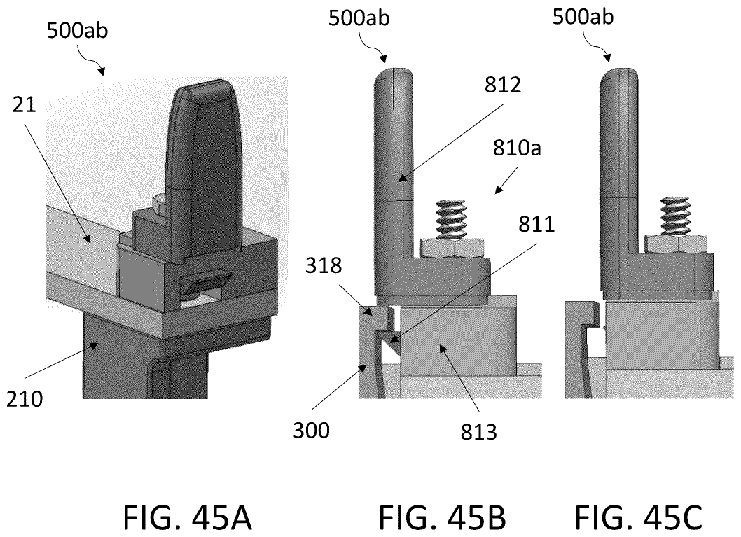

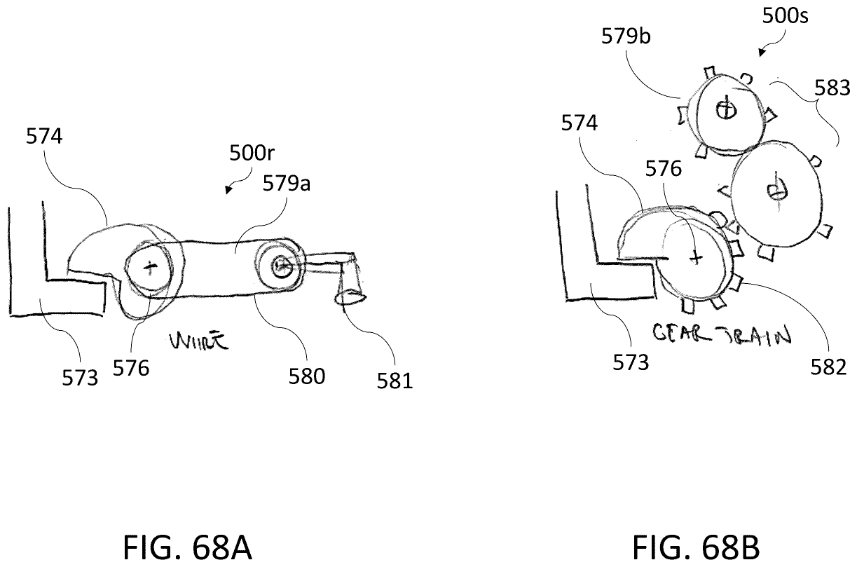

In some implementations, the locking end 532 can span the entire width of the cavity 301 as shown in FIG. 10A. Thus, the locking end 532 can mechanically secure and/or release multiple carriers 200c at the same time. It should be appreciated, however, the case assembly 100c can more generally include one or more locking mechanisms 500c that each have locking ends 532 to mechanically couple one or more carriers 200c to the case 300c. The locking end 532 can be actuated by various actuation mechanisms including, but not limited to, a linkage mechanism (see, for example, the actuation mechanisms 579c-579h in FIGS. 45-49B), a wire or cable (see, for example, the actuation mechanism 579a in FIG. 68A), and a gear assembly (see, for example, the actuation mechanism 579b in FIG. 68B). The actuator used to actuate the locking end 532 can be disposed on an exterior portion of the case 300c, such as the front sides of the right end panel 312 or the left end panel 313.

The carrier 200c further includes the overhang portions 221-1 and 221-2 and the case 300c further includes the ledges 330-1 and 330-2 to provide additional mechanical support when the carrier 200c is installed into the case 300c. As before, the overhang portions 221-1 and 221-2 and the ledges 330-1 and 330-2 provide additional mechanical stability and support to the carrier 200c so that the carrier 200b is not supported solely by the locking mechanism 500c and the alignment mechanism 400b.

### 3. Additional Examples of Carriers

It should be appreciated the carriers 200a-200c described above are non-limiting examples and that additional inventive implementations of the carrier are contemplated herein. In the following, several additional example implementations of carriers and components of the carriers are disclosed. Each of these carriers can generally include one or more of the same features described above with respect to the carriers 200a-200c. For brevity, detailed discussions of these features are not repeated below.

It should also be appreciated that one or more features discussed below in connection with a particular carrier can be readily incorporated in other example carriers according to the present disclosure provided that respective features are not mutually inconsistent. This includes, for example, features forming a portion of a frame, a module attachment mechanism, an alignment mechanism, a locking mechanism, and/or a circuit board attachment mechanism.

The following carriers can also be readily used together with the various example implementations of modules, cases, carrier electronics, and/or case electronics described herein. For example, each of the following carriers can be installed in any one of the cases 300a-300c described above. In another example, the following carriers can each support any one of the carrier electronics 600a and 600b described above.

3.1 Additional Examples of Carriers with Different Frames

FIGS. 11A-11C show another example carrier 200d with a module 20 where the carrier 200d includes module attachment mechanisms 240d-1 and 240d-2 integrally formed with the frame 210. The frame 210 once again includes a base portion 230 and a pair of arms 220-1 and 220-2 defining an aperture 211. The base portion 230 includes a pair of integrally formed tabs 274 forming part of the circuit board attachment mechanism 260b, a hook 535 forming part of the locking mechanism 500c, and a mounting base 432 forming part of the alignment mechanism 400b.

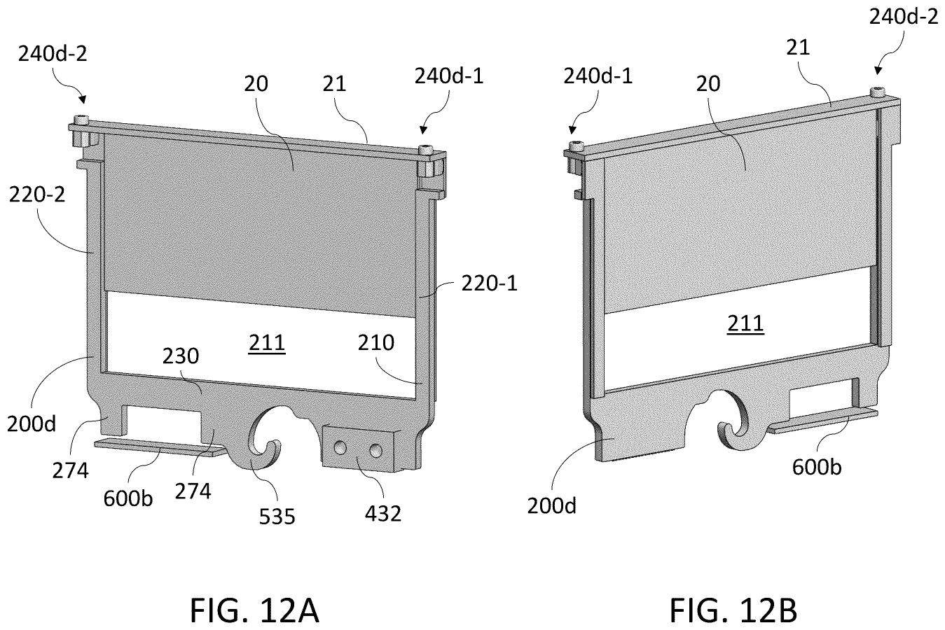

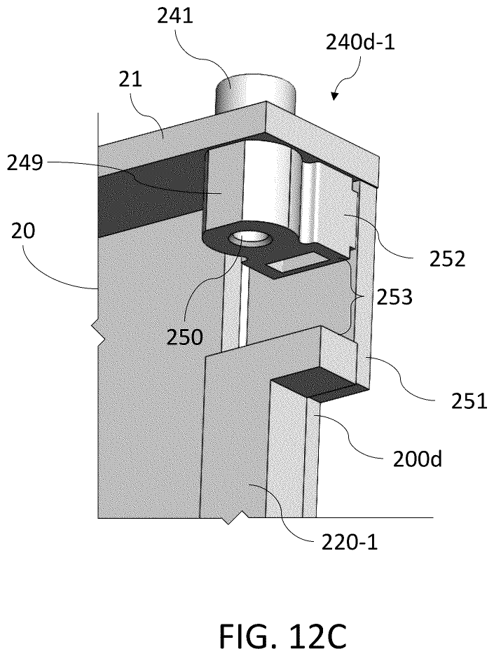

The module attachment mechanisms 240d-1 and 240d-2 are each joined to the respective front ends of the arms 220-1 and 220-2 via a wall portion 251 as shown in FIG. 12C. Each module attachment mechanism 240d-1 and 240d-2 includes a fastener post 249 defining a fastener opening 250 to facilitate mechanical coupling with the faceplate 21 of the module 20 via a fastener 241. As shown in FIG. 12C, the wall portion 251 is disposed on one side of the arm 220-1 and the fastener post 249 is offset from the front end of the arm 220-1 such that a channel 253 is formed between the fastener post 249 and the arm 220-1. As described above, the modules 20 typically include one or more circuit boards disposed behind the faceplate 21 with at least one circuit board oriented parallel with the faceplate 21 supporting one or more control inputs 25 and/or input/output ports 26. The channel 253 can be used, in part, to hold one or more of the circuit boards in the electronics 23 of the module 20. In some implementations, the channel 253 can also help align the fastener openings (not shown) of the faceplate 21 to the respective fastener openings 250 of the module attachment mechanisms 240d-1 and 240d-2.

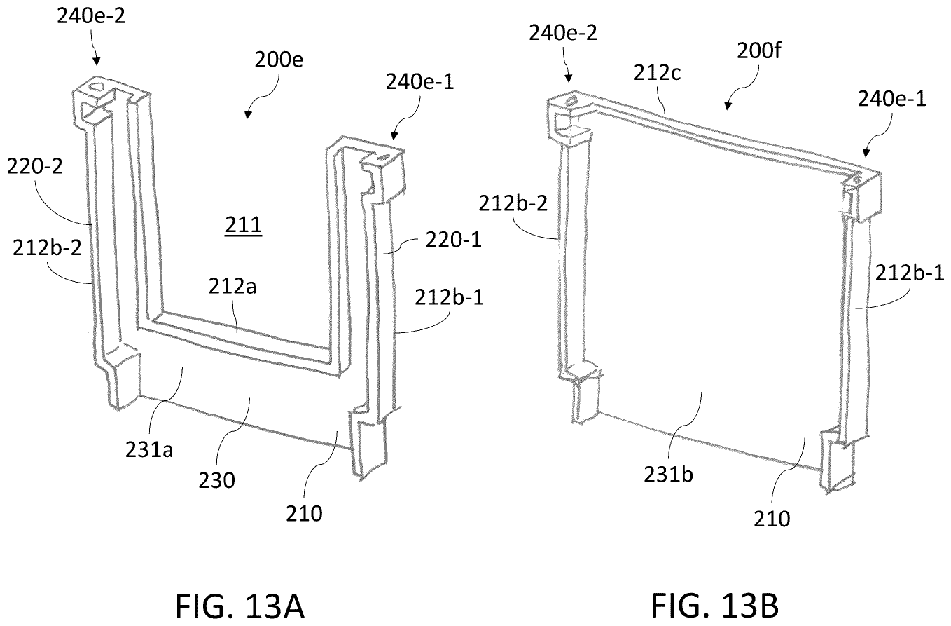

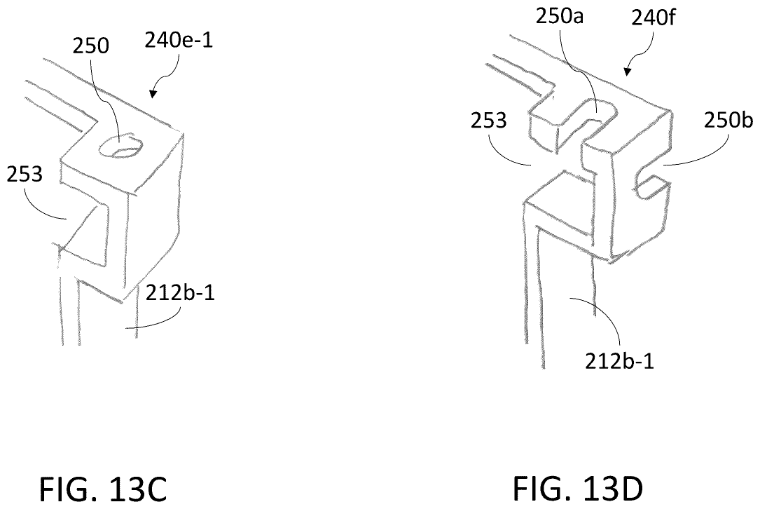

FIG. 13A shows another example carrier 200e with multiple ribs 212a, 212b-1, and 212b-2 to increase the mechanical stiffness of the carrier 200e. The carrier 200e includes a frame 210 with a base portion 230 and arms 220-1 and 220-2 that together define an aperture 211. As shown, the base portion 230 and the arms 220-1 and 220-2 are formed, in part, from a wall 231a that spans the depth of the carrier 200c. The rib 212a is formed along the interior edges of the wall 231 defining the aperture 211. The ribs 212b-1 and 212b-2 are formed along the top and bottom outer edges of the wall 231, respectively. The ribs 212a, 212b-1, and 212b-2 generally extend from the wall 231a towards the left or right sides of the case assembly. In some implementations, the ribs 212a, 212b-1, and 212b-2 extend perpendicularly from the wall 231a. The carrier 200e further includes a pair of module attachment mechanisms 240c-1 and 240e-2, which are formed, in part, by the ribs 212b-1 and 212b-2, as discussed in further detail below.

FIG. 13B shows another example carrier 200f, which is a variant of the carrier 200c without the aperture 211. As shown, the frame 210 includes a wall 231b with the ribs 212b-1 and 212b-2 disposed on the top and bottom edges of the frame 210. Additionally, the frame 210 includes a rib 212c formed along the front edge of the wall 231 and joined with the module attachment mechanisms 240e-1 and 240e-2. The carrier 200f is generally mounted to one side of the faceplate 21 of the module 20 and the wall 231b can be used, in part, as a barrier to separate the electronics of the module 20 from the electronics of a neighboring module 20. For example, the wall 231b can reduce the exposure of the electronics of the module 20 when the neighboring module 20 is removed. In another example. The wall 231b can reduce collisions between the respective electronics of the two modules 20 during assembly. In some implementations, a pair of carriers 200f can be mounted to opposing sides of the faceplate 21, thus providing barriers on the right and left sides of the module 20.

FIG. 13C shows a magnified view of the module attachment mechanism 240e-1 in the carriers 200c and 200f. As shown, the module attachment mechanism 240e-1 includes an integrally formed fastener opening 250 to facilitate mechanical coupling of the module 20 to the carrier via fastener. The module attachment mechanism 240e-1 also includes a channel 253 to align and support at least one circuit board in the electronics of the module 20. FIG. 13D shows a magnified view of another example module attachment mechanism 240f, which is a variant of the module attachment mechanisms 240c-1 and 240c-2 with a pair of slots 250a and 250b instead of the fastener opening 250. The slot 250a can be used to mechanically couple the module 20 to the carrier via a fastener similar to the fastener opening 250. Additionally, the slot 250a allows the fastener to be pre-installed onto the faceplate 21 of the module 20 such that the module 20 and the fastener can slide into place on the carrier during assembly.

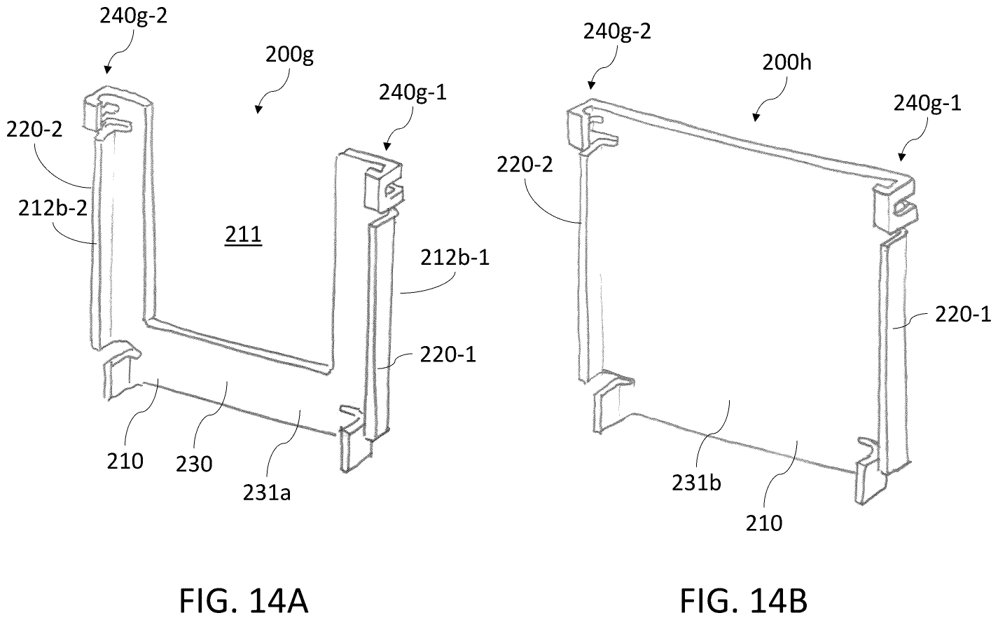

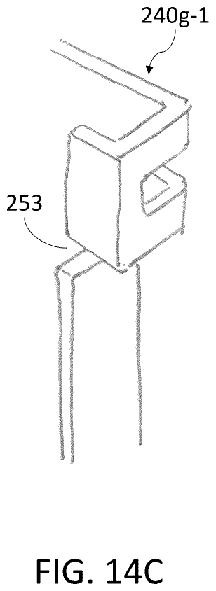

FIG. 14A shows another example carrier 200g designed for greater case of manufacture, for example, when using sheet forming processes (e.g., for sheet metal). As shown, the carrier 200g includes a frame 210 with a base portion 230 and arms 220-1 and 220-2 formed, in part, by a wall 231a. The base portion 230 and the arms 220-1 and 220-2 define an aperture 211. Additionally, the frame 210 includes ribs 212b-1 and 212b-2 and module attachment mechanisms 240g-1 and 240g-2, formed, in part, by bending a flat sheet about an axis aligned along the depth of the carrier 200g. FIG. 14B shows another example carrier 200h, which is a variant of the carrier 200g without the aperture 211. FIG. 14C shows the module attachment mechanism 240g-1 can be formed with a channel 253 to support and align a circuit board in the electronics of the module 20.

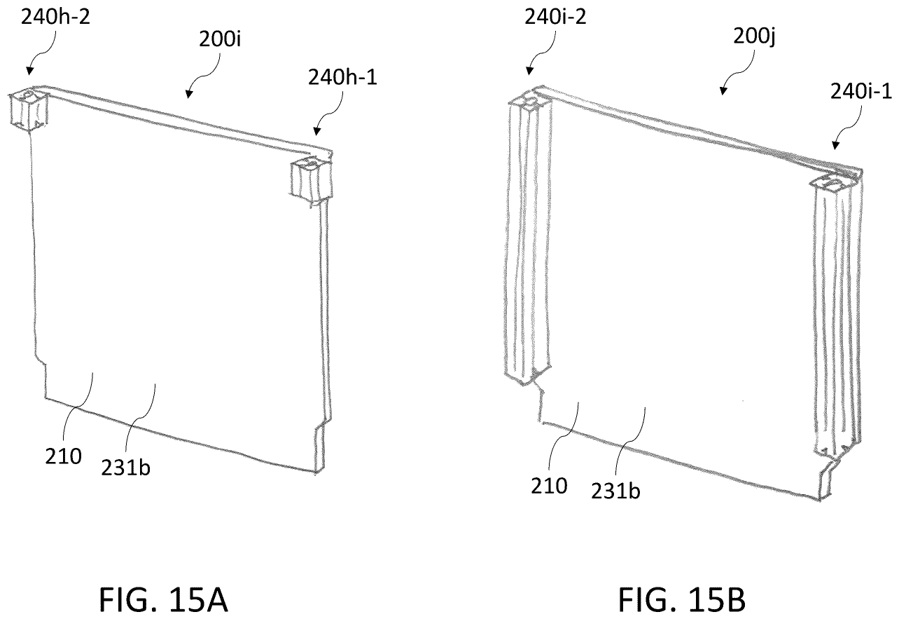

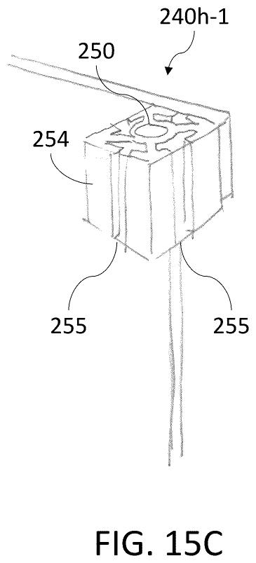

FIG. 15A shows another example carrier 200i with a pair of module attachment mechanisms 240h-1 and 240h-2 that each include a rail post 254. As shown, the carrier 200i includes a frame 210 with a wall 231b where the pair of module attachment mechanisms 240h-1 and 240h-2 are disposed on respective front corners of the wall 231b. The rail posts 254 of the attachment mechanisms 240h-1 and 240h-2 can be used to mechanically couple the carrier 200i to both the module 20 and the case. FIG. 15C shows each rail post 254 includes a fastener opening 250 to facilitate mechanical coupling of the module 20 to the carrier 200i via a fastener. The rail post 254 further includes one or more channels 255 that are each shaped to slide onto a corresponding rail (not shown) disposed on the case. Generally, the carrier 200i can be mechanically coupled to the case if only one of the channels 255 of each rail post 254 is engaged to a rail.

The depth of the rail post 254 can be chosen based, in part, on the desired alignment tolerances between the carrier 200i, the amount of material and associated costs for manufacture. For example, the rail posts 254 can have a relatively shallow depth, such as in the module attachment mechanisms 240h-1 and 240h-2 where the rail posts 254 are localized to the front side of the frame 210. In another example, FIG. 15B shows a carrier 200j with a pair of module attachment mechanisms 240i-1 and 240i-2 that each include a rail 254 spanning a substantial portion of the depth of the frame 210 to provide greater alignment tolerances between the carrier 200j and the case.

3.2 Examples of Carriers with Cap Assemblies

In some implementations, the module attachment mechanisms can further support a cap assembly to mount additional components near or on the faceplate 21 of the module 20 to provide additional feedback to the user and/or augment the operation of the module 20. The cap assembly can generally support multiple components including, but not limited to, an LED indicator and a capacitive touch sensor. For example, a capacitive touch sensor can provide an additional control input, for example, to turn the module 20 on or off, or to cycle between different clock signals provided by the case electronics. The capacitive touch sensor can be electrically coupled to the fastener 241 and thus, actuated by the user touching the fastener 241. In another example, an LED indicator can provide visual feedback to the user, such as emitting green light when the module 20 is turned on and ready to use, red light when the module 20 is turned off, and/or white light if the module 20 is receiving a clock signal.

The cap assembly can be electrically and communicatively coupled to the carrier electronics via, for example, an electrical cable. The electrical cable generally provides one or more electrical connections between the various components of the cap assembly and the carrier electronics including, but not limited to, an electrical power connection (e.g., +12V, −12V, and ground connections) to transmit electrical power, a control input connection to receive control signals (e.g., from the capacitive touch sensor), an output connection to transmit signals to the LED indicator to emit a particular wavelength of light. The various electronic components of the cap assembly can further include one or more circuit boards (not shown) mechanically coupled to the frame 210 of the carrier.

FIG. 16 shows an example module attachment mechanism 240j that includes a cap assembly 280a mounted to the faceplate 21 of a module 20. Specifically, the cap assembly 180a includes a cap housing 284 mechanically coupled to the faceplate 21 via a combination of a fastener 282a with a male portion inserted through an opening 289 on the cap housing 284 and a fastener opening 27 on the faceplate 21 and a cap 281a with a female portion that couples to the fastener 282a. The fastener 282a includes a fastener head 283a disposed within the cap housing 284 to clamp the cap housing 284 to the faceplate 21 when the cap 281a is tightened. The cap 281a is disposed on the front side of the faceplate 21 providing the user access to tighten or loosen the cap 281a via the tabs 288a-1 and 288a-2 when assembling or disassembling the module 20 from the carrier. It should be appreciated different caps can be used with the cap assembly 280a. For example, FIGS. 16A and 16B show another example cap 281b with a tab 288b to couple to the fastener 282a.

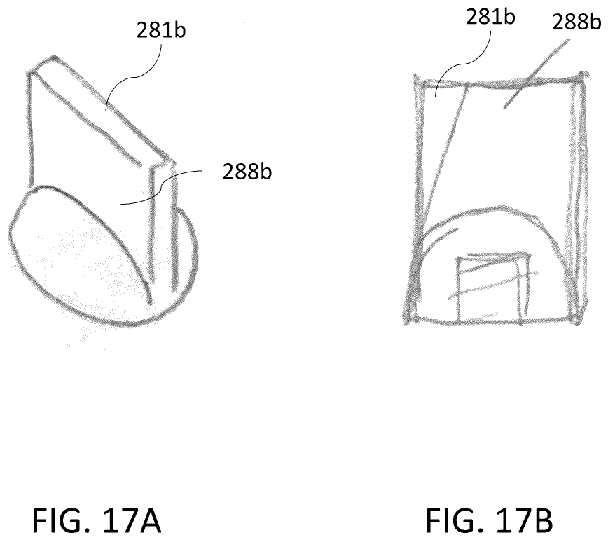

In some implementations, the fastener can include a washer that physically contacts the cap housing 284 instead of the fastener head, thus allowing cap housings 284 with different sized openings 289 to be used with standardized fasteners. For example, FIGS. 17A and 17B show a fastener 282b for a cap assembly 280a with a washer 287 that can provide a larger contact area between the fastener and the cap housing. As shown, the fastener 282b can be a threaded rod 283b with no fastener head. In another example, FIG. 18C shows a fastener 282c with a different-shaped fastener head 283c used together with the washer 287. In yet another example, FIG. 18D shows a fastener 282d with a fastener head 283d similar to the fastener 282c, but with a through hole 290 to transmit light (e.g., light emitted by the LED indicator 286).

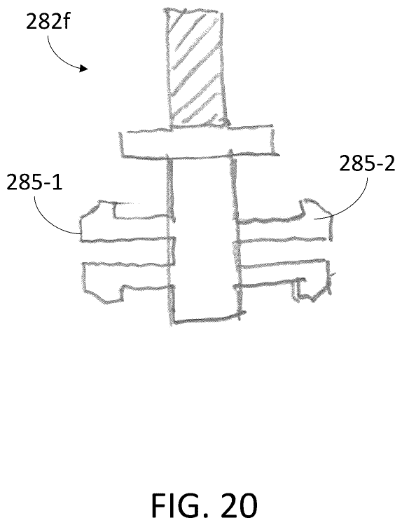

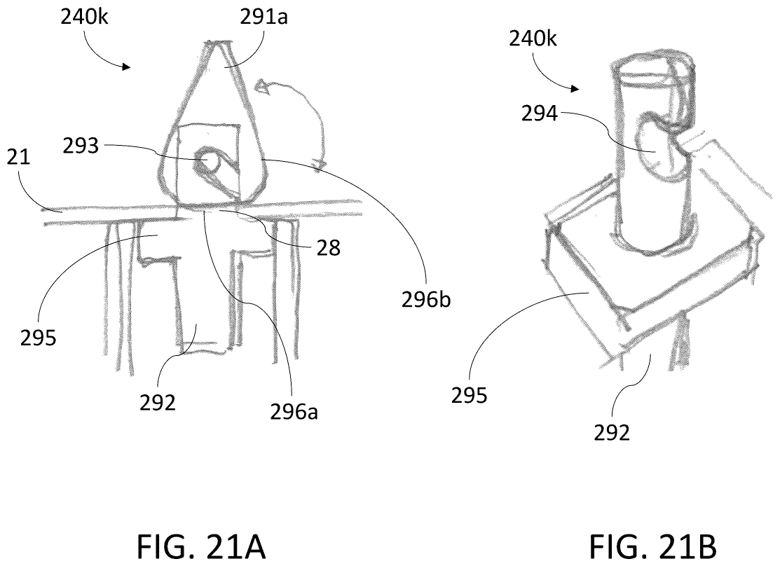

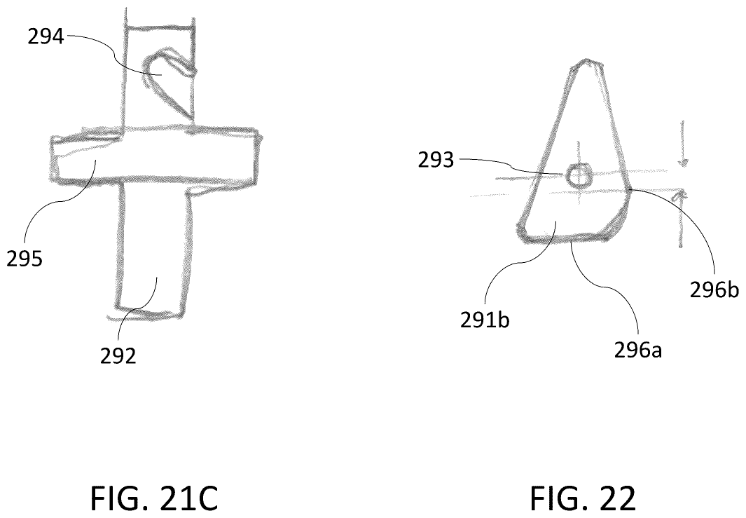

For simplicity, the frame 210 of the carrier is not shown in FIG. 16. However, it should be appreciated that the cap assembly 280a is generally coupled directly to the frame 210 of the carrier. For example, the cap housing 284 can include a snap-fit connector 285 to mechanically couple the cap housing 284 to an opening (not shown) on the frame as shown in FIG. 16. In another example, FIGS. 18A and 18B show a fastener 282e for the cap assembly with an integrally formed connector 285. The fastener 282e can thus be directly coupled to the frame of the carrier, effectively forming a mounting post to couple the module 20 to the carrier, with the cap housing being attached separately to the frame or the cap housing 284. FIG. 20 shows another example fastener 282f with multiple integrally formed snap-fit connectors 285-1 and 285-2, which can be used, for example, to mechanically couple the cap housing 284 via the snap-fit connector 285-1 to the frame of the carrier via the snap-fit connector 285-2. It should also be appreciated that, in some implementations, at least a portion of the cap assembly 280a can be integrally formed together with the frame 210 of the carrier, such as the cap housing 284.

As shown in FIG. 16, the cap housing 284 can support an LED indicator 286, which can be electrically and communicatively coupled to the carrier electronics (not shown) via an electrical cable (not shown). In some implementations, one or more of the cap housing 284, the fastener 282a, or the cap 281a can be formed from a transparent material (e.g., transparent polycarbonate) to facilitate the transmission of light emitted by the LED indicator 286. In some implementations, one or more of the cap housing 284, the fastener 282a, or the cap 281a can be formed from an opaque material with one or more apertures to allow light to pass through the cap assembly 280a (see, for example, the through hole 290 in the fastener 282d shown in FIG. 18D).

Each carrier can generally support one or more cap assemblies depending, in part, on the number of attachment points on the faceplate 21. In some implementations, each cap assembly can support a different component. For example, for a module 20 with two fastener openings 27, the carrier can support two cap assemblies 280a with one cap assembly 280a supporting the LED indicator 286 and another cap assembly 280a support a capacitive touch sensor (not shown).

During assembly, the user can place the faceplate 21 of the module 20 onto the cap assembly 280a such that the fastener 282a passes through the fastener opening 27 of the face plate 21. The cap 281a can then be coupled to the fastener 282a while the faceplate 21 rests on the housing 284. In this manner, the user can mechanically couple the module 20 to the carrier without having to hold several parts together while tightening the fastener.

It should also be appreciated the module attachment mechanisms described herein are not limited to the use of fasteners to couple the module 20 to the carrier. More generally, the module attachment mechanism can have various attachment mechanisms including, but not limited to, a snap-fit connector, a clamp, a twist lock, and a cam lock.

For example, FIGS. 20A-20C show another example module attachment mechanism 240k for the carrier that includes a cam lock 291a. As shown, the module attachment mechanism 240k includes a post 292 coupled directly to, for example, the frame of the carrier or the cap housing. The post 292 includes a mounting plate 295 to support the faceplate 21 of the module 20. A portion of the post 292 further extends past the front side of the faceplate 21 and includes a groove 294. The cam lock 291a includes a rod 293 disposed in the groove 294, which allows the cam lock 291a to rotate. In some implementations, the groove 294 is shaped to form a snap-fit connection with the rod 293 to retain the rod 293 within the groove 294.

The cam lock 291a is shaped as a tear drop with a base portion 296a that clamps the faceplate 21 to the carrier and a side portion 296b that allows the faceplate 21 to move freely between the cam lock 291a and the mounting plate 295. During assembly, the cam lock 291a is initially rotated such that the side portion 296b faces the mounting plate 295, thus allowing the faceplate 21 of the module 20 to be inserted between the cam lock 291a and the mounting plate 295. Thereafter, the cam lock 291a is rotated such that the base portion 296a physically contacts the faceplate 21, thus securely coupling the module 20 to the carrier. It should be appreciated the cam lock 291a is a non-limiting example and that other cam lock geometries can be used. For example, FIG. 22 shows another cam lock 291b shaped as a rounded right triangle with flat base portion 296a and a side portion 296b.

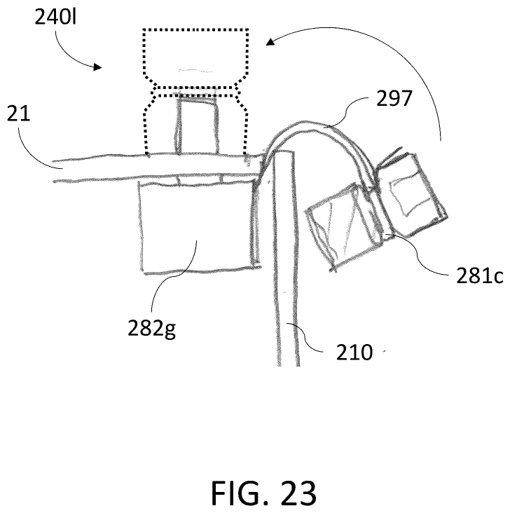

FIG. 23 shows yet another example module attachment mechanism 2401 that includes a fastener 282g and a cap 281c coupled to the carrier 210 via a tether 297. The tether 297 can reduce the likelihood of the cap 281c being lost during assembly and/or disassembly. As shown, the fastener 282g can be directly mounted to the frame 210 and include a male portion that protrudes through a corresponding fastener opening on the faceplate 21. The cap 281c can include a female portion that couples to the male portion of the fastener 282g.

### 4. Additional Examples of Alignment Mechanisms

It should be appreciated that the alignment mechanisms 400a and 400b described above are non-limiting examples and that additional inventive implementations of the alignment mechanism are contemplated herein. In the following, several additional example implementations of alignment mechanisms are disclosed. These alignment mechanisms can generally include one or more of the same features described above with respect to the alignment mechanisms 400a and 400b. For brevity, detailed discussions of these features are not repeated below.

It should also be appreciated that one or more features discussed below in connection with a particular alignment mechanism can be readily incorporated in other example alignment mechanisms according to the present disclosure provided that respective features are not mutually inconsistent. This includes, for example, features to partially constrain the carrier to a case, features to facilitate positional adjustment of the carrier with respect to the case, and features to engage and/or disengage the alignment mechanism.

The following alignment mechanisms can also be readily incorporated into the various example implementations of cases and carriers described above and used together with the various example implementations of modules, carrier electronics, and/or case electronics described herein. For example, each of the following alignment mechanisms can be integrated into any one of the carriers 200a-200j described above. In another example, each of the following alignment mechanisms can be incorporated into any one of the cases 300a-300c described above.

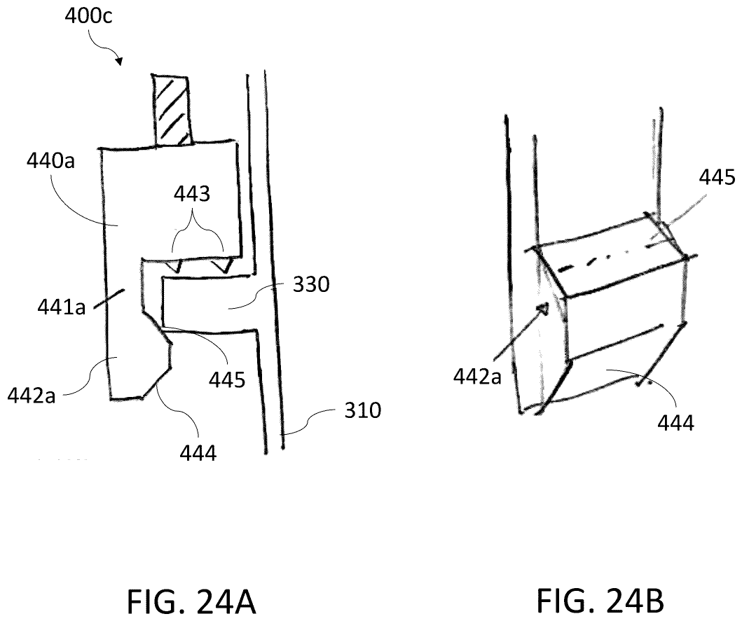

In some implementations, the alignment mechanism formed between the case and the carrier can include a snap-fit connection. For example, FIG. 24A shows an alignment mechanism 400c where the carrier includes a snap-fit connector 440a that mechanically couples to a ledge 330 on the frame 310 of the case. As shown, the snap-fit connector 440a includes an arm 441a with a connector end 442a that physically contacts a back portion of the ledge 330 when the carrier is inserted into the case, thus partially constraining the carrier to the case. The arm 441a mechanically bends when the snap-fit connector 440a is inserted past the ledge 330. The bending motion of the arm 441a can be facilitated, in part, by a tapered lead-in surface 444 on the connector end 442a. When the lead-in surface 444 physically contacts the ledge 330, the contact force applied to the arm connector end 442a produces a torque that causes the arm 441a to bend. The connector end 442a can similarly include a lead-out surface 445 that provides a tapered surface to bend the arm 441a when a sufficiently large force is applied to remove the carrier from the case.

In some implementations, the snap-fit connector 440a can mechanically constrain the carrier to the case along the depth direction while allowing the carrier to slidably move along the width of the case (i.e., along the right and left directions). This can be achieved, in part, by reducing the contact area and, thus, the frictional force between the snap-fit connector 440a and the ledge 330. For example, FIG. 24A shows the snap-fit connector 440a includes a pair of ribs 443 to contact a front portion of the ledge 330. The ribs 443 can each have a tapered shape to reduce the contact area with the ledge 330.

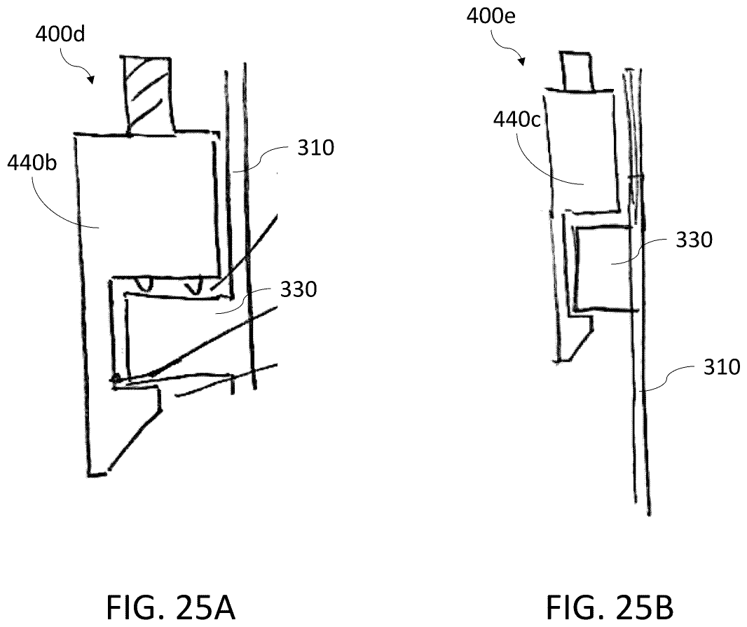

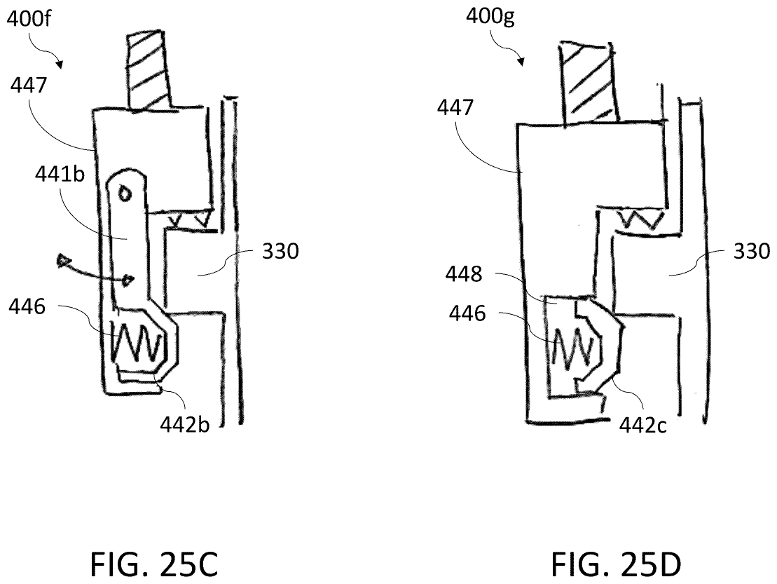

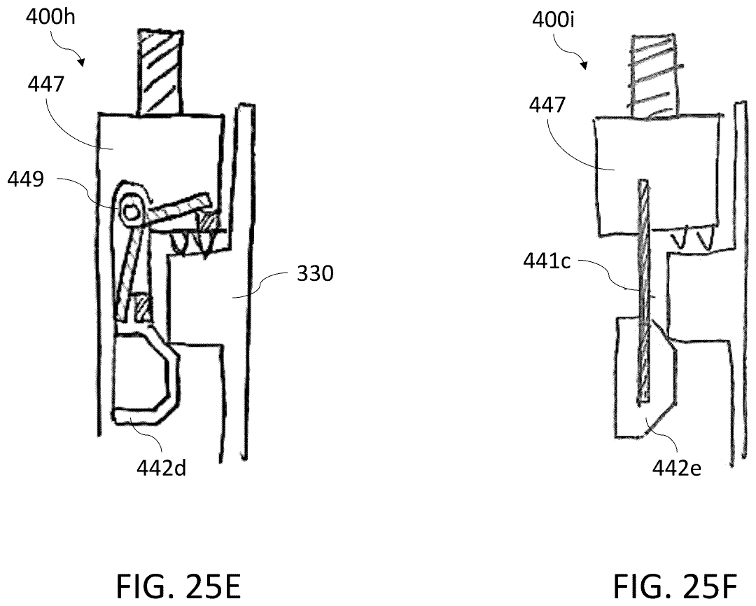

FIG. 25A shows another example alignment mechanism 400d where the carrier includes a snap-fit connector 440b, which is a variant of the snap-fit connector 440a without the lead-out surface 445. FIG. 25B shows another example alignment mechanism 400e where the carrier includes a snap-fit connector 440c, which is a variant of the snap-fit connector 440a without the lead-out surface 445 and the ribs 443.

It should be appreciated the locking mechanisms 400c-400e are non-limiting examples and that the carrier can be coupled to the ledge 330 of the case in similar ways using other mechanisms.

In another example, FIG. 25C shows an alignment mechanism 400f where the carrier includes an arm 441b rotatably coupled to a frame 447. The frame 447 can be coupled to the frame 210 or integrally formed together with the frame 210. The arm 441b can be rotated between a locked position where the connector end 442b of the arm 441b physically contacts a back portion of the ledge 330, thus partially constraining the carrier to the case, and an unlocked position where the connector end 442b is displaced from the ledge 330 such that the arm 441b can move past the ledge 330 when inserting or removing the carrier from the case. As shown, the alignment mechanism 400f can further include a spring 446 attached to the frame 447 and the connector end 442b. The spring can be biased to maintain the arm 441b in the locked position. Said in another way, the spring 446 can be under compression. When inserting or removing the carrier, the spring can be further compressed to allow the connector end 442b to move past the ledge 330.

FIG. 25D shows another alignment mechanism 400g where the carrier includes a frame 447 with a movable connector end 442c coupled to the frame 447 via a spring 446. As shown, the connector end 442c can be disposed within a channel 448 formed in the frame 447, which limits the connector end 442c to translational motion along a single axis. Similar to the alignment mechanism 400f, the connector end 442c can move between a locked and unlocked position and the spring 446 can be biased to maintain the connector end 442c in the locked position.

FIG. 25E shows another alignment mechanism 400h where the carrier includes a frame 447 with a connector end 442d coupled to the frame 447 via a torsion spring 449. The connector end 442d can generally be constrained to rotate and/or translate relative to the frame 447. For example, the connector end 442d can be disposed in a channel formed on the frame 447 similar to the channel 448, thus limiting the connector end 442d to translational motion along a single axis. The torsion spring 449 can be biased to apply a force to maintain the connector end 442d in a locked position.

FIG. 25F shows another alignment mechanism 400i where the carrier includes a frame 447 with a connector end 442e coupled to the frame 447 via a leaf spring 441c. The leaf spring 441c can be formed as a thin beam that can mechanically bend similar to the arm 441a. In some implementations, the leaf spring 441c can be composed of a different material than the connector end 442e and/or the frame 447.

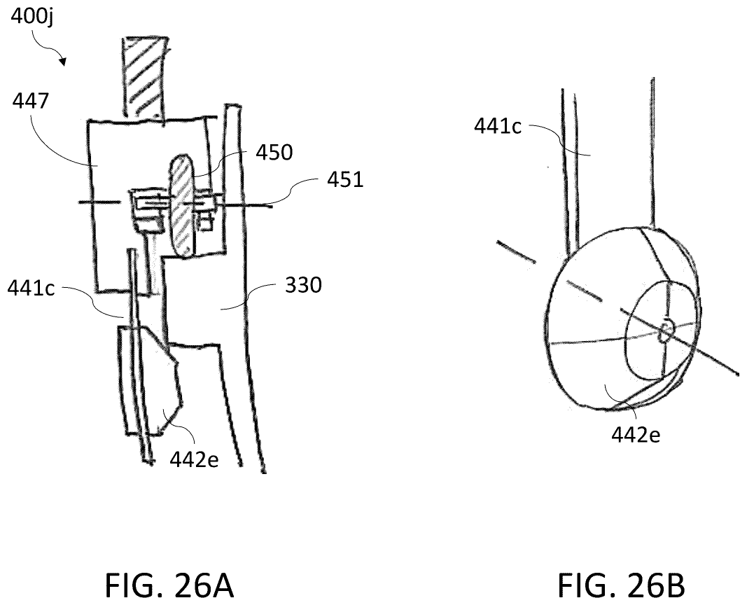

In yet another example, FIGS. 25A and 25B show an alignment mechanism 400j where the carrier includes a frame 447 supporting a wheel 450 that rotates about an axis 451. The wheel 450 can be used in place of the ribs 443 to facilitate adjustment of the carrier along the width of the case. As shown, the wheel 450 can physically contact a front portion of the ledge 330 on the case. The alignment mechanism 400j further includes the connector end 442e and the leaf spring 441c described above. FIG. 26B shows the connector end 442e has a round shape to reduce the contact area and, thus, the frictional force, between the connector end 442c and the ledge 330, which can otherwise impede the movement of the carrier along the case when the alignment mechanism 400j is engaged.

FIGS. 26A and 26B show another alignment mechanism 400k that includes a rotatable arm 441d with a connector end 442 actuated by a push button 455. As shown, the arm 441d, which is coupled to the carrier, can rotate about a pivot point 452 such that the end 442f moves between a locked and unlocked position as described above. The push button 455 mechanically supported by a mounting plate 454. The mounting plate 454 is rigidly coupled to the carrier or the case while the push button 455 can be slidably coupled to the mounting plate 454. The push button 455 further includes a rod 456 that physically contacts a lever 453 on the arm 441d. When the push button 455 is pressed, the rod 456 is displaced causing the arm 441d to rotate and disengage from the rail of the case. In this manner, the carrier can be removed from the case by pressing a button rather exerting a force to pull the carrier out of the case.

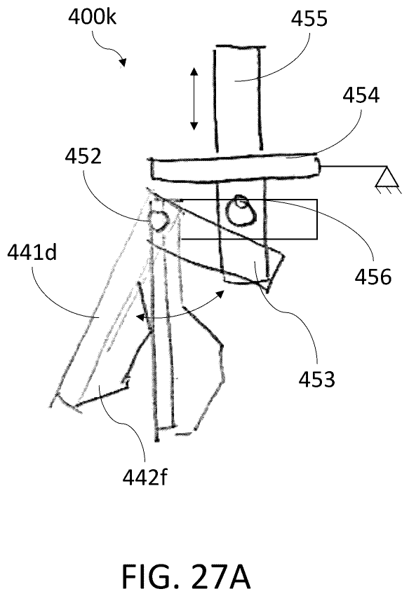

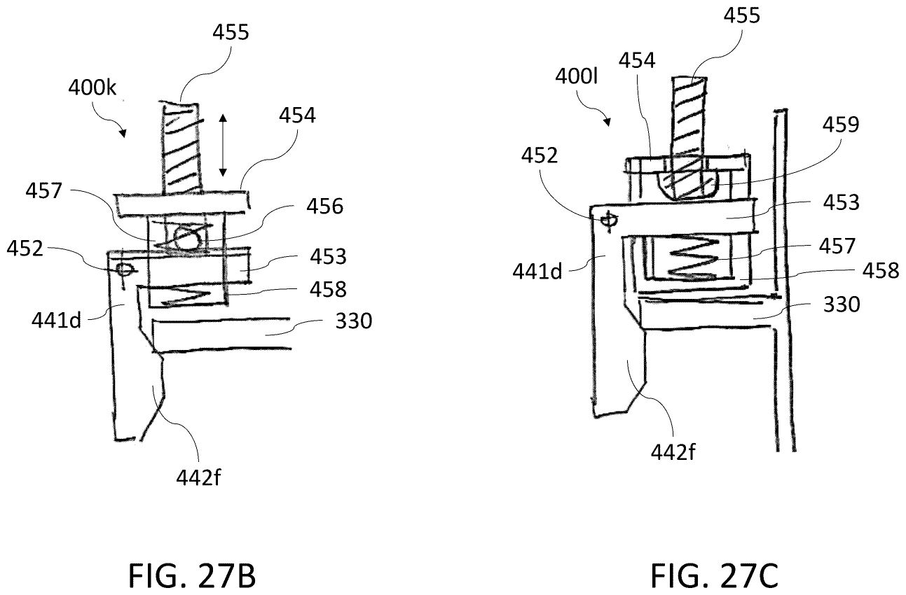

As shown in FIG. 27B, the alignment mechanism 400k further includes a housing 458 directly coupled to the mounting plate 454 to contain a spring 457. The spring 457 is attached to the mounting plate 454 and the lever 453 of the arm 441d such that the end 442f is maintained in the locked position. This can be accomplished, in part, by placing the spring 457 on the front side of the lever 453 and configuring the spring 457 to be in tension. It should be appreciated other configurations of the spring and push button can be used to actuate the arm 441d. For example, FIG. 27C shows another alignment mechanism 400l where the spring 457 is placed on the back side of the lever 453 and configured to be in compression. As shown, the push button 455 includes a rounded head 459 to contact and displace the arm 441d.

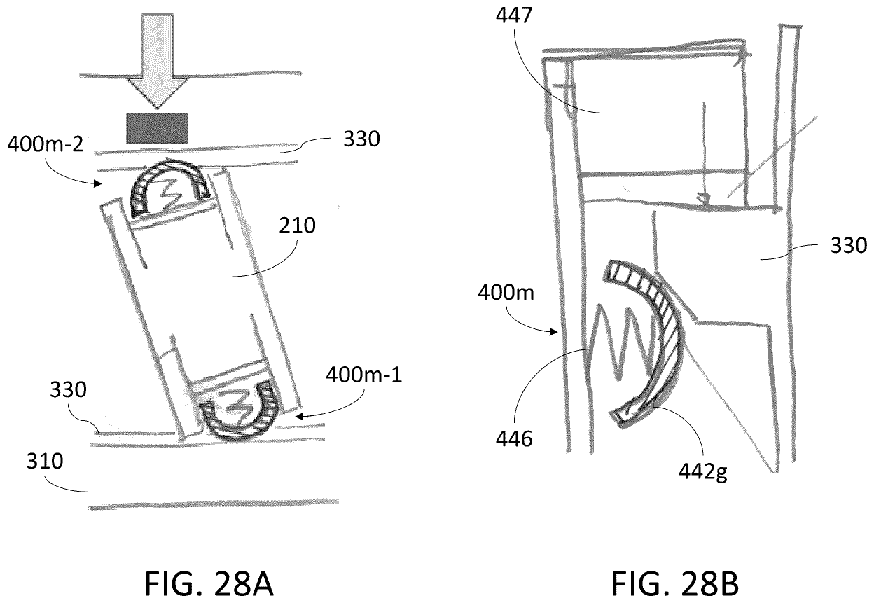

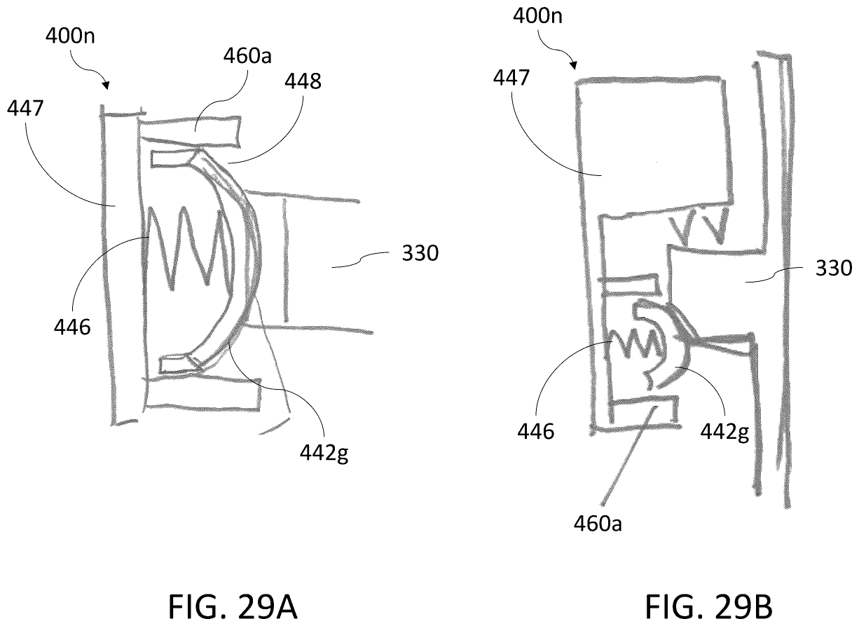

FIGS. 27A and 27B show a frame 210 of a carrier with a pair of alignment mechanisms 400m-1 and 400m-2 (also referred to herein as a “alignment mechanism 400m”) being inserted into a frame 310 of a case with rails 439 disposed on opposing sides for engagement. As shown in FIG. 28A, the carrier can be inserted at an angle into the case and subsequently rotated to the orientation shown in FIG. 10A for installation. FIG. 28B shows the alignment mechanism 400m includes a frame 447 with a movable end 442g shaped as a dome and coupled to the frame 447 via a spring 446. The dome-shaped end 442g reduces the contact area with the ledge 330 similar to the tapered conical-shaped end 442e in the alignment mechanism 400j.

FIGS. 28A and 28B show another example alignment mechanism 400n, which is a variant of the alignment mechanism 400m where the frame 447 includes a wall 460a that defines the channel 448 to guide the movement of the end 442g. For example, the wall 460a constrains the end 442g to move translationally along a single axis.

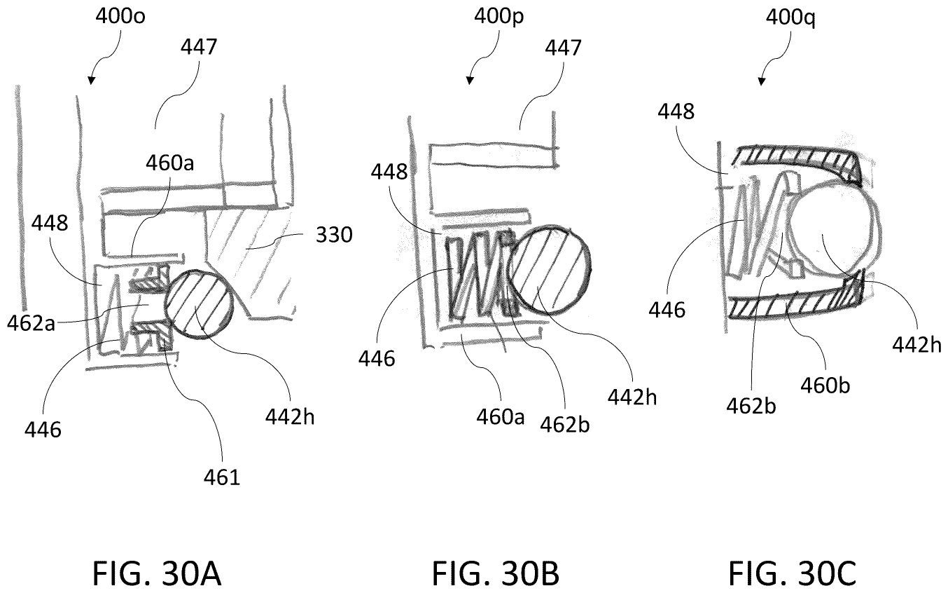

FIG. 30A shows another example alignment mechanism 4000 where a carrier includes an end 442h shaped as a sphere or a ball guided by a plunger 461 to engage the ledge 330 of a case. As shown, the carrier once again includes a frame 447 with a wall 460a defining a channel 448 to contain a spring 446, the plunger 461, and at least a portion of the end 442h. Thus, the plunger 461 and the end 442h are constrained to move translationally along a single axis. A portion of the end 442h is nested within a receptacle 462a on the plunger 461. The plunger 461, in turn, is attached to the spring 446. In some implementations, the end 442h can be adhered to the plunger 461 to prevent the loss of the end 442h particularly if it's pushed out of the channel 448 via the spring 446.

FIG. 30B shows another example alignment mechanism 400p where a carrier includes the frame 447, the end 442h, and a spring 446 that incorporates a receptacle 462b to constrain and guide the end 442h as it moves between a locked position and an unlocked position. Similar to the alignment mechanism 4000, the frame 447 includes the wall 460a defining the channel 448. The end 442h can be adhered to the spring 446.

FIG. 30C shows another example alignment mechanism 400q where a carrier includes a frame (not shown) with a wall 460b that has a tapered geometry. The alignment mechanism 400q once again includes the spring 446 with the receptacle 462b, which is disposed in the channel 448 defined by the wall 460b. As shown, the wall 460b tapers inwards towards the rail (not shown) of the case, thus limiting the displacement of the end 442h. Said in another way, the wall 460b prevents the end 442h from falling out from the channel 448.

### 5. Additional Examples of Locking Mechanisms

It should be appreciated the locking mechanisms 500a-500c described above are non-limiting examples and that additional inventive implementations of the locking mechanism are contemplated herein. In the following, several additional example implementations of locking mechanisms are disclosed. These locking mechanisms can generally include one or more of the same features described above with respect to the locking mechanisms 500a-500c. For brevity, detailed discussions of these features are not repeated below.

It should also be appreciated that one or more features discussed below in connection with a particular locking mechanism can be readily incorporated in other example locking mechanisms according to the present disclosure provided that respective features are not mutually inconsistent. This includes, for example, features to fully constrain the carrier to a case and features to engage and/or disengage the locking mechanism.

The following locking mechanisms can also be readily incorporated into the various example implementations of cases and carriers described above and used together with the various example implementations of modules, carrier electronics, and/or case electronics described herein. For example, each of the following locking mechanisms can be integrated into any one of the carriers 200a-200j described above. In another example, each of the following locking mechanisms can be incorporated into any one of the cases 300a-300c described above.

### 5.1 Side-Mounted Locking Mechanisms

FIGS. 30A-30C show another example locking mechanism 500d with a twist lock 540a to securely couple a carrier to the side of a case. As shown, the twist lock 540a includes an arm 541 that is rotatably coupled to the frame 210 of the carrier via a tab 546 protruding from the frame 210. The tab 546 includes an opening (not shown) through which the arm 541 is disposed and supported. The opening of the tab 546 defines a rotation axis 545 about which the arm 541 rotates. In some implementations, the arm 541 is coupled to the opening of the tab 546 via a bearing (e.g., a plain bearing, a ball bearing) to facilitate rotational movement of the arm 541 relative to the frame 210 while constraining axial motion through the opening.

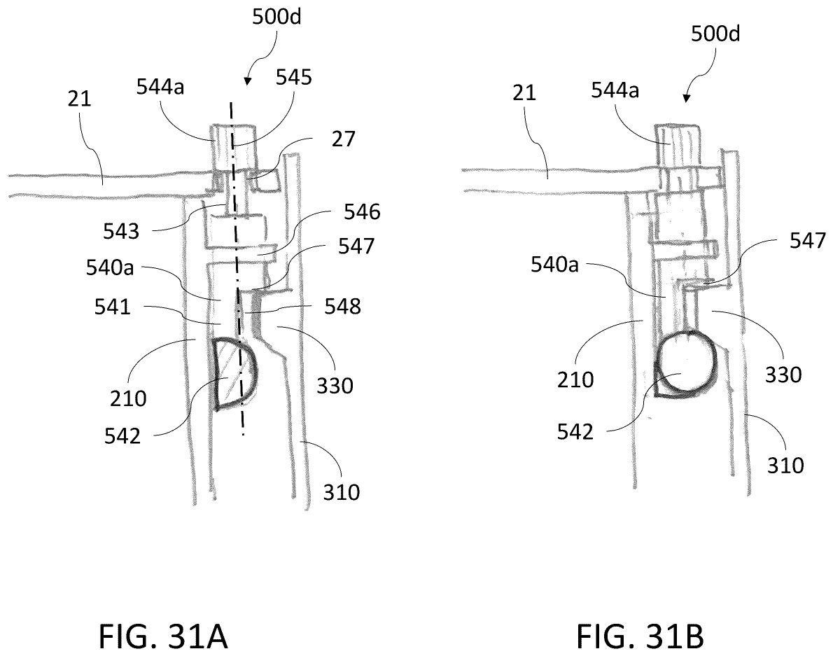

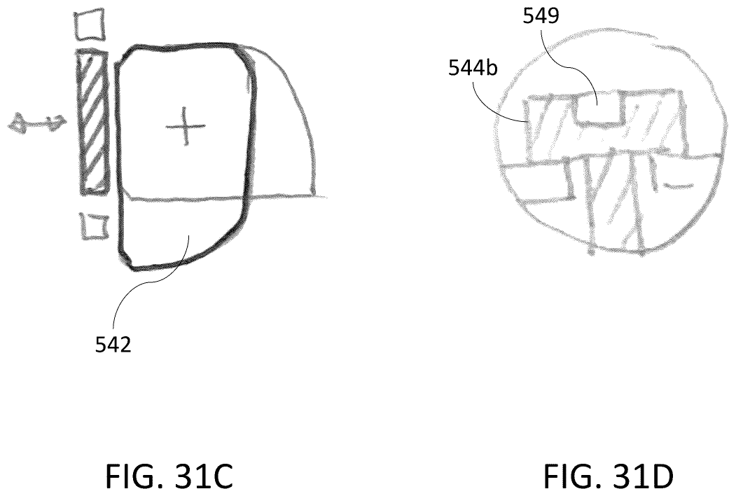

The arm 541 includes an overhang portion 547 and a connector end 542 that together define a recess 548 shaped to mechanically engage a ledge 330 on a frame 310 of the case. The arm 541 also includes a knob 544a. As shown, the knob 544a can be partially disposed on the front side of the faceplate 21 of the module so that the user has direct access to rotate the twist lock 540a. This can be accomplished, in part, by the knob 544a protruding through one of the fastener openings 27 on the faceplate 21 of the module. The other fastener openings 27 on the faceplate 21 can be used to mechanically couple the module to the carrier. For example, FIG. 31A shows the knob 544a includes a shank 543 that passes through the fastener opening 27 and couples to the arm 541. In some implementations, the knob 544a is a thumb screw that is fastened to one end of the arm 541 via a fastener opening (not shown) on the arm 541. In some implementations, the knob 544a can further include features to facilitate rotation via a tool (e.g., a screwdriver). For example, FIG. 31D shows another example knob 544b with a screw drive 549 to receive, for example, the end of a flathead screwdriver.

When inserting the carrier into the case, the arm 541 is initially rotated to an unlocked position that allows the connector end 542 to move past the ledge 330 until the overhang portion 547 physically contacts the front side of the ledge 330, as shown in FIG. 31A. In other words, the overhang portion 547 serves as a mechanical stop to mechanically support the carrier and limit the extent the carrier can be inserted into the case. Once the carrier is in the case, the twist lock 540a is rotated to a locked position via the knob 544a such that the connector end 542 is at least partially disposed on or behind the back side of the ledge 330 and the ledge 330 is at least partially disposed within the recess 548 of the arm 541, thus preventing removal of the carrier from the case. To release and remove the carrier, the twist lock 540a can be rotated back to the unlocked position.

In some implementations, the overhang portion 547 and the connector end 542 can clamp onto the ledge 330 to reduce or, in some instances, mitigate unwanted play between the carrier and the case. This can be accomplished, in part, by shaping and dimensioning the arm 541 such that the connector end 542 and the overhang portion 547 physically contact opposing sides of the ledge 330 (e.g., the front and back sides). In some implementations, the recess 548 formed between the overhang portion 547 and the connector end 542 can be slightly smaller than the ledge 330 such that an interference fit is formed when the twist lock 540a is rotated to the locked position. For example, FIGS. 30A and 30B show the back side of the ledge 330 can be sloped to ensure at least a portion of the ledge 330 makes physical contact with the connector 542 as the twist lock 540a is rotated.

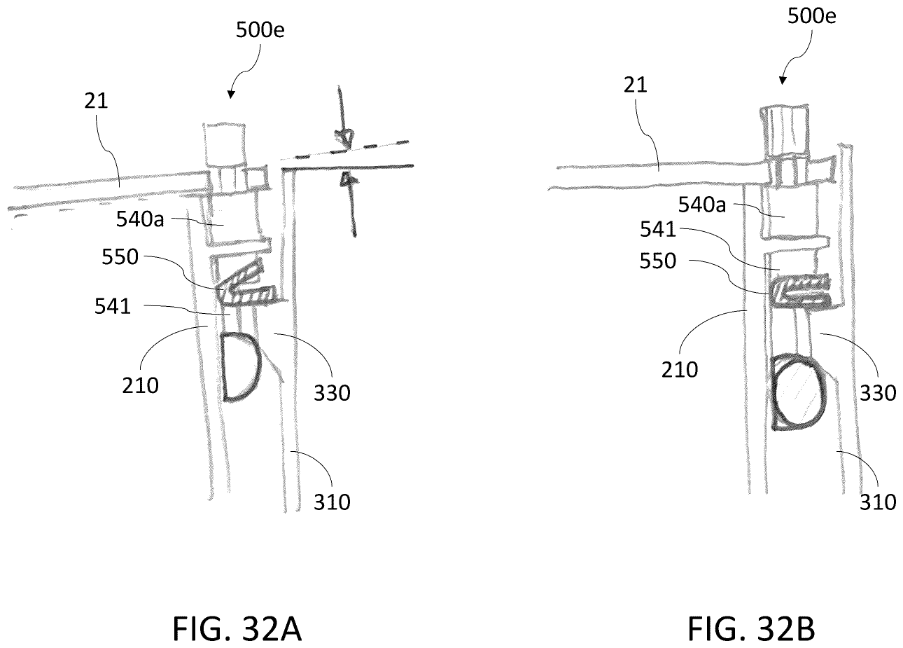

Additionally, a spring can be added to further generate a clamping force between the arm 541 and the ledge 330. For example, FIGS. 31A and 31B show another example locking mechanism 500e that includes the twist lock 540a in the locking mechanism 500d with the addition of a spring 550 disposed around the arm 541. The spring 550 can be, for example, a spring washer. In this example, the spring 550 physically contacts the front side of the ledge 330 rather than the overhang portion 547. As shown, the spring 550 is compressed when the twist lock 540a is rotated from its unlocked position in FIG. 32A to its locked position in FIG. 32B. The compression of the spring 550 generates a spring force that maintains physical contact between the ledge 330 of the case and the spring 550 and the connector end 542 of the twist lock 540a.

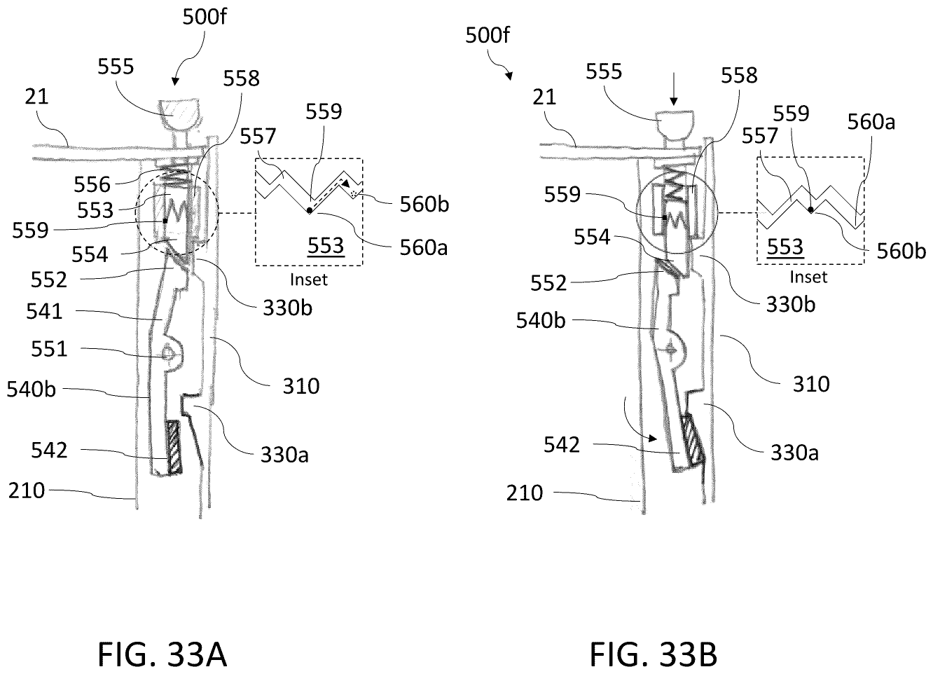

FIGS. 32A and 32B show another example locking mechanism 500f with a push toggle mechanism 540b. As shown, the push toggle mechanism 540b includes an arm 541 rotatably coupled to a frame 210 of a carrier via a pivot joint 551. The arm 541 includes a connector end 542 that engages a back side of a ledge 330a on a frame 310 of the carrier when the push toggle mechanism 540b is in a locked position (see FIG. 33B). The arm 541 further includes an end 552 that mechanically contacts an actuator 553. The actuator 553 is slidably and rotatably coupled to an actuator housing 558 rigidly coupled to the frame 210 of the carrier. The actuator 553 includes an end 554 that physically contacts the arm 541 thereby causing the arm 541 to rotate between an unlocked position (FIG. 33A) and a locked position (FIG. 33B). The actuator 553 further includes a push button 555 that protrudes from the faceplate 21 of the module. In some implementations, the actuator housing 558 also serves as an overhang portion that contacts a ledge 330b on the frame 310, to align and position the carrier before the locking mechanism 500f is engaged.

The actuator 553 is configured to move between and remain in two positions corresponding to the unlocked and locked positions of the arm 541 by pressing the push button 555. This is accomplished, in part, by the actuator 553 being mechanically constrained to slidably move and rotate along a path defined by a channel 557 formed on the exterior of the actuator 553. As shown, the actuator housing 558 includes a post 559 disposed in the channel 557. The actuator 553 is further coupled to a spring 556 that imparts a spring force to maintain the post 559 at either of corners 560a or 560b of the channel 557. When the push button 555 is pressed with a force having a magnitude greater than the spring force, the actuator 553 is slidably displaced. As the actuator 553 slidably moves relative to the actuator housing 558, the resulting contact between the post 559 and the walls of the channel 557 causes the actuator 553 to rotate and the post 559 to move along the channel 557. The actuator 553 can be sufficiently displaced such that the post 559 is moved from the corner 560a to the corner 560b or vice-versa. Once the push button 555 is released, the spring 556 maintains the post 559 at the new corner along the channel 557.

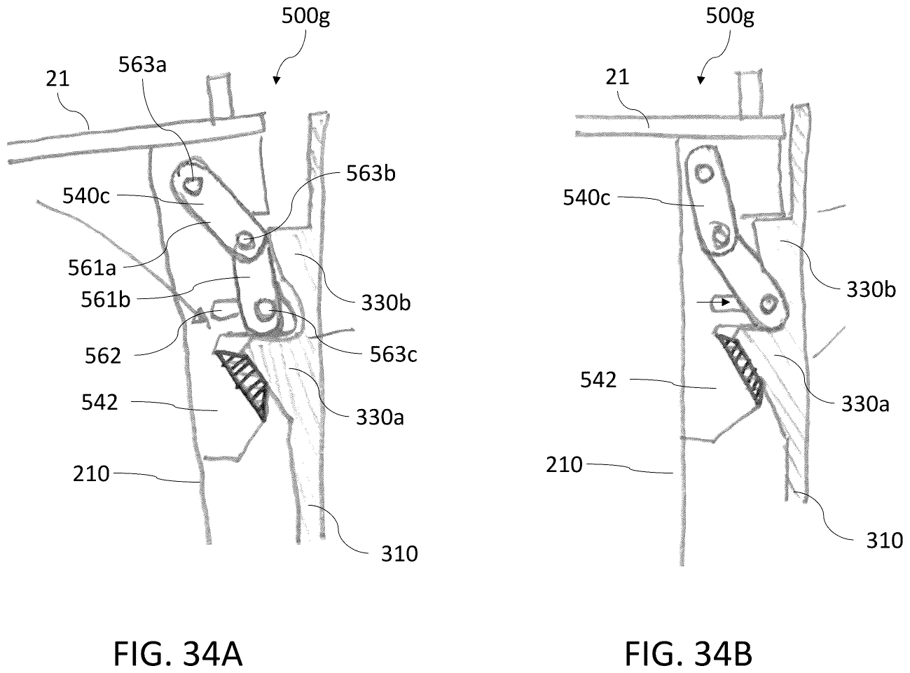

FIGS. 33A and 33B show another example locking mechanism 500g that includes a linkage mechanism 540c. Once again, the frame 210 includes a connector end 542 to engage a back side of a ledge 330a on a frame 310 of the case. The linkage mechanism 540c includes link members 561a and 561b. The link member 561a is rotatably coupled to the frame 210 via a pivot joint 563a and rotatably coupled to the link member 561b via a pivot joint 563b. The link member 561b is rotatably and slidably coupled to a slot 562 formed on the frame 210 via a pivot joint 563c. In this implementation, the carrier is inserted into the case at an angle (FIG. 34A) and subsequently rotated such that the linkage mechanism 540c physically contacts the ledge 330b of the frame 310, displacing the linkage mechanism 540c with the link member 561b moving along the slot 562 towards the case 310. Once a portion of the link member 561b is disposed behind the back side of the ledge 330b (see FIG. 34B), the locking mechanism 500g is engaged.

FIGS. 34A and 34B show another example locking mechanism 500h that includes a linkage mechanism 540d. As shown, the carrier 210 includes a connector end 542 disposed on an opposite side from the linkage mechanism 540d. Similar to the locking mechanism 500g, the carrier is inserted at an angle into the case such that the connector end 542 first engages the ledge 330b-1 of the frame 310. The frame 210 is then rotated and pushed downwards, displacing the linkage mechanism 540d such that the linkage mechanism 540d and a portion of the frame 210 are wedged between the ledges 330a and 330b-2, thus securing the carrier in place.

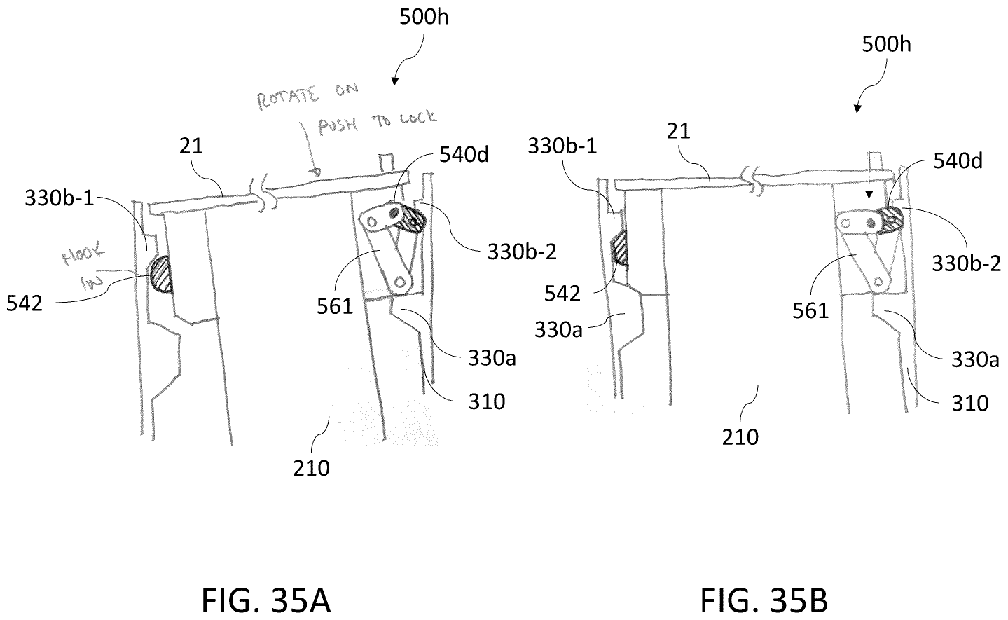

FIGS. 35A-35C show another example locking mechanism 500i that includes a rotatable peg 540c. The rotatable peg 540e is mounted to a frame of the carrier (not shown) and includes an arm 541 with a knob 544a that protrudes from the front side of the faceplate 21 of the module. The arm 541 is configured to rotate with respect to the faceplate 21 and the carrier. The arm 541 further includes a crescent-shaped end 564 and a tooth 565 configured to be inserted into a mounting post 566 coupled to the frame of the case (not shown). The mounting post 566 defines a channel 567 shaped to receive the end 564. The mounting post 566 further includes a recess 568 formed within the channel 567. When the arm 541 is inserted into the channel 567, the arm 541 can then be rotated by the knob 544a until the tooth 565 is disposed within the recess 568, thus locking the carrier to the case.

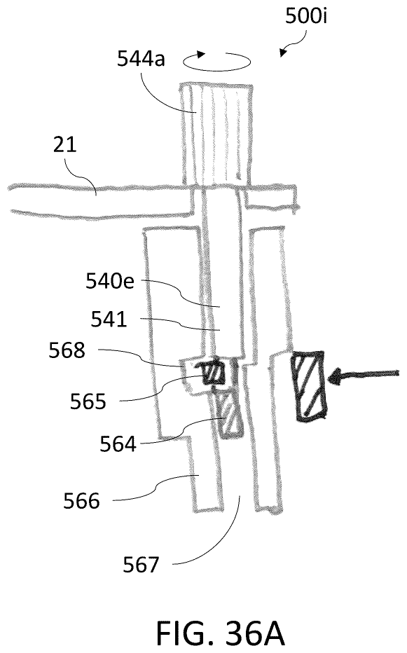

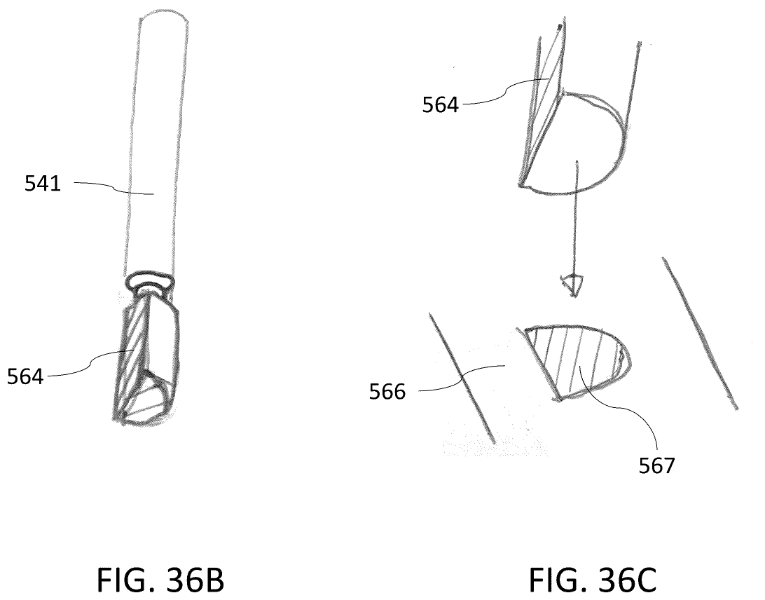

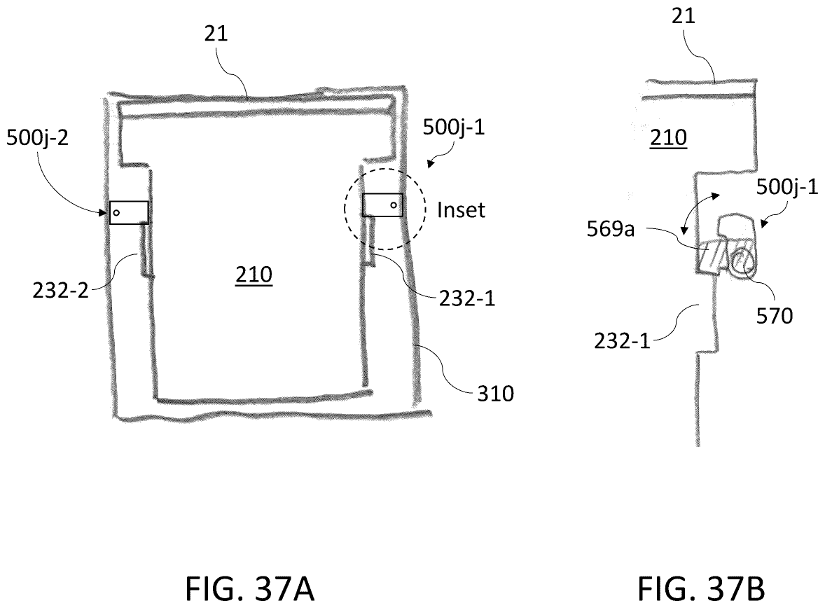

FIGS. 36A and 36B show another example carrier with a pair of locking mechanisms 500j-1 and 500j-2. As shown, a frame 210 of the carrier is disposed within a frame 310 of the case and by the pair of locking mechanisms, which are disposed on opposing sides of the frame 210. In this implementation, the frame 210 includes ledges 232-1 and 232-2. The locking mechanisms 500j-1 and 500j-2 each include a connector end 569a rotatably coupled to the side of the frame 310 via a pivot joint 570. When the carrier is inserted into the case, the connector ends 569a in each of the locking mechanisms 500j-1 and 500j-2 are rotated to physically contact a front side of the ledges 232-1 and 232-2, respectively, thus securely coupling the carrier to the case. The connector end 569a can be actuated by a knob (not shown) mounted to the pivot joint 570 and disposed on the frame 310.

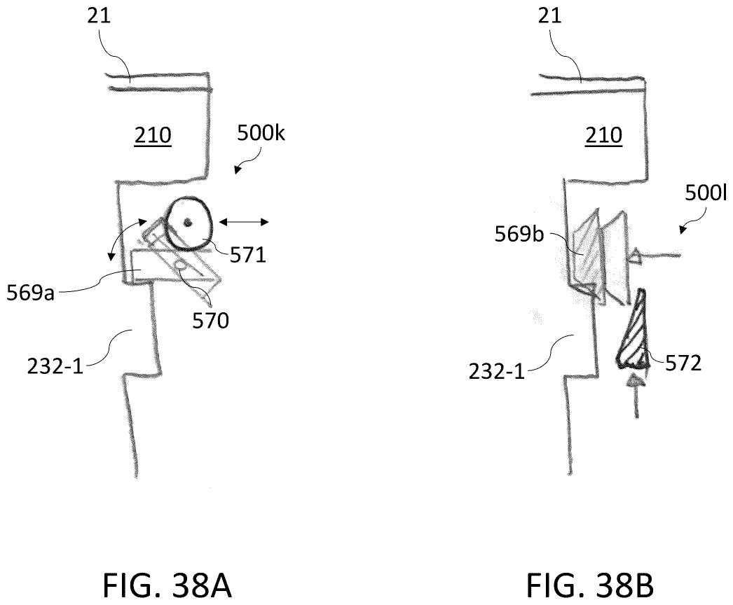

Alternatively, the connector end 569a can be actuated by a lever or a switch. For example, FIG. 38A shows another example locking mechanism 500k that includes a switch 571 slidably coupled to the case. As shown the switch 571 can physically contact the connector end 569a, causing the connector end 569a to rotate until contact is made with the ledge 232-1. In some implementations, the connector end 569a can be coupled to a spring (not shown) that maintains the connector end 569a in the locked position. Thus, the locking mechanism 500k is only disengaged when the switch 571 is actuated (e.g., moved to the right in FIG. 38A).

FIG. 38B shows another example locking mechanism 500l that includes a switch 572 translationally coupled to the case to actuate a connector end 569b. As shown, the switch 572 can be slidably coupled to the case and shaped as a wedge. When the carrier is inserted into the case, the switch 572 can be slidably displaced resulting in physical contact between the switch 572 and the connector end 569b. As the switch 572 is further displaced, the connector end 569b is displaced until physical contact is made with the ledge 232-1 of the carrier, thus securing the carrier to the case. In some implementations, one or both of the connector end 569b and the switch 572 can be coupled to one or more springs that maintains the locking mechanism 500l in the locked position. Thus, the locking mechanism 500l is only disengaged when the switch 572 is actuated (e.g., moved downwards in FIG. 38B).

Following below are additional examples of side-mounted locking mechanisms that can be implemented in the modular signal processing systems disclosed herein.

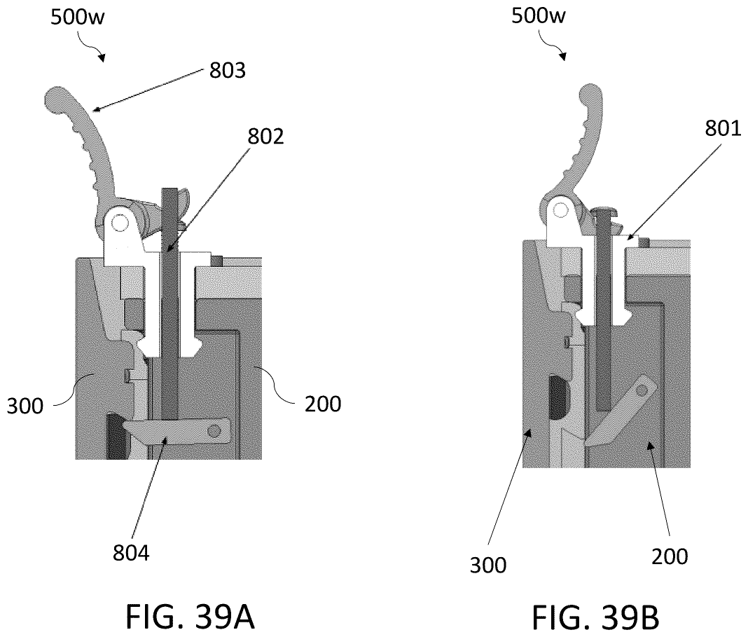

In some implementations, the locking mechanism may include a plunger latch mechanism. For example, FIGS. 39A and 39B show a locking mechanism 500w with a plunger 802 coupled to a handle 803 and a latch 804. To disengage the locking mechanism 500w, the handle 803 is pushed such that the plunger 802 moves downwards through the support clamp 801. As shown, the plunger 802 can be supported by a support clamp 801, which snap fit connects to the frame 310 of the carrier 200. Accordingly, the locking mechanism 500w can provide simpler, easier mechanical assembly. Additionally, the locking mechanism 500w can provide a relatively large range of motion. In some implementations, a spring can be included along the plunger 802 and/or the latch 804 to provide a return spring force that keeps the latch 804 in an engaged (e.g., locked) position. The handle 803 can have sufficient rotational motion such that carrier 200 with the locking mechanism 500w can temporarily exceed a 3U height.

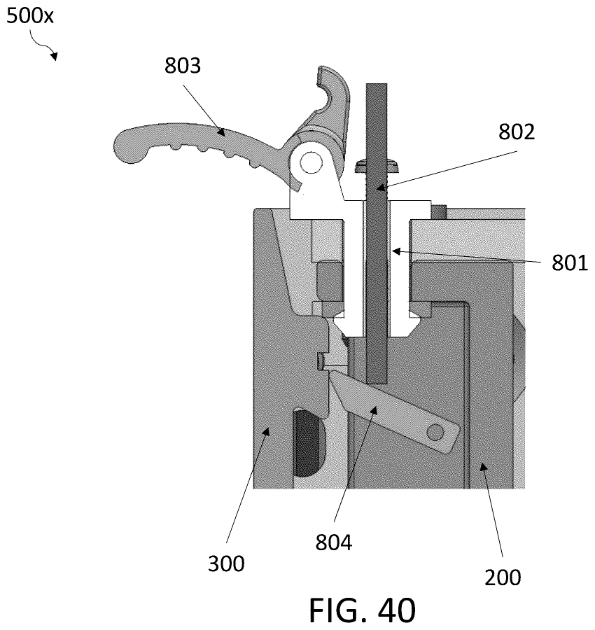

FIG. 40 shows another example locking mechanism 500x with a plunger latch mechanism that operates as a push lock. As shown, the latch 804 can be oriented to tip upwards when inserting the carrier 200 into the case 300. In this example, the carrier 200 can be locked to the case 300 by pushing the carrier 200 into the case 300 instead of toggling or holding the handle 803 in a disengaged (e.g., unlocked) position as in the locking mechanism 500w. Again, the orientation and motion of the latch 804 can result in rotational motion of the handle 803 that exceeds, at least temporarily, the 3U height. Additionally, linkages can be coupled to the plunger 802, the handle 803, and/or the latch 804. In some implementations, the additional linkages can alter the motion of the handle 803 such that the handle 803 does not exceed the 3U height. Furthermore, a secondary latch can be used instead of the handle 803 shown in FIG. 40.

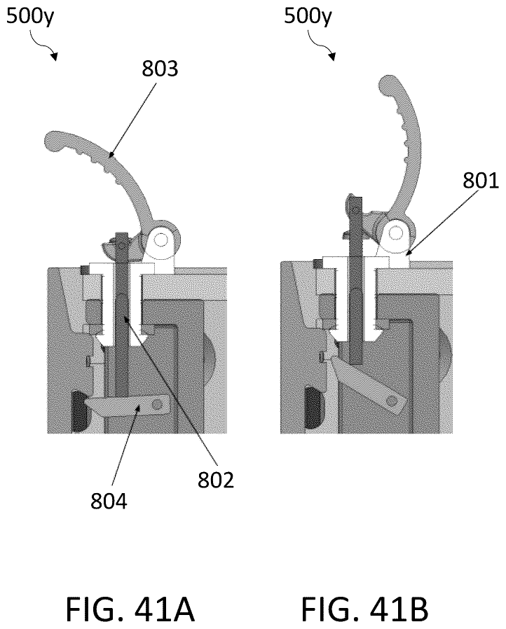

FIGS. 41A and 41B show another example locking mechanism 500y with a plunger latch mechanism that includes a puller mechanism. As shown, the locking mechanism 500y is disengaged by pulling the handle 803 upwards such that the plunger 802 moves upwards through the support clamp 801. Compared to the locking mechanisms 500w and 500x, the locking mechanism 500y can have a lower range of motion and the retention force can be higher. However, assembly can require additional steps to connect the plunger 802 to the latch 804. For this example, the locking mechanism 500y can be unlocked by moving the carrier 200 in a downwards motion, e.g., by pushing the carrier 200 downwards into the case 300. In some implementations, the force applied to unlock the locking mechanism 500y can be varied by modifying the shape of the tip of the latch 804 (e.g., the radius of curvature of a rounded end). Again, a spring can be included along the plunger 802 and/or the latch 804 to provide a retention force to maintain the locking mechanism 500y in an engaged state.

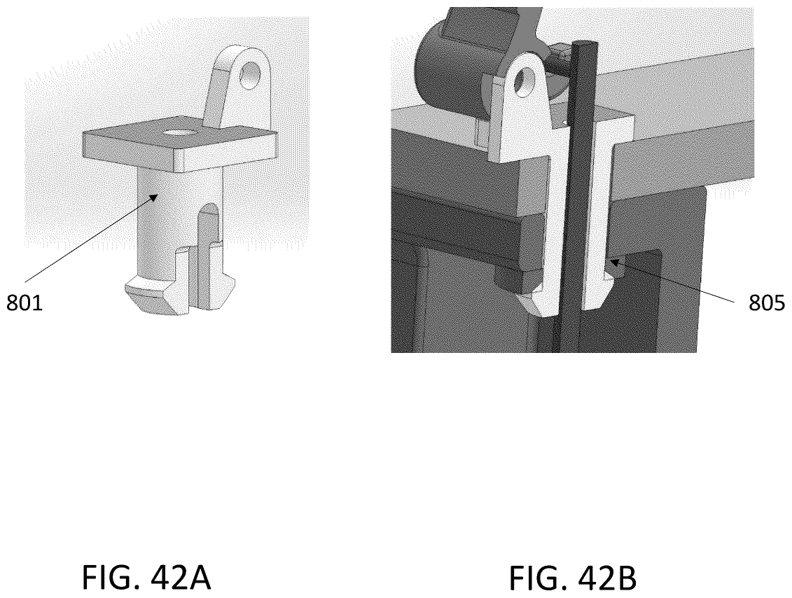

FIGS. 42A and 42B show additional views of the support claim 801. The support clamp 801 can be made of plastic. In some implementations, a washer 805 can be included to tightly couple the support clamp 801 to the carrier 200 (e.g., the support clamp 801 doesn't wiggle) without generating an appreciable amount of stress in the support clamp 801. For example, the washer 805 can be an elastomer washer. As another example, the support clamp 801 can be a plastic part with a turned center tube and a thread on the bottom to allow for greater assembly variance and a potentially more mechanically secure attachment instead of a snap fit.

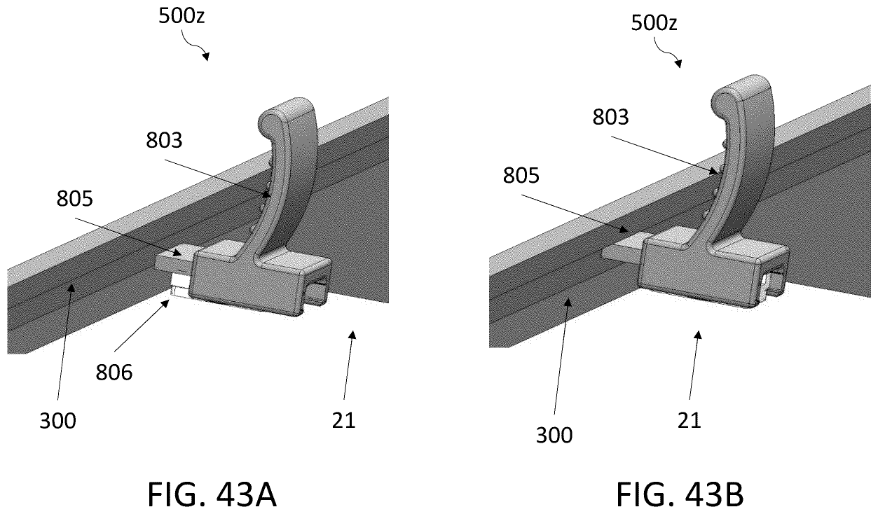

FIGS. 43A and 43B show another example locking mechanism 500z with a slide mechanism. As shown, the locking mechanism 500z can include a latch 805 with a handle 803 that is slidably coupled to a rail 806 mounted to the carrier 200. The locking mechanism 500z is engaged and disengaged by slidably moving the latch 805 into or out of engagement with the case 300. Compared to the foregoing plunger latch locking mechanisms, the locking mechanism 500z can be simpler. For example, the handle 803 can be pushed or pulled to slidably lock or unlock the carrier 200. Moreover, the locking mechanism 500z can be shaped and/or dimensioned to occupy less space than the foregoing plunger latch locking mechanisms, thus occupying less space along the faceplate 21 of a module 20 and/or fitting into relatively tighter spaces, e.g., between the carrier 200 and the case 300.

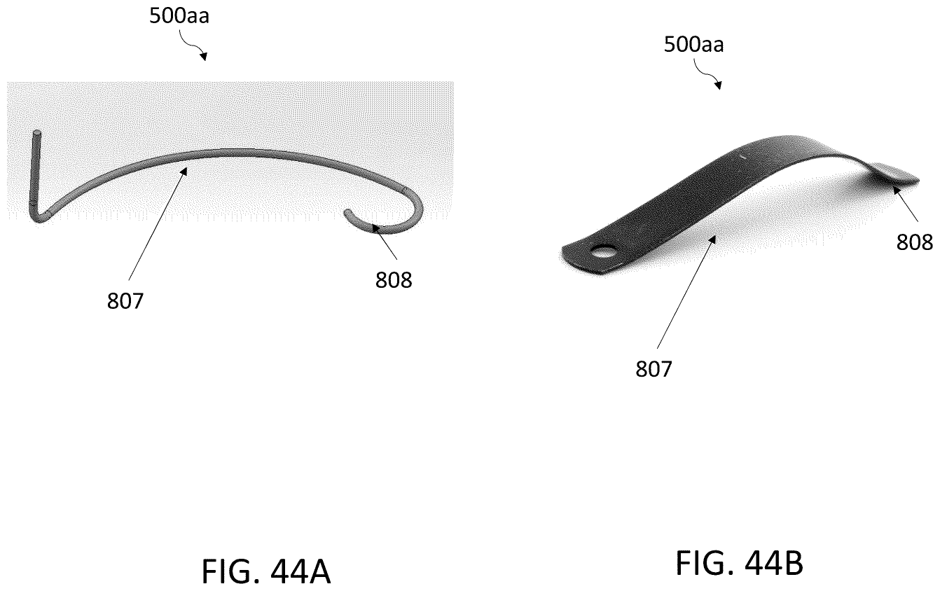

FIGS. 44A and 44B show another example locking mechanism 500aa with a cantilever spring 807. In this example, the cantilever spring 807 can be used to mechanically lock the carrier 200 to the case 300 by bending the cantilever spring 807 such that an end 808 engages the case 300. The cantilever spring 807 can further be coupled to a plunger latch configured as a push or pull mechanism. A spring can also be used.

In some implementations, the locking mechanism may include a vertical pinch mounted to a carrier that is configured to pinch a portion of a case, thus securely coupling the carrier to the case. For example, FIGS. 45A-45C show a locking mechanism 500ab that includes a vertical pinch 810a mounted to the frame 210 of the carrier 200. The vertical pinch 810a includes a base 813 that can be rigidly mounted to the face plate 21 or the frame 210 of the carrier 200. The vertical pinch 810a further includes a latch 811 coupled to a handle 812. The latch 811 and the handle 812 are slidably coupled to the base 813. As shown in FIGS. 45B and 45C, the latch 811 and the handle 812 can together form a pinching mechanism that pinches onto a ledge 318 of the case 300.

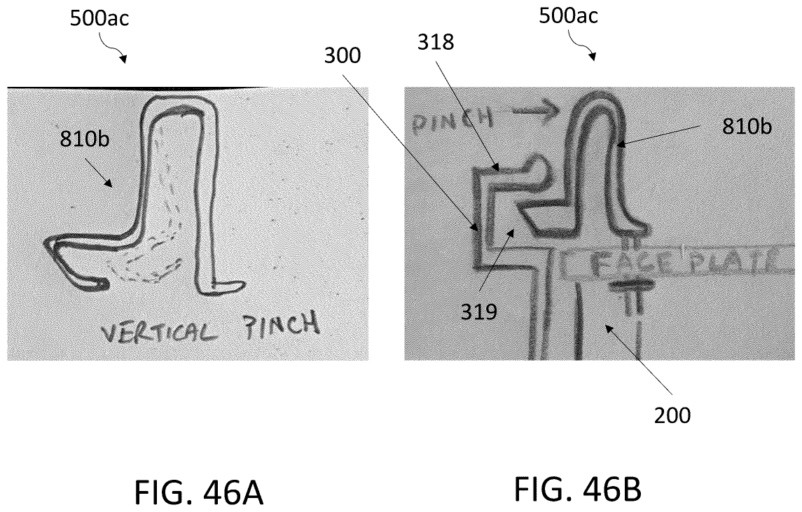

FIGS. 46A and 46B show another example locking mechanism 500ac with a vertical pinch 810b. As shown, the vertical pinch 810b can be formed as a single mechanically compliant component that integrates both the handle and the latch. The vertical pinch 810b can be securely coupled to the face plate 21 or the frame 210. The vertical pinch 810b can be further bent and/or deformed to engage or disengage the ledge 813. In this example, the case 300 can further include a channel 319 formed, in part, by the ledge 318 to receive the end of the vertical pinch 810b.

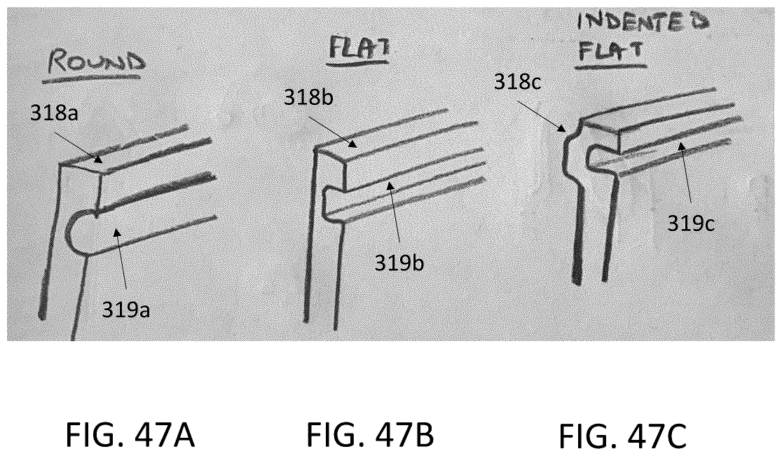

It should be appreciated that the ledge 813 and/or the undercut formed, in part, by the ledge 813 can have various geometries. For example, the geometry of the undercut (e.g., the channel 319) along the case sidewall and the latch 811 can be flat to achieve a higher pullout force. In another example, the undercut (e.g., the channel 319) and/or the latch 811 can be rounded in shape and/or have smooth edges to reduce degradation (e.g., chipping, fracture) of components and increase lifetime. The geometry of the undercut (e.g., the channel 319) and/or the latch 811 can also be chosen to facilitate an extrusion process for manufacture. For example, FIG. 47A shows a ledge 318a with a rounded channel 319a. FIG. 47B shows a ledge 318b with a flat channel 319b. FIG. 47C shows a ledge 318c with an indented flat channel 319c.

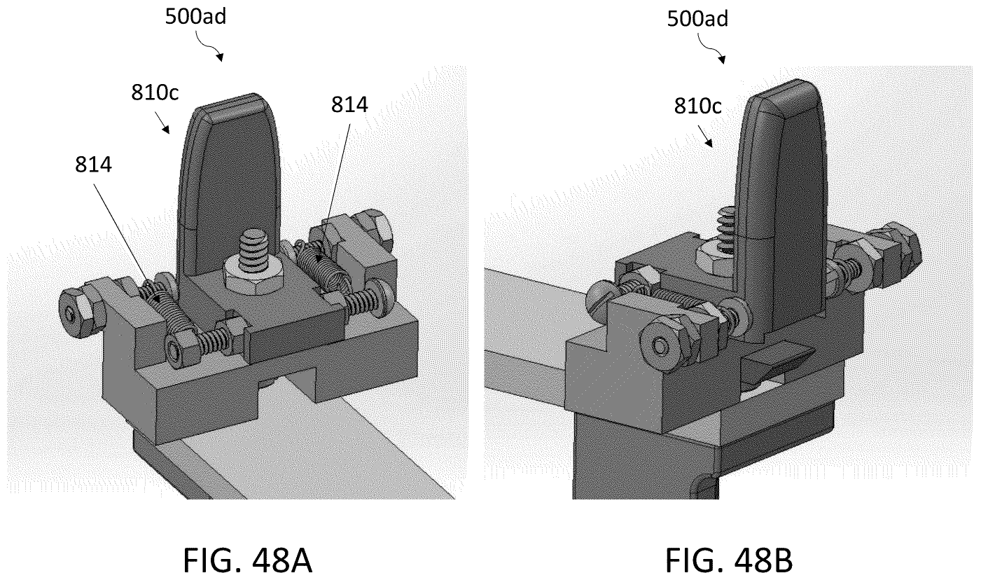

It should also be appreciated that the foregoing vertical pinches can include a spring to provide a retention force that maintains engagement of the vertical pinch to a case. For example, FIGS. 48A and 48B show a locking mechanism 500ad with a vertical pinch 810c that is a variant of the vertical pinch 810a, but with springs 814 to provide a retention force for engagement.

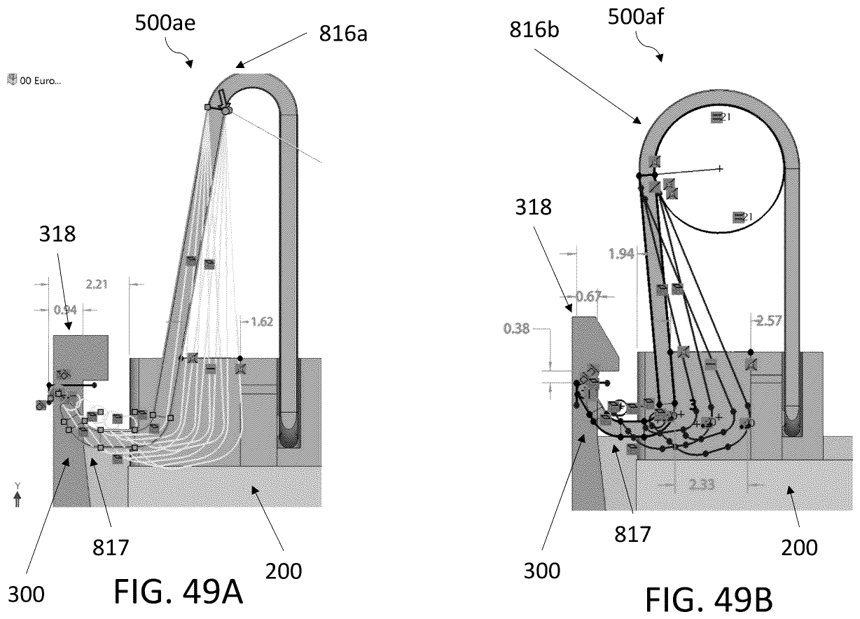

In some implementations, the locking mechanism may include a wireform spring to securely couple a carrier to a case. The wireform spring can function in a similar manner to the cantilever spring 807 or the vertical pinch 810b in that actuation of the wireform spring is based on bending and/or deforming the wireform spring in an elastic manner to engage or disengage a portion of a case. A wireform spring can provide a standalone locking mechanism that is relatively inexpensive. Additionally, the ratio of the pull force to the actuation force can be relatively high, the number of lifecycles (e.g., number of times the wireform spring is bent to engage or disengage the locking mechanism) can be relatively high, and the wireform spring can provide tactile feedback to the user. For example, FIG. 49A shows a locking mechanism 500ac with a wireform spring 816a mounted to the frame 210 of the carrier 200. Multiple snapshots of the wireform spring 816a are shown in FIG. 49A where the spring 816a is bent so that an end 817 either engages or disengages the ledge 318 of the case 300. The geometry of the wireform spring 816a can be modified, for example, to adjust the force required to bend the spring 816 for engagement or disengagement. For example, FIG. 49B shows a locking mechanism 500af with a wireform spring 816b having a different geometry compared to the wireform spring 816a.

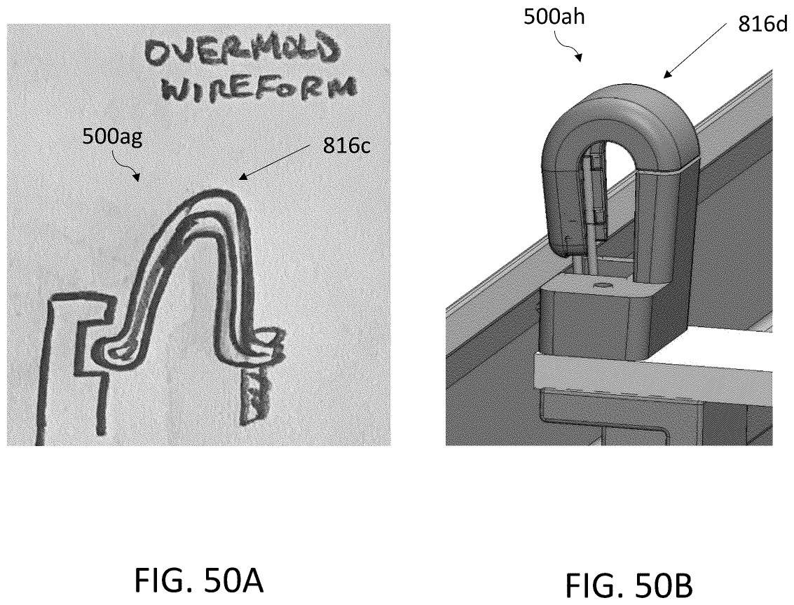

In some implementations, at least a portion of the wireform spring can be overmolded with an elastomer to improve its durability, feel (e.g., when the user presses on the spring), and/or aesthetic appearance. The entirety or a portion of the wireform spring can be overmolded. For example, the end of the wireform spring that physically contacts the case can be left exposed (i.e., without the overmold material). This can mitigate wear that may otherwise occur if that portion is covered in the overmold material. Also, leaving the end exposed can maintain tactile feedback for the user. For example, FIG. 50A shows a locking mechanism 500ag with a wireform spring 816c having an overmold that covers the entirety of the spring 816c. FIG. 50B shows another example locking mechanism 500ah with a wireform spring 816d having an overmold (e.g., an elastomeric shell) that covers the spring 816d. The end of the spring 816d is left exposed.

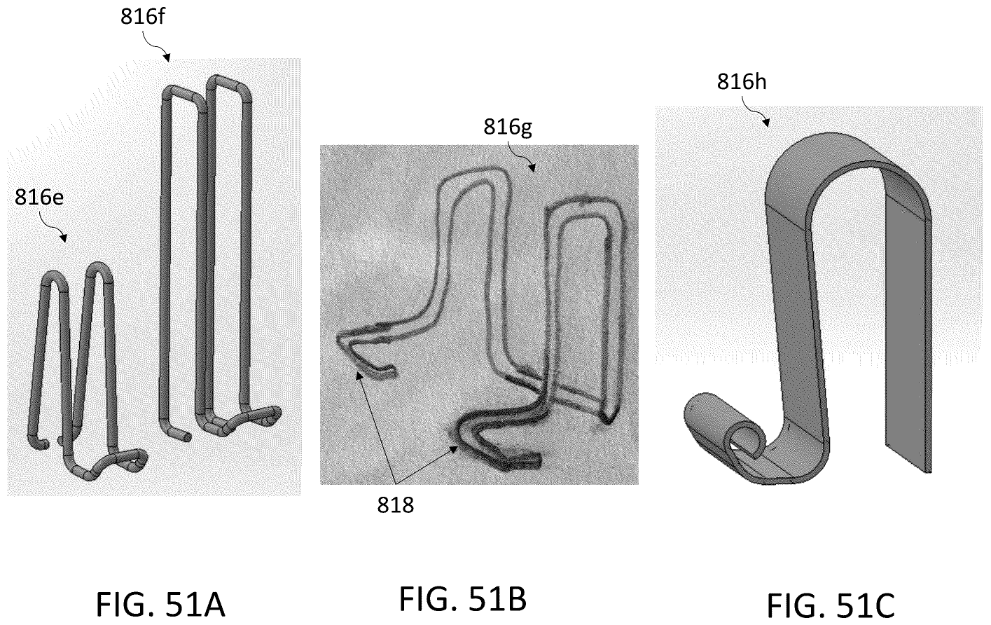

It should be appreciated that a myriad of wireform geometries can be used for the locking mechanisms disclosed herein. FIG. 51A shows additional examples of wireform springs 816e and 816f having different geometries. FIG. 51B shows a wireform spring 816g with dual ends 818 with lead ins to form a slam latch. Additionally, other types of springs can be used, such as a flat spring 816h as shown in FIG. 51C.

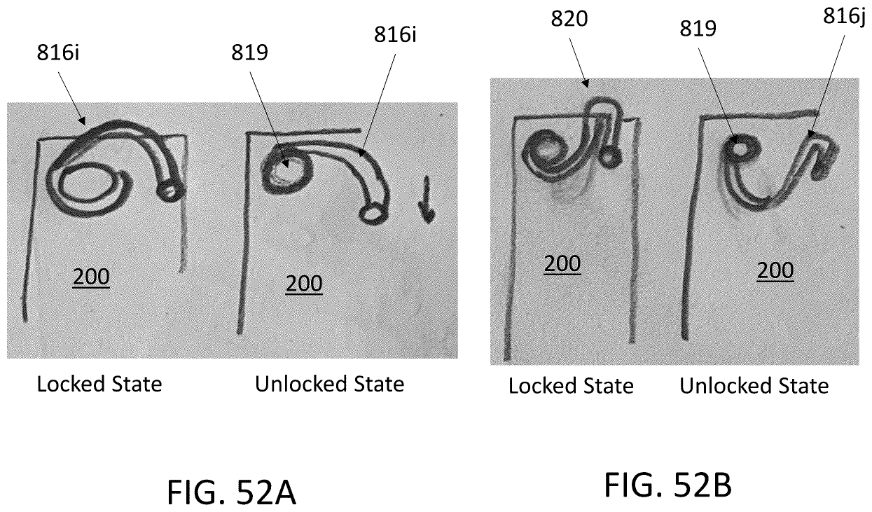

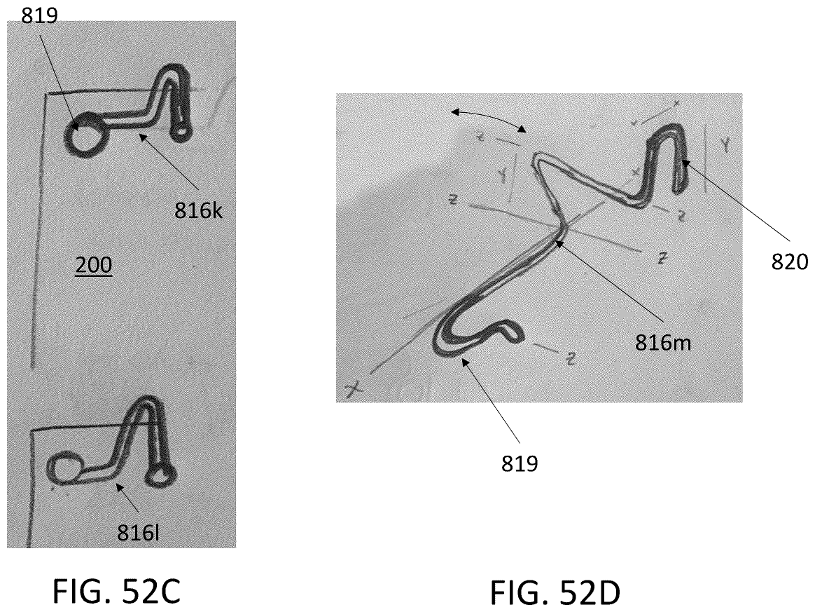

The wireform springs can also be configured to rotate to latch onto a portion of the case. For example, FIG. 52A shows a wireform spring 816i attached to a portion of the carrier 200 at an attachment point 819 and configured to rotate between locked and unlocked states (i.e., engaged and disengaged states). FIG. 52B shows another wireform spring 816j with a handle 820 for case of actuation by the user and a different geometry. FIG. 52C shows additional examples of wireforms springs 816k and 816l. FIG. 52D shows yet another example wireform spring 816m with the attachment point 819 and the handle 820.

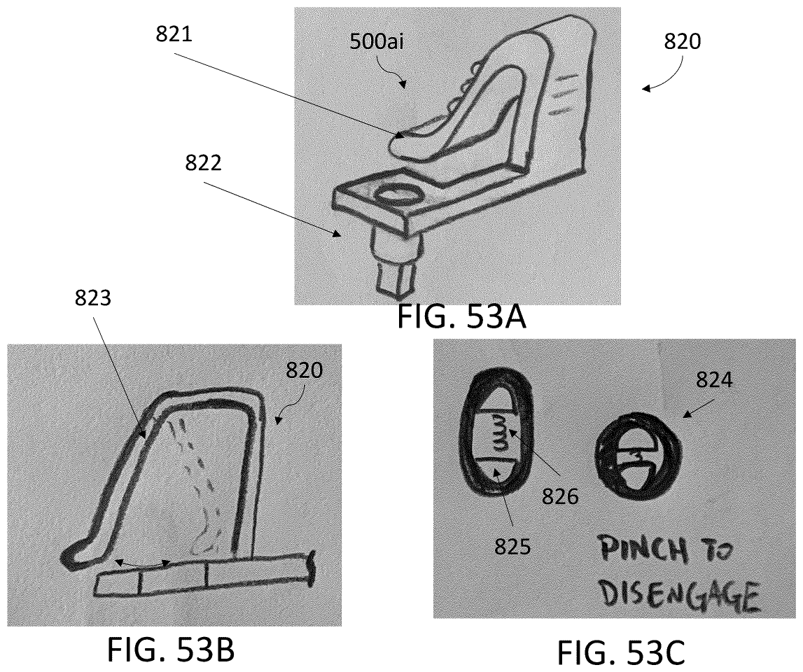

In some implementations, the locking mechanism may include a plastic snap connector. The snap connector can provide a relatively simple actuation mechanism. Additionally, the snap connector can be mechanically rigid and thus more resistant to a pullout (e.g., forced removal of the carrier). The snap connector can further provide tactile feedback to the user when installing a carrier to a case. The snap connector can be an injection molded component and thus relatively inexpensive to manufacture. For example, FIG. 53A shows an example locking mechanism 500ai with a snap connector 820 that includes an end 821 configured to pinch onto a portion of the case and thus secure the carrier to the case. The snap connector 820 further includes an attachment point 822 to directly couple the snap connector 820 to the carrier. FIG. 53B shows the snap connector 820 can further be formed to have a “living” hinge 823 in the sense that a portion of the snap connector 820 can be configured to bend to facilitate engagement and disengagement of the snap connector 820 from the case.

FIG. 53C shows another example that includes an O-ring 824 that is coupled to a pair of wedges 825 with a spring 826 disposed between the wedges 825. The spring 826 generates a force that pushes the wedges 826 away from one another, thus extending the O-ring 824. This can be used to engage a carrier and a case. To disengage, the O-ring 842 can be squeezed to move the wedges 825 closer to one another.

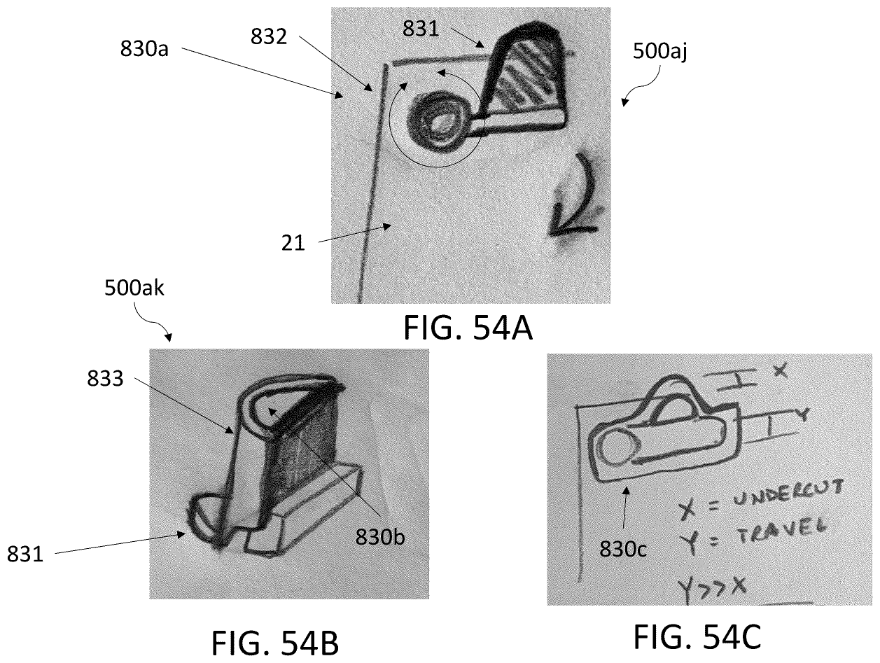

In some implementations, the locking mechanism can include a deformable elastomer element. The deformable element can be a homogeneous and deformable component, which can be slidably displaced and/or deformed to engage/disengage the case. The deformable element can be a single compression molded part. The deformable element can provide a dampening effect to the faceplate 21 of the module 20. The deformable element can be formed from various polymers including, but not limited to, silicone. Moreover, the deformable element can be readily patterned with different designs to customize its aesthetic appearance. For example, FIG. 54A shows a locking mechanism 500aj with a deformable element 830a. The deformable element 830a includes a latch 831, which can be pressed into engagement with the case, which causes the element 830a to deform as it rotates about an attachment point 832. FIG. 54B shows another example locking mechanism 500ak with a deformable element 830b. The deformable element 930b includes a button portion 833, which when pressed, causes the latch 831 to displace outwards, thus engaging the case. FIG. 54C shows yet another example deformable element 830c with a different geometry.

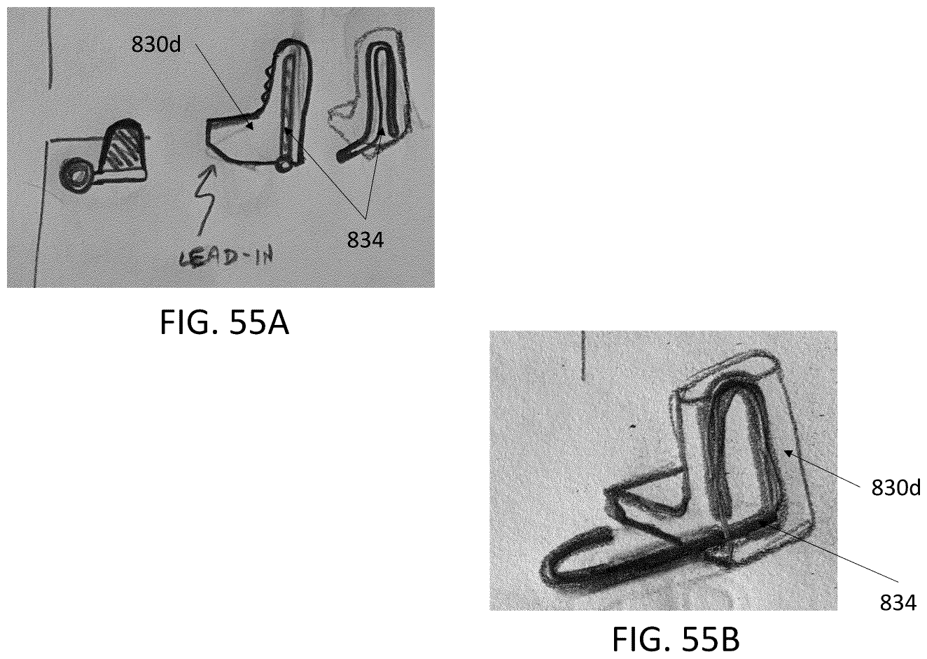

The deformable element can further be overmolded onto a wireform. The wireform can increase the mechanical stiffness in select areas of the deformable element to increase the pullout force, improve the case of actuation, and/or reduce wear. The wireform can also provide a more mechanically rigid connection point to the carrier and/or the faceplate. For example, FIGS. 55A and 55B show an example deformable element 830d with a wireform 834.

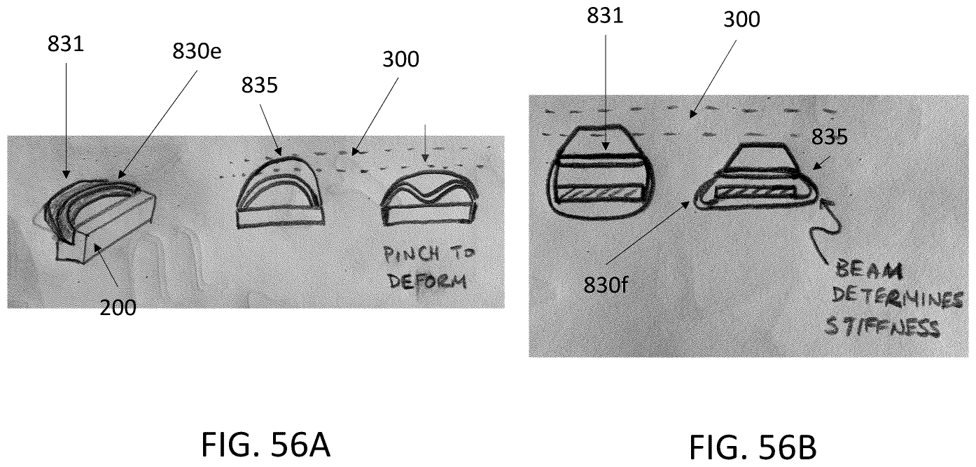

It should be appreciated that the deformable element can be actuated in various ways. In the examples above, the deformable element is actuated by pressing or pulling on a portion of the element. In another example, FIG. 56A shows a deformable element 830e with a thin-walled section 835 coupled to a latch portion 831. The section 835 can be disposed over the carrier 200 to give the appearance of a fingernail, hence this example is referred to as the fingernail concept. The section 835 can be pressed to deform the section 835 and thus displace the ledge portion 831. FIG. 56B shows another example deformable element 830f according to the fingernail concept.

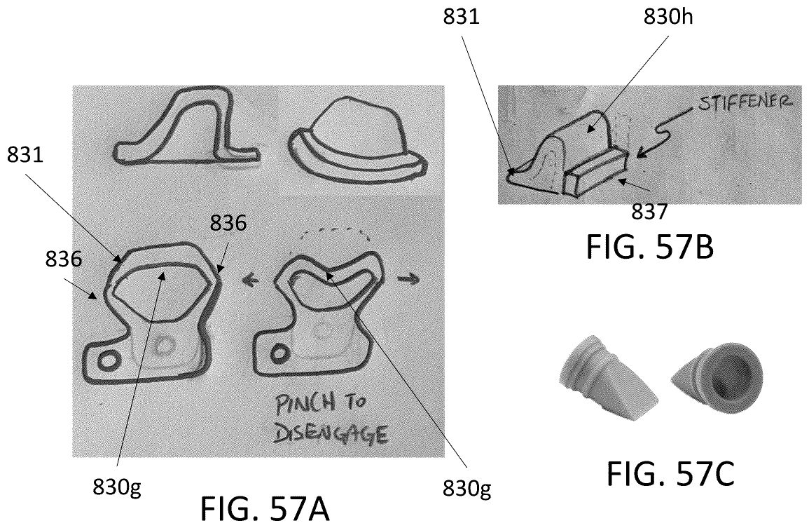

In yet another example, FIG. 57A shows a deformable element 830g with a pair of thin-walled section 836. The pair of thin-walled section 836 can be pressed together to displace a latch portion 831. As shown, the shape of the pair of thin-walled section 836 and the latch portion 831 forms the appearance of a duckbill, hence this example is referred to as the duckbill concept. FIG. 57B shows another example deformable element 830h that includes a stiffener 837 to provide more mechanical rigidity along a portion of the element 830h. FIG. 57C shows additional examples of deformable elements according to the duckbill concept.

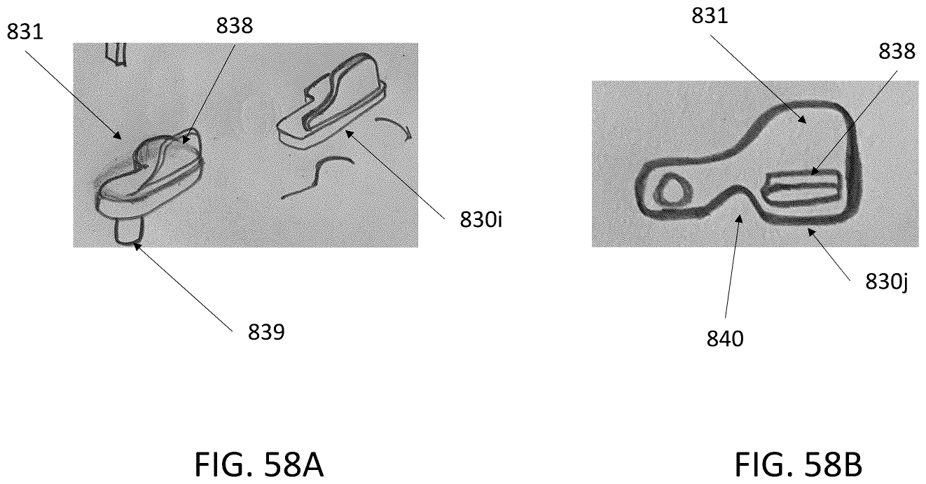

In yet another example, FIG. 58A shows a deformable element 830i, which is configured to bend as a beam. Accordingly, this example is referred to as the beam concept. As shown, the deformable element 830i can include an attachment point 839 for connection to the carrier, a handle 838 for the user to press against to bend the element 830i, and a latch portion 831 to engage the case. FIG. 58B shows another example deformable element 830j according to the beam concept where the element 830j further includes a notch 840 to facilitate controlled bending about a particular axis.

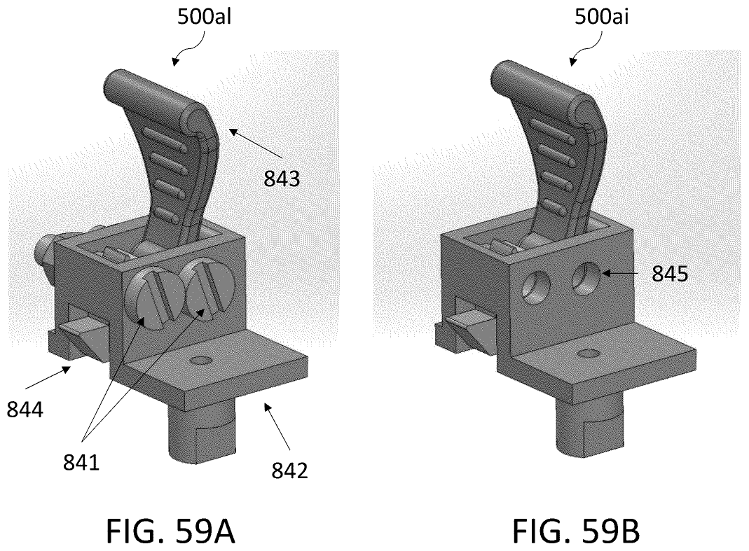

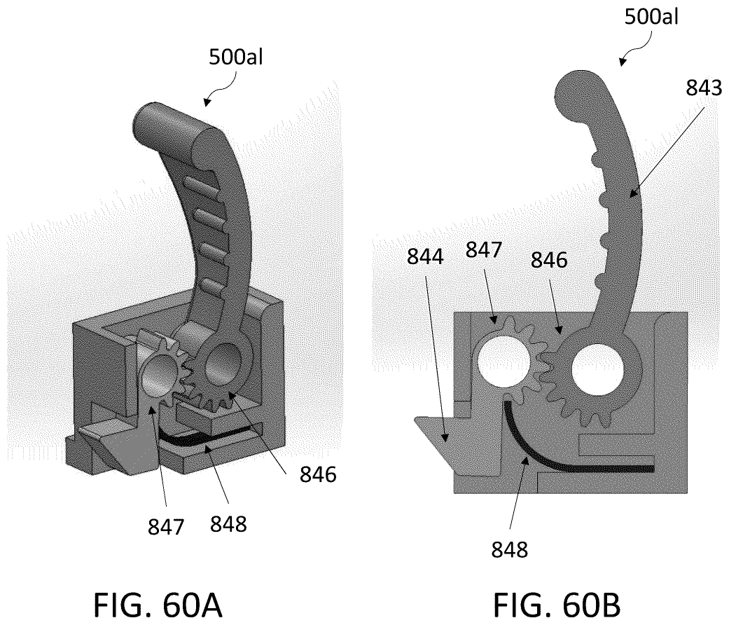

In some implementations, the locking mechanism may include a rotary geared latch. For example, FIGS. 59A, 59B, 60A, and 60B show several views of example locking mechanism 500al with a rotary geared latch. As shown, the locking mechanism 500al can include a base 842 to facilitate attachment to the carrier. The locking mechanism 500al further includes a handle 843 and a latch 844, which are rotatably coupled to the base 842 via rods 841 inserted through openings 845 on the base 842. The handle 843 also includes a gear portion 846 that meshes with a gear portion 847 of the latch 844. Accordingly, the latch 847 can be displaced in and out (e.g., to engage or disengage a case) by rotating the handle 843. The locking mechanism 500al can further include a spring 548 (e.g., a beam spring) to impart a retention force to maintain the latch 844 in an engaged or locked position.

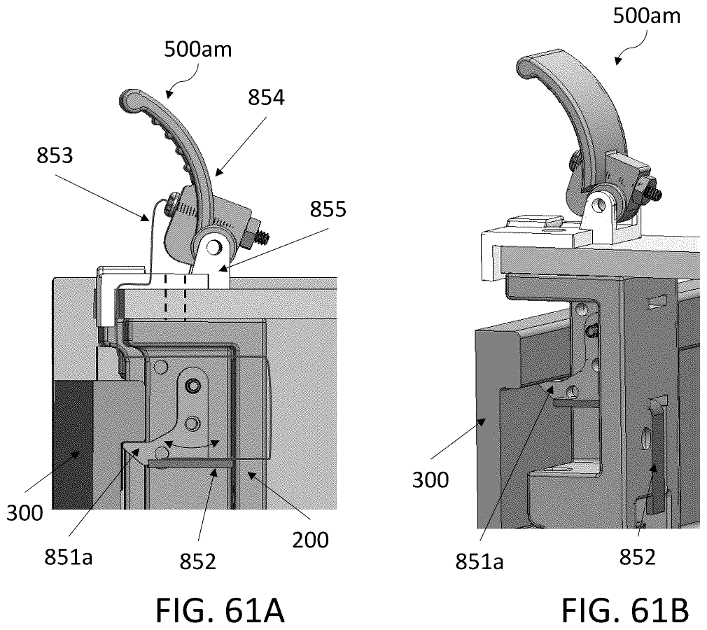

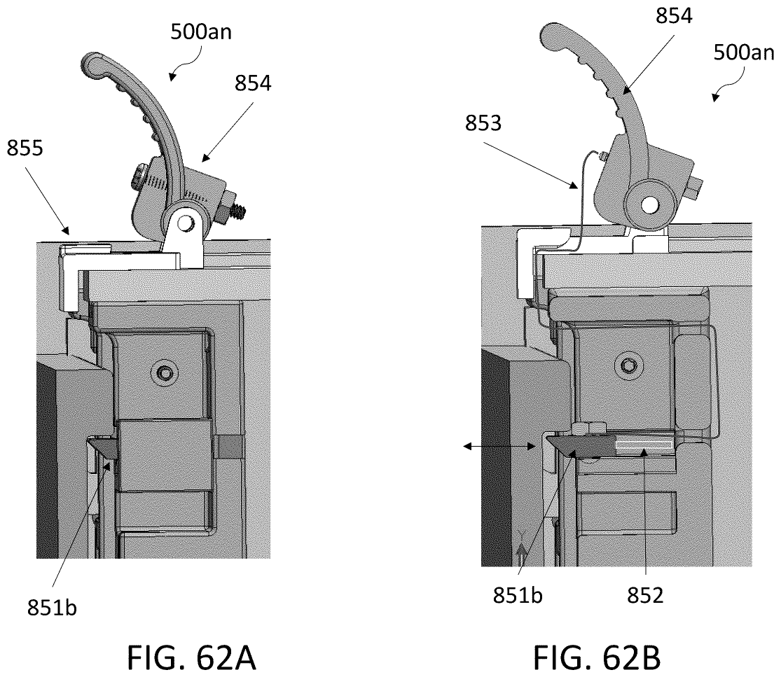

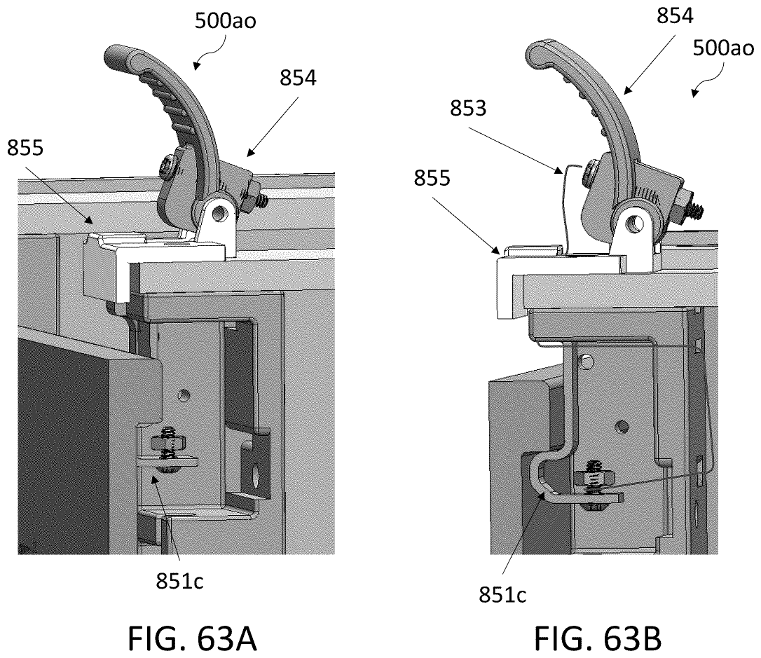

In some implementations, the locking mechanism may include a cable to transmit a force, e.g., form a handle, to actuate a latch. For example, FIGS. 61A and 61B show a locking mechanism 500am with a cable 853 to actuate a rotary latch 851a. As shown, the mechanism 500am includes a base 855 mounted directly to the carrier 200 supporting a handle 854. The handle 854 is coupled to a cable 853, which is routed through an opening in the base 855 and coupled to the rotary latch 851a. When the handle 854 is actuated (e.g., rotated), the resulting displacement of the handle 854 generates tension in the cable 853. This tension, in turn, transmits a force directly to the rotary latch 851a thereby causing the latch 851a to rotate about a pivot point. In this manner actuation of the handle 854 can release the latch 851 from engagement with the case 300. The locking mechanism can further include a spring 852 to maintain engagement between the latch 851a and the case 300. FIGS. 62A and 62B show another example locking mechanism 500an with a cable 853 to actuate a linear latch 851a. In this example, the latch 851a is configured to move along a linear (e.g., straight) path when the handle 854 is actuated. The mechanism 500an further includes a spring 852 to provide a retention force for the latch 851a. FIGS. 63A and 63B show yet another example locking mechanism 500ao with a cable 853 to actuate a spring latch 851c. In this example, the latch 851c is configured to bend about an attachment point to the carrier 200 in an elastic manner. Accordingly, the latch 851c functions as both the latch and the spring in this example.

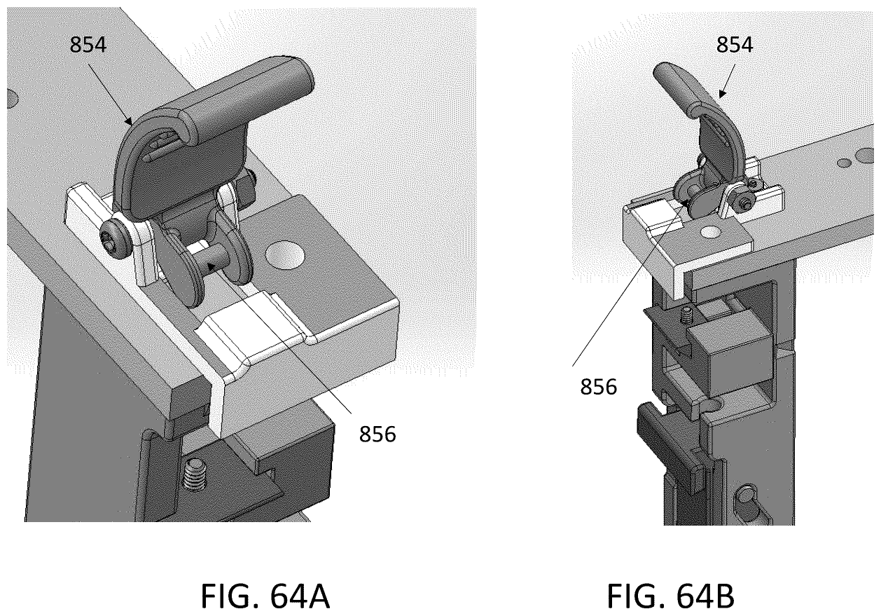

In the foregoing examples, the cable 853 can be attached to the handle 854 via a fastener. For example, the cable 853 can be wrapped around the fastener and the fastener subsequently fastened to an opening on the handle 854. In another example, FIGS. 64A and 64B show the handle 854 can include a spindle 856 about which the cable 853 can be wrapped and, thus, securely coupled to the handle 854.

### 5.2 Back-Mounted Locking Mechanisms

In some implementations, the locking mechanism can form a clamping mechanism disposed on a back portion of the case and the carrier. For example, FIG. 65 shows an example carrier with a frame 210 that includes a hook 573 disposed on a back portion of the frame 210 (e.g., the base portion 230). The frame 210 further includes the overhang portions 221-1 and 221-2, which abut the ledges 330-1 and 330-2, respectively, on the frame 310 of the case. As described above, the overhang portions 221-1 and 221-2 and provide additional mechanical support to the carrier when installed in the case. The locking mechanism (not shown) can impart a force onto the hook 573 (shown as a downward arrow in FIG. 65) resulting in a reactionary force applied to the overhang portions 221-1 and 221-2 (shown as upward arrows in FIG. 65). The various forces applied to the carrier and the case can reduce or, in some instances, mitigate unwanted play between the carrier and the case.

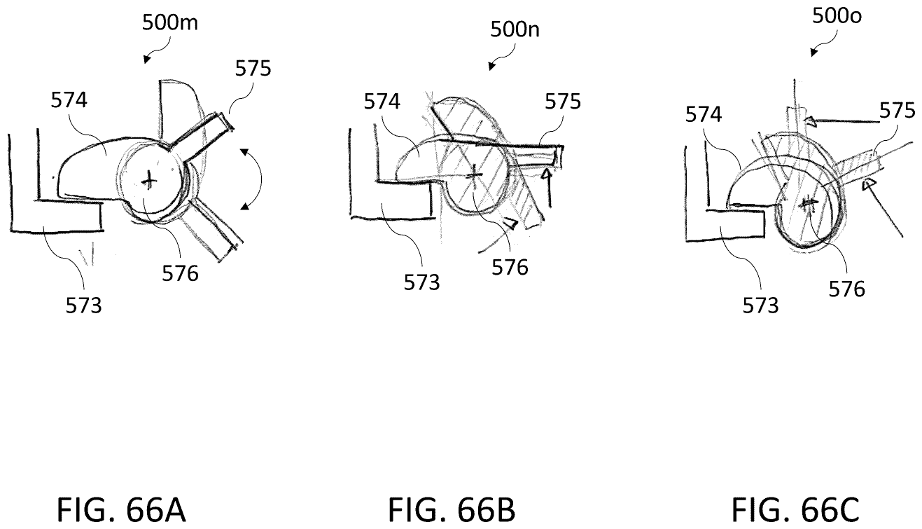

FIG. 66A shows an example locking mechanism 500m that includes a locking end 574 rotatably coupled to the case via a pivot joint 576. As shown, the locking end 574 can be rotated between a locked position where the locking end 574 contacts and restrains the hook 573 of the carrier and an unlocked position where the locking end 574 is rotated to allow removal of the carrier from the case. The locking end 574 further includes an actuator end 575 to actuate and move the locking end 574 between the locked and unlocked positions. As shown in FIG. 66A, the locking end 574 and the lever 574 can be joined at an obtuse angle, which can provide leverage to more easily rotate the locking end 574 depending on the actuation mechanism used. However, it should be appreciated the locking end 574 and the actuator end 575 can generally be joined at other angles. For example, FIG. 66B shows another example locking mechanism 500n where the locking end 574 and the actuator end 575 are joined at a straight angle. In another example, FIG. 66C shows another example locking mechanism 5000 where the locking end 574 and the actuator end 575 are joined at an acute angle.

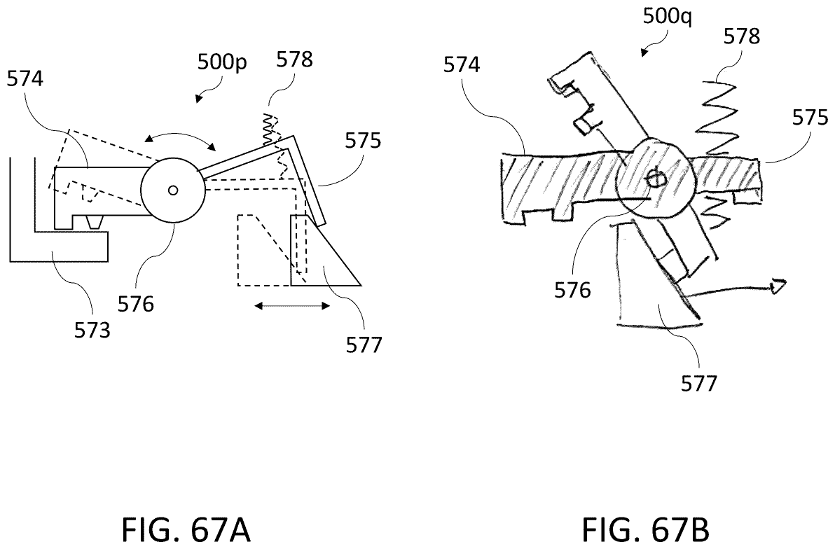

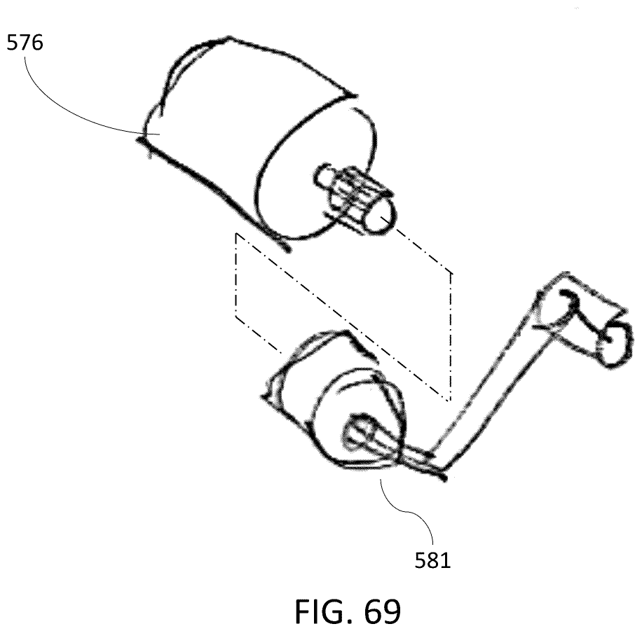

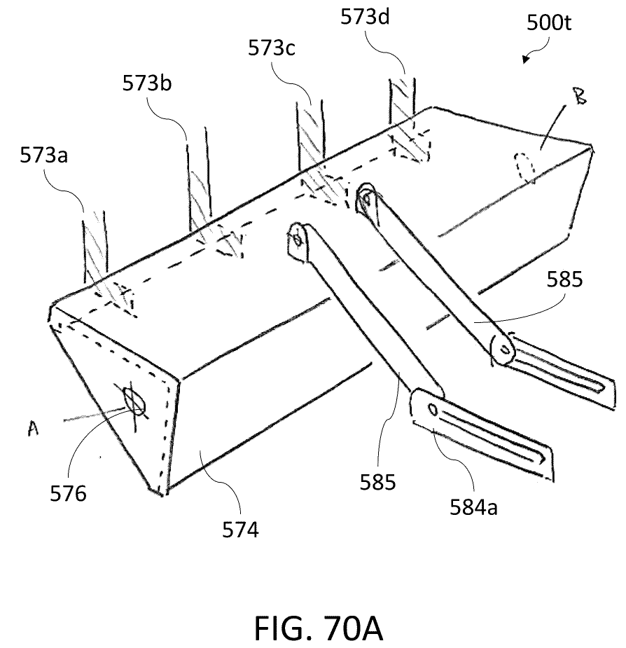

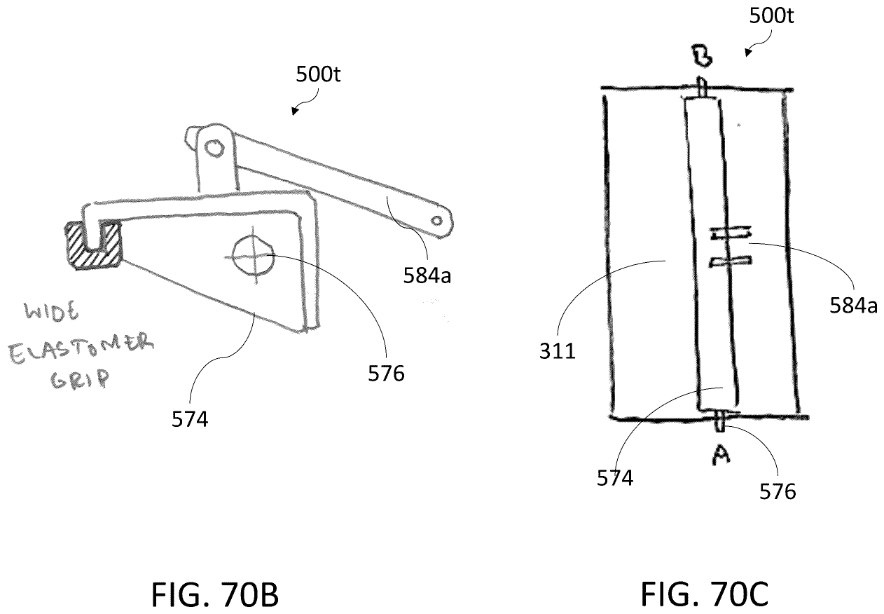

The actuator end 575 can generally be coupled to various actuation mechanisms including, but not limited to, a wire, a gear train, a linkage mechanism, a rotatable and/or translatable wedge, and any combinations of the foregoing. For example, the pivot joint 576 can be directly coupled to a handle 581 as shown in FIG. 69. In another example, FIG. 67A shows a locking mechanism 500p where the locking end 574 is actuated by a movable wedge 577. As shown, the wedge 577 can be slidably coupled to the case and actuated by a switch (not shown) disposed on the case. As the wedge 577 slidably moves, the wedge 577 physically contacts the actuator end 575 causing the locking end 574 to rotate. When the switch is moved, for example, to the right in FIG. 67A, the locking end 574 rotates and contacts the hook 573 of the carrier. The locking mechanism 500p can further include a spring 578 coupled to the actuator end 575 to maintain the locking end 574 in the unlocked position unless the wedge 577 is actuated. In some implementations, the wedge 577 can extend across the width of the case and can thus actuate one or multiple locking ends 574 for different carriers. FIG. 67B shows another example locking mechanism 500q with the wedge 577, the spring 578, and the locking end 574 and the actuator end 575 are joined at a straight angle based on the locking mechanism 500n shown in FIG. 66B.

FIG. 68A shows another example locking mechanism 500r with a pulley mechanism 579a to rotate the locking end 574. As shown, the pulley mechanism 578 includes a wire 576 that connects to the pivot joint 576 and a handle 581. By rotating the handle 581, the wire 576 can be displaced thus causing the locking end 574 to rotate.

FIG. 68B shows another example locking mechanism 500s with a gear mechanism 579b. As shown, the locking end 574 includes a set of gear teeth 582 in place of the lever 575 described above. The gear mechanism 579b includes one or more gears 583 with corresponding gear teeth that mesh with the gear teeth 582. Each of the gears 583 can be rotatable via a handle (not shown) mounted to the case. By rotating the handle, the gears 583 can thus rotate the locking end 574.

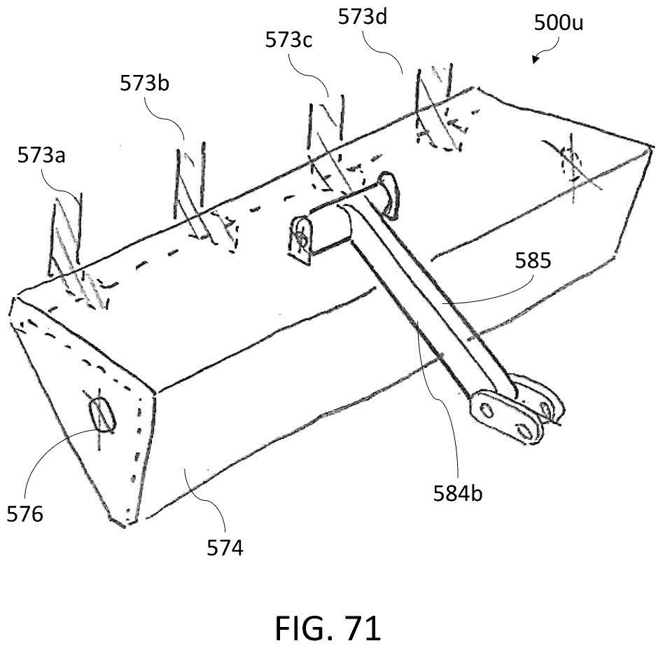

FIGS. 43A-43C show another example locking mechanism 500t that includes a locking end 574 shaped as wedge to securely couple multiple carriers to the case. As shown, the locking end 574 has a sufficiently large width to couple multiple hooks 573a-573d corresponding to different carriers to the case. In some implementations, the locking end 574 can span the width of the case and thus securely couple any carrier installed in the case at the same time. As described above, the locking end 574 is rotatably coupled to the case via a pivot joint 576. In this implementation, the locking end 574 can be actuated by a linkage mechanism 584a rotatably coupled to the locking end 574. As shown, the linkage mechanism 584a can include multiple sets of linkage members 585 joined to the locking end 574 in parallel. However, it should be appreciated one set of linkage members can also be used to actuate the locking end 574. For example, FIG. 71 shows another locking mechanism 500u that includes the locking end 574 of the locking mechanism 500t with a linkage mechanism 584b. As shown, the linkage mechanism 584b includes one set of linkage members 585.

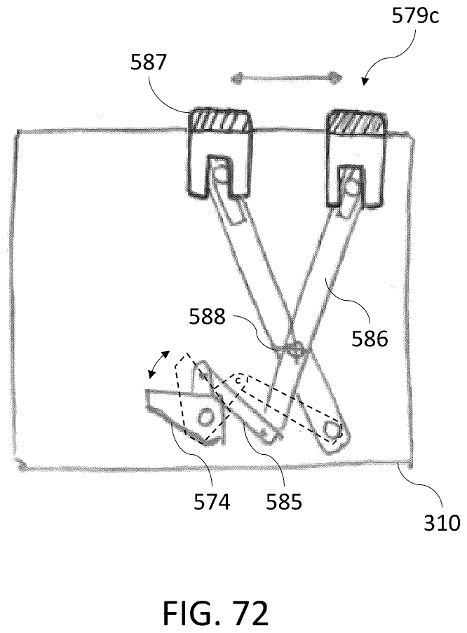

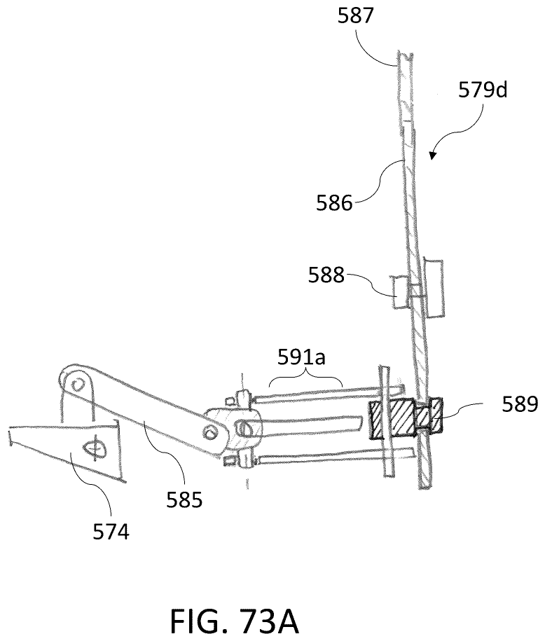

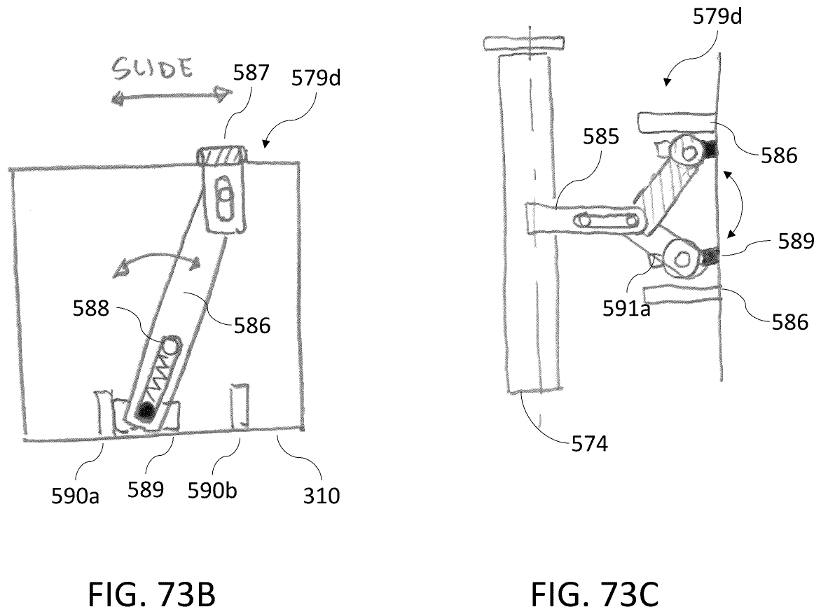

The linkage mechanisms 584a and 584b can be coupled to various mechanisms that allow the user to actuate and move the locking end 574. For example, FIG. 72 shows an actuation mechanism 579c that includes a slidable switch 587 rotatably coupled to the linkage members 585 via a lever arm 586. The lever arm 586 is rotatably coupled to the case via a pivot joint 588 rigidly mounted to the case. As shown, the slidable switch 587 can be disposed on a front side of the case to provide the user direct access to engage or release the locking mechanisms 584a and 584b. When the switch 587 is moved, the resulting motion of the lever arm 586 causes the locking end 574 to rotate between the locked and unlocked positions.

For the actuation mechanism 579c, the switch 587 is configured to move towards the top and/or bottom of the case. However, it should be appreciated the switch 587 can be configured to move in other directions along the case as well. For example, FIGS. 46A-46C show another actuation mechanism 579d where the switch 587 is movable towards the right or the left sides of the case. As shown, the actuation mechanism 579d once again includes a lever arm 586 coupled to the switch 587 and rotatably coupled to the case via a pivot joint 588. In this example, however, the lever arm 586 is coupled to the linkage members 585 and the locking end 574 via a linkage mechanism 591a. As shown, the linkage mechanism 591a is configured to displace the linkage members 585 and, by extension, the locking end 574 when the switch 587 is moved to the right or the left. Additionally, the linkage mechanism 591 includes a crank 589 to constrain the range of motion of the locking end 574. Specifically, FIGS. 46B and 46C show the crank 589 is disposed between tabs 590a and 590b, which act as mechanical stops to limit the range of movement of the crank 589.

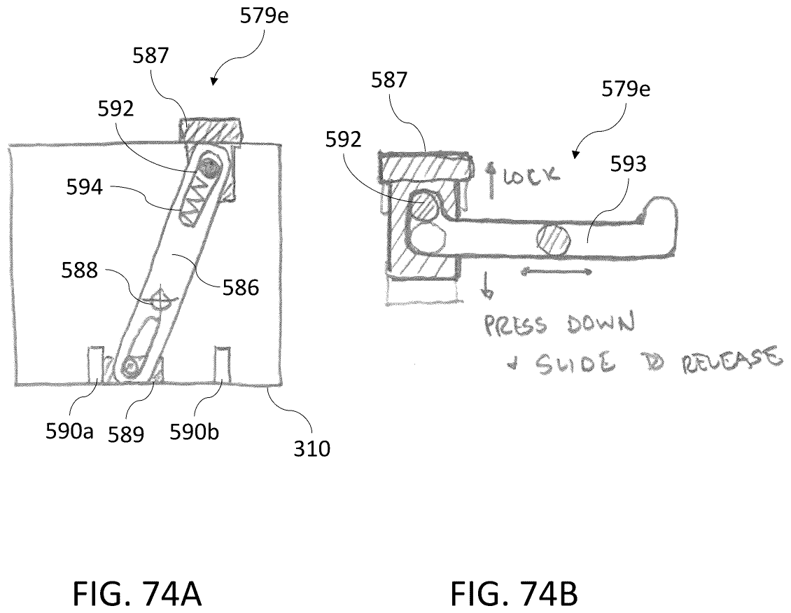

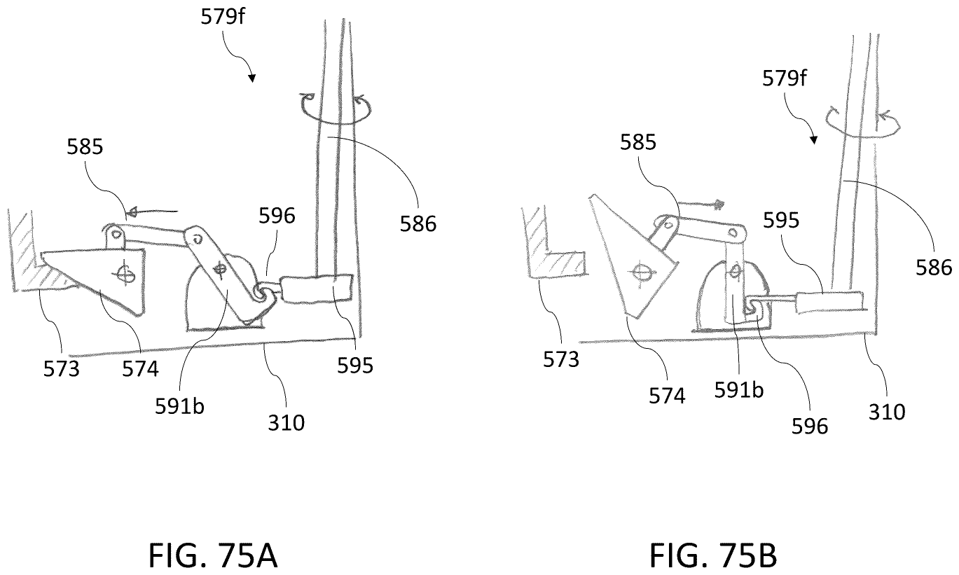

Generally, the switch 587 is configured to transition between two positions corresponding to the locked and unlocked positions of the locking end 574. In some implementations, the switch 587 can further include a slide lock mechanism to maintain the switch 587 in a particular position. For example, FIGS. 47A and 47B show another example actuation mechanism 579e, which is a variant of the actuation mechanism 579d with a slide lock mechanism. As shown, the switch 587 includes a post 592 that is constrained to a U-shaped slot 593 formed, for example, on the frame of the case. The switch 587 is further coupled to a spring 594 in compression to maintain the post 592 at one end of the slot 593. The position of the switch 587 can be changed by pushing the switch 587 downwards against the spring 594 and sliding the switch 587 and the post 592 along the slot 593 as shown in FIG. 74B. Once the switch 587 reaches the other position, the spring 594 pushes the post 592 into the other end of the slot 593.

It should also be appreciated that the linkage mechanisms 584a and 584b and the locking end 574 can be actuated by other mechanisms. For example, FIGS. 48A and 48B show another actuation mechanism 579f where the linkage members 585 and the locking end 574 are actuated by a twist lock mechanism. As shown, the actuation mechanism 579f includes a rotatable lever arm 586 with a knob (not shown) for actuation. The knob can be, for example, the knobs 544a or 544b described above. The lever arm 586 further includes a base 595 coupled to a linkage mechanism 591b via a ball joint 596. The linkage mechanism 591b, in turn, is coupled to the linkage members 585 and thus the locking end 574. As shown in FIGS. 48A and 48B, when the lever arm 586 is rotated, the resultant rotation of the base 595 displaces the ball joint 596. The displacement of the ball joint 596, in turn, causes displacement of the linkage mechanism 591b, the linkage members 585, and the locking end 574. In this manner, the actuation mechanism 579f can move the locking end 574 between the locked and unlocked positions.

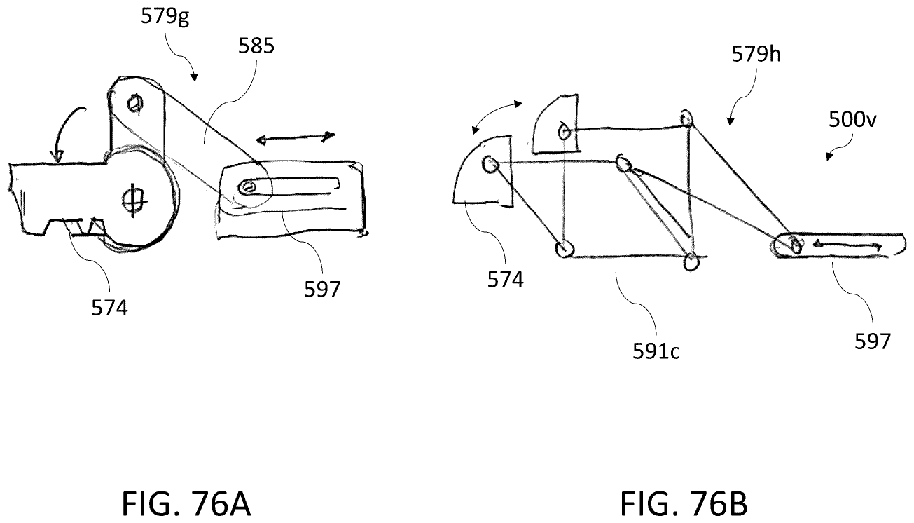

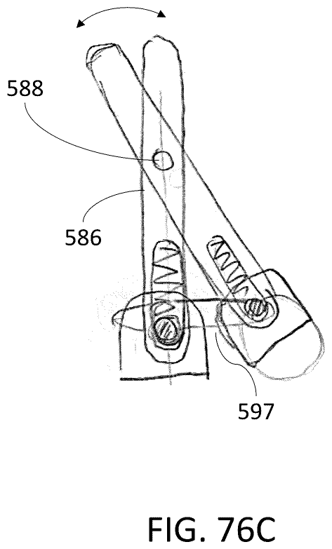

FIG. 76A shows another example actuation mechanism 579g with a slider crank 597 directly coupled to the linkage members 585 to rotate the locking end 574. As shown, the linkage members 585 and the locking end 574 are actuated by slidably displacing the crank 597. FIG. 76B shows another example actuation mechanism 579h where the locking end 574 is displaced via a four-bar linkage mechanism 591c disposed between and coupled to the locking end 574 and the slider crank 597. In this implementation, the locking end 574 is not constrained to the case via a pivot joint (e.g., the pivot joint 576), but rather moves together with one end of the four-bar linkage mechanism 597 as shown in FIG. 76B. Both the actuation mechanisms 579g and 579h can be actuated by the user using a switch connected to a lever arm as described above. For example, FIG. 76C shows a lever arm 586 rotatably coupled to the case (not shown) via the pivot joint 588 with one end of the lever arm 588 slidably coupled to the crank 597.

### 6. Conclusion

All parameters, dimensions, materials, and configurations described herein are meant to be exemplary and the actual parameters, dimensions, materials, and/or configurations will depend upon the specific application or applications for which the inventive teachings is/are used. It is to be understood that the foregoing embodiments are presented primarily by way of example and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein.

In addition, any combination of two or more such features, systems, articles, materials, kits, and/or methods, if such features, systems, articles, materials, kits, and/or methods are not mutually inconsistent, is included within the inventive scope of the present disclosure. Other substitutions, modifications, changes, and omissions may be made in the design, operating conditions and arrangement of respective elements of the exemplary implementations without departing from the scope of the present disclosure. The use of a numerical range does not preclude equivalents that fall outside the range that fulfill the same function, in the same way, to produce the same result.

Also, various inventive concepts may be embodied as one or more methods, of which at least one example has been provided. The acts performed as part of the method may in some instances be ordered in different ways. Accordingly, in some inventive implementations, respective acts of a given method may be performed in an order different than specifically illustrated, which may include performing some acts simultaneously (even if such acts are shown as sequential acts in illustrative embodiments).

All publications, patent applications, patents, and other references mentioned herein are incorporated by reference in their entirety.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying.” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A case assembly for a modular signal processing system, the case assembly comprising:
a case having at least one ledge;
case electronics, directly coupled to the case, to supply at least one of electrical power or data communication, the case electronics having a first circuit board with a plurality of electrical traces; and
a carrier configured to mechanically and electrically support a module, the carrier comprising:
a frame mechanically coupled to the case and configured to support the module;
a locking mechanism, coupled to the frame, having at least one movable connector end to engage the at least one ledge of the case to securely couple the frame to the case, the locking mechanism being configured to release the at least one connector end from the case when actuated; and
carrier electronics configured to supply the at least one of the electrical power or the data communication from the case electronics to the module, the carrier electronics having a plurality of pogo pin connectors in electrical contact with the plurality of electrical traces of the case electronics,
wherein:
the at least one movable connector end is slidably coupled to the frame; and
the carrier further comprises at least one spring to apply a force to maintain engagement of the at least one movable connector end to the at least one ledge.

2. The case assembly of claim 1, wherein the carrier has a width that is equal to or less than a width of the module.

3. The case assembly of claim 1, wherein the locking mechanism comprises:
at least one quick-release feature, disposed on at least one of the case or the carrier, to securely couple the carrier to the case when the locking mechanism is engaged, the at least one quick-release feature being actuatable to disengage the locking mechanism thereby allowing removal of the carrier from the case.

4. The case assembly of claim 3, wherein the at least one quick-release feature comprises at least one of a snap-fit connector, a clamp, a twist lock, a linkage mechanism, or a push button.

5. The case assembly of claim 1, wherein the carrier further comprises:
an alignment mechanism to slidably couple the carrier to the case such that when the locking mechanism is disengaged, the carrier is allowed to slidably movable along at least one axis with respect to the case.

6. The case assembly of claim 5, wherein:
the case comprises a protrusion that extends along the at least one axis; and
the alignment mechanism comprises:
a twist lock that is rotatable between a locked position where the twist lock is engaged to the protrusion and an unlocked position where the twist lock is not engaged to the protrusion,
wherein in the locked position, the twist lock prevents removal of the carrier from the case and allows the carrier to move along the at least one axis by sliding the twist lock along the protrusion.

7. The case assembly of claim 1, wherein:
the plurality of electrical traces spans a first length of the first circuit board; and
the plurality of pogo pin connectors are in electrical contact with the plurality of traces at any location along the first length.

8. The case assembly of claim 1, wherein:
the plurality of electrical traces is a first plurality of electrical traces; and
the case electronics further comprises:
a second circuit board, mechanically and electrically coupled to the first circuit board, having a second plurality of electrical traces to electrically couple the carrier electronics to the case electronics.

9. The case assembly of claim 1, wherein:
the carrier is a first carrier; and
the case assembly further comprises:
a second carrier configured to mechanically support the module together with the first carrier.

10. The case assembly of claim 9, wherein the second carrier does not include carrier electronics.

11. The case assembly of claim 1, in combination with a module, to form the modular signal processing system, wherein:
the module is mechanically coupled directly to the frame of the carrier; and
the module is operatively coupled directly to the carrier electronics of the carrier.

12. The modular signal processing system of claim 11, wherein:
the module has a faceplate with at least one opening; and
the module is mechanically coupled to the frame via one or more twist locks inserted through the at least one opening and fastened to the frame.

13. The modular signal processing system of claim 11, wherein at least one of the module or the case conforms to at least one of a Eurorack format, a Buchla format, a Frac format, a Modcan A format, a Module of the Month (MOTM) format, a Moog Unit (MU) format, a Serge format, or a 500 Series format.

14. A case assembly for a modular signal processing system, the case assembly comprising:
a case comprising:
at least one ledge; and
a protrusion that extends along at least one axis; and
case electronics, directly coupled to the case, to supply at least one of electrical power or data communication, the case electronics having a first circuit board with a plurality of electrical traces; and
a carrier configured to mechanically and electrically support a module, the carrier comprising:
a frame mechanically coupled to the case and configured to support the module;
a locking mechanism, coupled to the frame, having at least one movable connector end to engage the at least one ledge of the case to securely couple the frame to the case, the locking mechanism being configured to release the at least one connector end from the case when actuated;
carrier electronics configured to supply the at least one of the electrical power or the data communication from the case electronics to the module, the carrier electronics having a plurality of pogo pin connectors in electrical contact with the plurality of electrical traces of the case electronics; and
an alignment mechanism to slidably couple the carrier to the case such that when the locking mechanism is disengaged, the carrier is allowed to slidably movable along the at least one axis with respect to the case, the alignment mechanism comprising:
a twist lock that is rotatable between a locked position where the twist lock is engaged to the protrusion and an unlocked position where the twist lock is not engaged to the protrusion,
wherein in the locked position, the twist lock prevents removal of the carrier from the case and allows the carrier to move along the at least one axis by sliding the twist lock along the protrusion.

15. The case assembly of claim 14, wherein:
the plurality of electrical traces spans a first length of the first circuit board; and
the plurality of pogo pin connectors are in electrical contact with the plurality of traces at any location along the first length.

16. The case assembly of claim 14, wherein:
the carrier is a first carrier; and
the case assembly further comprises:
a second carrier configured to mechanically support the module together with the first carrier,
wherein the second carrier does not include carrier electronics.

17. The case assembly of claim 14, in combination with a module, to form the modular signal processing system, wherein:
the module is mechanically coupled directly to the frame of the carrier; and
the module is operatively coupled directly to the carrier electronics of the carrier.

18. A case assembly for a modular signal processing system, the case assembly comprising:
a case having at least one ledge;
case electronics, directly coupled to the case, to supply at least one of electrical power or data communication, the case electronics having a first circuit board with a plurality of electrical traces; and
a carrier configured to mechanically and electrically support a module, the carrier comprising:
a frame mechanically coupled to the case and configured to support the module;
a locking mechanism, coupled to the frame, having at least one movable connector end to engage the at least one ledge of the case to securely couple the frame to the case, the locking mechanism being configured to release the at least one connector end from the case when actuated; and
carrier electronics configured to supply the at least one of the electrical power or the data communication from the case electronics to the module, the carrier electronics having a plurality of pogo pin connectors in electrical contact with the plurality of electrical traces of the case electronics,
wherein:
the plurality of electrical traces spans a first length of the first circuit board; and
the plurality of pogo pin connectors are in electrical contact with the plurality of traces at any location along the first length.

19. The case assembly of claim 18, wherein:
the carrier is a first carrier; and
the case assembly further comprises:
a second carrier configured to mechanically support the module together with the first carrier,
wherein the second carrier does not include carrier electronics.

20. The case assembly of claim 18, in combination with a module, to form the modular signal processing system, wherein:
the module is mechanically coupled directly to the frame of the carrier; and
the module is operatively coupled directly to the carrier electronics of the carrier.
